(19) United States
(12) Patent Application Publication
(10) Pub. No.: US 2025/0338279 A1
(43) Pub. Date: Oct. 30, 2025

(54) METHOD AND APPARATUS FOR MANAGING UCI ON PUSCH FOR MULTIPLE CRI BASED REPORTING IN A WIRELESS COMMUNICATION SYSTEM

(71) Applicant: SAMSUNG ELECTRONICS CO., LTD., Suwon-si (KR)

(72) Inventors: Dattaraj Dileep Raut MULGAONKAR, Bangalore (IN); Diwakar SHARMA, Bangalore (IN); Karthik MURALIDHAR, Bangalore (IN); Santanu MONDAL, Bangalore (IN)

(21) Appl. No.: 19/195,401

(22) Filed: Apr. 30, 2025

(30) Foreign Application Priority Data
Apr. 30, 2024 (IN) 202441034140
May 16, 2024 (IN) 202441038465
May 22, 2024 (IN) 202441039975
Jun. 18, 2024 (IN) 202441046932
Apr. 15, 2025 (IN) 202441034140

(51) Int. Cl. H04W 72/21; H04B 7/06; H04W 24/10

(52) U.S. Cl. CPC H04W 72/21; H04B 7/0617; H04B 7/0626; H04B 7/0632; H04W 24/10

(57) ABSTRACT

The disclosure relates to a 5th generation (5G) or 6G communication system for supporting a higher data transmission rate in a wireless communication system. The disclosure provides a system and method for managing uplink control information (UCI) for hybrid beamforming on a physical uplink shared channel (PUSCH) in a wireless communication system.

### CROSS-REFERENCE TO RELATED APPLICATIONS

This application is based on and claims priority under 35 U.S.C. § 119 to Indian Provisional Patent Application No. 202441034140 filed on Apr. 30, 2024, Indian Provisional Patent Application No. 202441038465 filed on May 16, 2024, Indian Provisional Patent Application No. 202441039975 filed on May 22, 2024, Indian Provisional Patent Application No. 202441046932 filed on Jun. 18, 2024, and Indian Non-Provisional patent application No. 202441034140 filed on Apr. 15, 2025, in the Indian Intellectual Property Office, the disclosure of which are incorporated by reference herein in their entirety.

### BACKGROUND

### 1. Field

The present disclosure is related to the field of wireless communication. More particularly, the present disclosure is related to a method and system for managing uplink control information (UCI) for hybrid beamforming on a physical uplink shared channel (PUSCH) in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (M_{R}) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The next generation mobile wireless communication system Fifth Generation (5G) or NR support a diverse set of use cases and deployment scenarios. This cases includes deployment at both low frequencies (100s of MHz), similar to Long Term Evolution (LTE) today, and very high frequencies (mm waves in the tens of GHz) and newly introduced band FR3. Similar to the LTE, NR uses orthogonal frequency-division multiplexing (OFDM) in both the downlink (i.e., from a network node, gNB eNB, or base station, to a user equipment (UE)). In the uplink (i.e., from UE to gNB), both discrete Fourier transform (DFT)—spread OFDM and OFDM will be supported.

Downlink transmissions are dynamically scheduled, i.e., in each sub frame the gNB transmits downlink control information (DCI) about which UE data is to be transmitted to and which resource blocks in the current downlink sub frame the data is transmitted on. This control signaling is typically transmitted in the first one or two OFDM symbols in each sub frame in NR. The control information is carried on physical control channel (PDCCH) and data is carried on physical downlink shared channel (PDSCH). A UE first detects and decodes PDCCH and if a PDCCH is decoded successfully, it decodes the corresponding PDSCH based on the decoded control information in the PDCCH. Uplink data transmissions are also dynamically scheduled using PDCCH. Similar to downlink, a UE first decodes uplink grants in PDCCH and then transmits data over the physical uplink shared channel (PUSCH) based on the decoded control information in the uplink grant such as modulation order, coding rate, uplink resource allocation, and etc. In addition to the PUSCH, PUCCH is also supported in NR to carry uplink control information (UCI) such as hybrid automatic repeat request (HARQ) related acknowledgement (ACK), negative acknowledgement (NACK), or channel state information (CSI) feedback. In NR, a reference signal is transmitted from each antenna port at the gNB for downlink channel estimation at a UE.

Reference signals for downlink channel estimation are commonly referred to as channel state information reference signal (CSI-RS). For N antenna ports, there may be N CSI-RS signals, each associated with one antenna port. By measuring on CSI-RS, a UE can estimate the effective channel the CSI-RS is traversing including the radio propagation channel and antenna gains at both the gNB and the UE.

In NR phase MIMO, to address the issue of coverage, higher downlink spectrum efficiency, larger antenna arrays for single transmission point transmissions with an increased number of antennas have an increased interest in the industry. In specifications, the support for such large antenna arrays with large number of CSI-RS ports for CSI measurement and reporting is limited. With large number of ports, to increase the multi user-MIMO scheduling opportunities, multiple CRI based hybrid beamforming has been provided for enhancement. A UCI design is inadequate to support multiple CRI based report for CSI type I and Type II-r16. In order to support this, enhancements has been provided in the present disclosure to a UCI design.

Thus, it is desired to address the above-mentioned disadvantages, issues, or other shortcomings or at least provide a useful alternative.

### SUMMARY

The principal object of the embodiments herein is to provide a system and method for uplink control information on PUSCH for multiple CRI based reporting for hybrid beamforming in NR.

In an aspect, the objectives are achieved by providing a method for transmitting UCI for hybrid beamforming on a PUSCH in a wireless communication system. The method includes receiving a CSI report configuration from a base station. The CSI report configuration includes configuration information associated with multiple CRI based hybrid beamforming. Further, the method includes identifying the UCI including a first UCI part and a second UCI part. The first UCI part comprises a CSI resource indicator (CRI), a rank indicator (RI), and a channel quality information (CQI). The second UCI part includes a variable payload based on an order of CSI reporting. Further, the method includes transmitting the UCI. The first UCI part has a high priority over the second UCI part.

In another aspect, the objectives are achieved by providing a UE for transmitting UCI for hybrid beamforming on a PUSCH in a wireless communication system. The UE includes a transceiver and a processor coupled with the transceiver. The processor is configured to receive a CSI report configuration from a base station. The CSI report configuration comprises configuration information associated with multiple CRI based hybrid beamforming. Further, the processor is configured to identify the UCI including a first UCI part and a second UCI part. The first UCI part includes a CSI resource indicator (CRI), a rank indicator (RI), and a channel quality information (CQI). The second UCI part comprises a variable payload based on an order of CSI reporting. Further, the processor is configured to transmit the UCI. The first UCI part has a high priority over the second UCI part.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications can be made within the scope of the embodiments herein without departing from the scope thereof, and the embodiments herein include all such modifications.

### Advantageous Effects

According to embodiments of the present disclosure, efficient communication can be achieved.

Before undertaking the DETAILED DESCRIPTION below, it may be advantageous to set forth definitions of certain words and phrases used throughout this patent document: the terms “include” and “comprise”, as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 illustrates a UE according to an embodiment as disclosed herein; and

FIG. 2 illustrates a flow diagram of a method for managing UCI for hybrid beamforming on a PUSCH in a wireless communication system according to an embodiment as disclosed herein.

### DETAILED DESCRIPTION

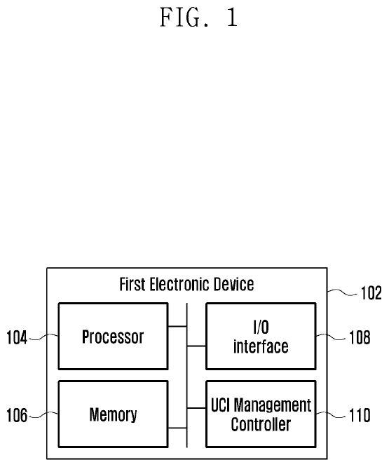

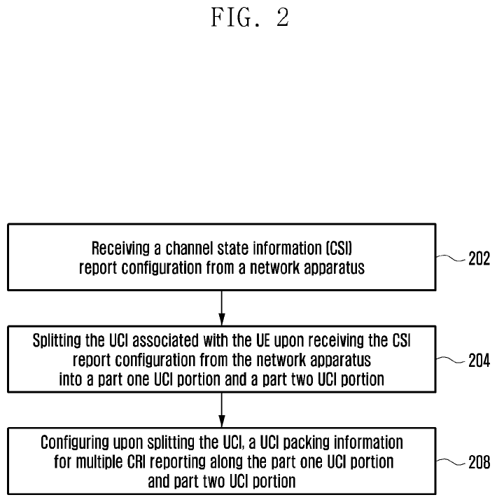

FIGS. 1 through 2, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Embodiments can be described and illustrated in terms of blocks which carry out a described function or functions. These blocks, which can be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block can be implemented by dedicated hardware, or by a processor (e.g., one or more programmed microprocessors and associated circuitry), or by a combination of dedicated hardware to perform some functions of the block and a processor to perform other functions of the block. Each block of the embodiments can be physically separated into two or more interacting and discrete blocks without departing from the scope of the disclosure. Likewise, the blocks of the embodiments can be physically combined into more complex blocks without departing from the scope of the disclosure.

Embodiments disclosed herein provide a system and method for uplink control information on PUSCH for multiple CRI based reporting for hybrid beamforming in NR. In NR phase MIMO, to address the issue of coverage, higher downlink spectrum efficiency, larger antenna arrays for single transmission point transmissions with an increased number of antennas have an increased interest in the industry. In specifications, the support for such large antenna arrays with large number of CSI-RS ports for CSI measurement and reporting is limited. With large number of ports, to increase the multi user-MIMO scheduling opportunities, multiple CRI based hybrid beamforming has been provided for enhancement. A UCI design is inadequate to support multiple CRI based report for CSI type I and Type II-r16. The Shortcomings has been addressed here.

FIG. 1 illustrates a UE (102) implemented to carry out the disclosed subject matter according to an embodiment as disclosed herein. Examples of the UE (102) can include, but are not limited to, consumer electronics (such as mobile phones and smartphones), tablets, wearable devices, computing devices (such as laptops, notebooks, desktops, workstations, etc.), IoT devices, automotive systems (such as connected cars, autonomous vehicles, vehicle-to-everything (V2X) communication devices, etc.), enterprise devices such as robotics, specialized equipment (such as medical devices, public safety devices, etc.), media devices (such as gaming consoles, streaming devices, etc.).

In an embodiment, in FIG. 1, the UE (102) includes a processor (104), a memory (106), an I/O interface (108), and a UCI management controller (110) coupled to the processor (104) and the memory (106). The components are explained in further detail below. Although not illustrated in the drawings, the UE (102) may include a transceiver coupled with the processor (104).

The processor (104) communicates with the memory (106), the I/O interface (108), and the UCI management controller (110). The processor (104) is configured to execute instructions stored in the memory (106) and to perform various processes. The processor (104) includes one or a plurality of processors, is a general-purpose processor such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU).

The memory (106) includes storage locations to be addressable through the processor (104). The memory (106) includes CSI report configuration received from a network apparatus. The memory (106) is not limited to a volatile memory and/or a non-volatile memory. Further, the memory (106) includes a plurality of computer-readable storage media. The memory (106) includes non-volatile storage elements. For example, non-volatile storage elements includes magnetic hard disks, optical disks, floppy disks, flash memories, or forms of electrically programmable memories (EPROM) or electrically erasable and programmable (EEPROM) memories.

The I/O interface (108) transmits the information between the memory (106) and external peripheral devices. The peripheral devices are the input-output devices associated with the UE (102). Further, the UCI management controller (110) communicates with the I/O interface (108) and the memory (106). The UCI management controller (110) is coupled to the memory (106) and the first processor (104). This coupling allows for efficient data transfer and communication between the components, ensuring that the UCI management controller (110) can manage UCI for hybrid beamforming on a PUSCH.

The UCI management controller (110) is an innovative integrated circuit that is implemented in the UE (102). In an embodiment, the structure of such innovative integrated circuit includes a multi-core architecture that enables managing UCI for hybrid beamforming on a PUSCH. Each core is optimized for specific tasks, such as receiving a CSI report configuration, splitting the UCI into a part one UCI and a part two UCI, configuring a UCI packing information for multiple CRI reporting along the part one UCI portion and part two UCI portion, and the like. The innovative integrated circuit for the above-mentioned points is made of a combination of analog and digital components designed to manage UCI for hybrid beamforming on a PUSCH. The analog components include a low-noise amplifier and a high-precision analog-to-digital converter to ensure accurate signal processing. The digital components consist of a microcontroller unit (MCU) and a digital signal processor (DSP) that work in tandem to manage UCI for hybrid beamforming on a PUSCH.

Based on type I configuration that is whether PMI report is wideband or sub band different table is used for Encoding. In a CRI based reporting, only single CRI is reported. To extend UCI design for multiple CRI, the tables has been extended to support multiple CRIs and each CRI having RI, PMI, and CQI. When the UE (102) is configured to report CRI-RI-CQI mode and cqi-FormatIndicator=widebandCQI or PMI is set to WB PMI and CQI is WB CQI, the following enhancement are provided to a table. The highlighted portion indicates addition of CSI fields to CSI report #n where n in integer value. Max value of M, the number of reported CRI, is 4 for type I and 2 type II configured by gNB by higher layer parameter.

The UE (102) can estimate the N_Rx×N_Tx effective channel matrix H and thus the channel rank indicator (RI), precoding matrix indicator (PMI), and channel quality indicator (CQI). A CSI-RS signal is transmitted on a set of time frequency resource elements (REs) associated with an antenna port. For channel estimation over a system bandwidth, the CSI-RS is typically transmitted over the whole system bandwidth. The set of REs used for CSI-RS transmission is referred to as CSI-RS resource. From the UE (102) point of view, an antenna port is equivalent to a CSI-RS that the UE (102) may use to measure the channel. In NR, two types of CSI feedbacks may be supported for closed-loop transmission, i.e., Type I and Type II. Type I is codebook based PMI feedback with normal resolution targeting Single User MIMO (SU MIMO) transmissions. Type II is an enhanced CSI feedback with higher resolution targeting multi-user MIMO (MU-MIMO) transmissions.

For both types of codebook, the PMI for each sub band is split up into two indices, i_1 and i_2. I_1 is reported on a wideband basis (i.e., it is the same for all sub bands) while i_2 is reported per sub band (if sub band reporting is configured). In Type I CSI reporting, the bit width of i_1, is on the order of ˜ 10 bits and the bit width of i_2, is up to 4 bits, which correspond to a relatively low overhead. For Type II reporting, it can be very high compared to type I. In NR, in addition to periodic and aperiodic CSI reporting as in LTE, semi-persistent CSI reporting is also supported. The three modes of CSI reporting may be supported in NR as follows:
Periodic CSI reporting: CSI is reported periodically by the UE (102). Parameters such as periodicity and sub frame offset are configured semi-statically, by higher layer signaling from the gNB to the UE (102);
Aperiodic CSI reporting: This mode of CSI reporting involves a single-shot (i.e., one time) CSI report by the UE (102) which is dynamically triggered by the gNB, e.g., by the DCI in PDCCH. Some of the parameters related to the configuration of the aperiodic CSI report are semi-statically configured from the gNB to the UE (102) but the triggering is dynamic; and
Semi-Persistent CSI reporting: similar to periodic CSI reporting, semi-persistent CSI reporting periodicity and subframe offset which can be semi statically configured by the gNB to the UE (102). However, a dynamic trigger from gNB to the UE (102) can be performed to allow the UE (102) to begin semi-persistent CSI reporting. In some cases, a dynamic trigger from gNB to UE can be performed to command the UE (102) to stop the semi-persistent transmission of CSI reports.

It has been agreed that in NR, the UE (102) can be configured with N=1 CSI reporting settings, M>1 resource settings, and 1 CSI measurement setting, where the CSI measurement setting includes L 1 links and value of L may depend on the capability of the UE (102). At least the following configuration parameters are signalled via RRC at least for CSI acquisition:

In each CSI reporting setting, at least: reported CSI parameter(s), CSI Type (I or II) if reported, code book configuration including codebook subset restriction, time-domain behaviour, frequency granularity for CQI and PMI, measurement restriction configurations;

In each resource setting A configuration of S≥1 CSI-RS resource set(S), A configuration of K_s_≥1 CSI-RS resources for each set s, including at least: mapping to REs, the number of ports, time-domain behavior, etc.; and

Like in LTE, there is a need for uplink L1/L2 control signaling to support data transmission on downlink and uplink transport channels. Uplink L1/L2 control signaling consists of:
Hybrid-ARQ acknowledgments for received DL-SCH transport blocks;
Channel-state information (CSI) related to the downlink channel conditions, used to assist downlink scheduling, including multi-antenna and beamforming schemes; and
Scheduling requests, indicating that a device requests uplink resources for UL-SCH transmission.

There is no UL-SCH transport-format information included in the uplink transmission. The gNB is in complete control of the uplink UL-SCH transmissions and the device always follows the scheduling grants received from the network, including the UL-SCH transport format specified in those grants. Thus, the network knows the transport format used for the UL-SCH transmission in advance and there is no need for any explicit transport-format signaling on the uplink.

In NR, it has been agreed that CSI in UCI when transmitted on PUSCH is split up into two separately encoded parts, Where the first CSI part is of a known payload size (and typically small), containing at least RI and CQI, and where the second CSI part has a variable payload size and contains the remaining CSI parameters such as PMI. Based on decoding the first CSI part, the UE (102) knows the payload size of the second CSI part and can decode it.

One issue with Type II CSI reporting is that the payload can vary drastically depending on rank selected by the UE (102).

As the gNB is unaware of the selected RI when allocating the PUSCH resources

One issue with Type II CSI reporting is that the payload can vary drastically depending on rank selected by the UE (102). As the gNB is unaware of the selected RI when allocating the PUCCH resources, it could potentially allocate a too small resource so that the CSI payload may not fit. Therefore, it was decided to introduce a mechanism for how the UE (102) may handle such cases.

Separately encoded parts of a CSI report have different transmission priority. Part 1 (used to identify the number of information bits in part 2) has higher priority. For Release 19 (NR Phase 5 MIMO), CRI based reporting for hybrid beamforming was agreed for more than one resource for better feedback and scheduling of the UE (102). A CSI Type I feedback was agreed for CRI based reporting. And also, up to one resource feedback out of multiple resources was adopted.

For CRI based reporting, When more than one NZP CSI-RS resources are contained in the selected NZP CSI-RS resource set for channel measurement, a multiple CSI-RS resource indicator (CRI) is reported by the UE (102) to indicate to the gNB about the multiple selected NZP CSI-RS resource in the resource set, together with RI, PMI and CQI associated with the each selected NZP CSI-RS resource. The number of CRI and their associated RI, PMI and CQI to be reported are configured by gNB by higher layer parameter.

For multiple CRI based reporting for hybrid beamforming in release 19, both Type I and Type II-r16 has been agreed as of RAN1 meeting #116b. For multiple CRI reporting, UCI packing information also may be updated for multiple RI, PMI and CQIs. In one of the agreements in RAN1 meeting #116b, there was discussion on whether to prioritize some resources that is Mᵣ resources out of M resources.

Based on type of CSI configuration that is periodic, semi-persistent and aperiodic and reporting mode, the UE (102) can send CSI feedback data on PUCCH/PUSCH. CSI feedback Type I and type II-r16 wideband Report both can be sent on PUCCH.

In NR phase MIMO, to address the issue of the coverage, higher downlink spectrum efficiency, larger antenna arrays for single transmission point transmissions with an increased number of antennas have an increased interest in the industry. In specifications, the support for such large antenna arrays with large number of CSI-RS ports for CSI measurement and reporting is limited. With large number of ports, to increase the multi user-MIMO scheduling opportunities, multiple CRI based hybrid beamforming has been provided for enhancement. A UCI design is inadequate to support multiple CRI based report for CSI type I and Type II-r16. In order to support this, enhancements has been provided in the present disclosure to a UCI design.

Based on type I configuration that is whether PMI report is wideband or sub band different table is used for Encoding. In CRI based reporting, only single CRI is reported. To extend UCI design for multiple CRI to report on PUSCH, following tables has been extended to support multiple CRIs and each CRI having RI, PMI, and CQI.

For CSI reporting on PUSCH, If cqi-BitsPerSubband is configured, this applies by taking Sub band CQI as Sub band differential CQI and replacing the corresponding number of bits 2 by 4.

The bit width for PMI of codebookType=typeI-SinglePanel and codebookType=typeI-MultiPanel is specified in 3GPP specification.

The table used for encoding CRI, RI, LI, CQI is given as

TABLE 6.3.1.1.2-3
RI, LI, CQI, and CRI of codebookType = typeI-SinglePanel, or
reportQuantity set to “cri-RI-CQI,” or 1 CSI-RS port

| | Bitwidth | | | | |
|---|---|---|---|---|---|
| | 1 antenna | | | > 4 antenna ports | |
| Field | port | 2 antenna ports | 4 antenna ports | Rank1~4 | Rank5~8 |
| rank indicator | 0 | min(1, ┌log₂ n_{RI}┐) | min(2, ┌log₂ n_{RI}┐) | ┌log₂ n_{RI}┐ | ┌log₂ n_{RI}┐ |
| when | | | | | |
| codebookType = | | | | | |
| typeI- | | | | | |
| SinglePanel | | | | | |
| rank indicator | 0 | 1 | 2 | 3 | 3 |
| when | | | | | |
| reportQuantity | | | | | |
| set to “cri-RI- | | | | | |
| CQI” | | | | | |
| Layer Indicator | 0 | ┌log₂ v┐ | min(2, ┌log₂ v┐) | min(2, ┌log₂ [symbol] | min(2, ┌log₂ [symbol] |
| Wide-band | 4 | 4 | 4 | 4 | 4 |
| CQI for the first | | | | | |
| TB | | | | | |
| Wideband CQI | 0 | 0 | 0 | 0 | 4 |
| for the second | | | | | |
| TB | | | | | |
| Subband | 2 | 2 | 2 | 2 | 2 |
| differential | | | | | |
| CQI for the first | | | | | |
| TB | | | | | |
| Subband | 0 | 0 | 0 | 0 | 2 |
| differential | | | | | |
| CQI for the | | | | | |
| second TB | | | | | |
| CRI | $⌈ {log}_{2} ( {K}_{s}^{CSI - R} \text{?}$ | $⌈ {log}_{2} ( {K}_{s}^{CSI - RS} ⌉$ | $⌈ {log}_{2} ( {K}_{s}^{CSI - RS} ⌉$ | $⌈ {log}_{2} ( {K}_{s}^{CSI - R} \text{?}$ | $⌈ {log}_{2} ( {K}_{s}^{CSI - RS} \text{?}$ |

[symbol]

indicates data missing or illegible when filed

n_{RI} In Table 6.3.1.1.2-3 is the number of allowed rank indicator values, 9 is the value of the rank. The value of K_s\hat{ }(CSI-RS) is the number of CSI-RS resources in the corresponding resource set the values of the rank indicator field are mapped to allowed rank indicator values with increasing order, where “0” is mapped to the smallest allowed rank indicator value. For higher layer parameter reportQuantity set to “cri-RI-CQI,” the values of the rank indicator field are mapped to rank indicator values with increasing order, where “0” is mapped to rank-1.

The bit width for PMI of codebookType=typeII-r16 is provided in Tables 6.3.2.1.2-1A, where the values of (N₁, N₂), (O₁, O₂), L, K^{NZ}, N₃, and {Mihl=1,.,y (N₁, N₂) are logical Antenna ports in Horizontal and vertical direction:
(O₁, O₂) are oversampling factor in horizontal and vertical direction;
L is number of spatial DFT beams to be selected for increasing resolution of codebook;
N_{PSK} is the phase reporting per beam;
{Mₗ}_{l=1, . . . ,v} w is the number of DFT beams in frequency domain;
K^{NZ} is the number of non zero coefficients; and/or
N₃ is the number of sub bands.

TABLE 6.3.2.1.2-1A
PMI of codebookType = typeII-r16

| | Information fields X₁ | | | | | | |
|---|---|---|---|---|---|---|---|
| | i_{1,1} | i_{1,2} | i_{1,8,1} | i_{1,8,2} | i_{1,8,3} | i_{1,8,4} | |
| Rank = 1 N₃ ≤ 19 | ┌log₂(O₁O₂)┐ | $⌈ {log}_{2} ( \begin{matrix}{N}_{1} {N}_{2} \\ L\end{matrix} ) ⌉$ | ┌log₂K^{NZ}┐ | N/A | N/A | N/A | |
| Rank = 2 N₃ ≤ 19 | ┌log₂(O₁O₂)┐ | $⌈ {log}_{2} ( \begin{matrix}{N}_{1} {N}_{2} \\ L\end{matrix} ) ⌉$ | ┌log₂(2L)┐ | ┌log₂(2L)┐ | N/A | N/A | |
| Rank = 3 N₃ ≤ 19 | ┌log₂(O₁O₂)┐ | $⌈ {log}_{2} ( \begin{matrix}{N}_{1} {N}_{2} \\ L\end{matrix} ) ⌉$ | ┌log₂(2L)┐ | ┌log₂(2L)┐ | ┌log₂(2L)┐ | N/A | |
| Rank = 4 N₃ ≤ 19 | ┌log₂(O₁O₂)┐ | $⌈ {log}_{2} ( \begin{matrix}{N}_{1} {N}_{2} \\ L\end{matrix} ) ⌉$ | ┌log₂(2L)┐ | ┌log₂(2L)┐ | ┌log₂(2L)┐ | ┌log₂(2L)┐ | |
| Rank = 1 N₃ > 19 | ┌log₂(O₁O₂)┐ | $⌈ {log}_{2} ( \begin{matrix}{N}_{1} {N}_{2} \\ L\end{matrix} ) ⌉$ | ┌log₂ K^{NZ}┐ | N/A | N/A | N/A | |
| Rank = 2 N₃ > 19 | ┌log₂(O₁O₂)┐ | $⌈ {log}_{2} ( \begin{matrix}{N}_{1} {N}_{2} \\ L\end{matrix} ) ⌉$ | ┌log₂(2L)┐ | ┌log₂(2L)┐ | N/A | N/A | |
| Rank = 3 N₃ > 19 | ┌log₂ (O₁O₂)┐ | $⌈ {log}_{2} ( \begin{matrix}{N}_{1} {N}_{2} \\ L\end{matrix} ) ⌉$ | ┌log₂(2L)┐ | ┌log₂(2L)┐ | ┌log₂(2L)┐ | N/A | |
| Rank = 4 N₃ > 19 | ┌log₂ (O₁O₂)┐ | $⌈ {log}_{2} ( \begin{matrix}{N}_{1} {N}_{2} \\ L\end{matrix} ) ⌉$ | ┌log₂(2L)┐ | ┌log₂(2L)┐ | ┌log₂(2L)┐ | ┌log₂(2L)┐ | |
| | Information fields X₂ | | | | | | |
| | i_{2,3,1} | i_{2,3,2} | i_{2,3,3} | i_{2,3,4} | i_{1,5} | i_{1,6,1} | i_{1,6,2} |
| Rank = 1 N₃ ≤ 19 | 4 | N/A | N/A | N/A | N/A | $⌈ {log}_{2} ( \begin{matrix}{N}_{3} \\ {M}_{1}\end{matrix} \text{?}$ | N/A |
| Rank = 2 N₃ ≤ 19 | 4 | 4 | N/A | N/A | N/A | $⌈ {log}_{2} ( \begin{matrix}{N}_{3} \\ {M}_{2}\end{matrix} \text{?}$ | $⌈ {log}_{2} ( \begin{matrix}{N}_{3} \\ {M}_{2}\end{matrix} \text{?}$ |
| Rank = 3 N₃ ≤ 19 | 4 | 4 | 4 | N/A | N/A | $⌈ {log}_{2} ( \begin{matrix}{N}_{3} \\ {M}_{3}\end{matrix} \text{?}$ | $⌈ {log}_{2} ( \begin{matrix}{N}_{3} \\ {M}_{3}\end{matrix} \text{?}$ |
| Rank = 4 N₃ ≤ 19 | 4 | 4 | 4 | 4 | N/A | $⌈ {log}_{2} ( \begin{matrix}{N}_{3} \\ {M}_{4}\end{matrix} \text{?}$ | $⌈ {log}_{2} ( \begin{matrix}{N}_{3} \\ {M}_{4}\end{matrix} \text{?}$ |
| Rank = 1 N₃ > 19 | 4 | N/A | N/A | N/A | ┌log₂ (2 [symbol] | $⌈ {log}_{2} ( \begin{matrix}2 M \\ {M}_{1}\end{matrix} \text{?}$ | N/A |
| Rank = 2 N₃ > 19 | 4 | 4 | N/A | N/A | ┌log₂ (2 [symbol] | $⌈ {log}_{2} ( \begin{matrix}2 M \\ {M}_{2}\end{matrix} \text{?}$ | $⌈ {log}_{2} ( \begin{matrix}2 M \\ {M}_{2}\end{matrix} \text{?}$ |
| Rank = 3 N₃ > 19 | 4 | 4 | 4 | N/A | ┌log₂ (2 [symbol] | $⌈ {log}_{2} ( \begin{matrix}2 M \\ {M}_{3}\end{matrix} \text{?}$ | $⌈ {log}_{2} ( \begin{matrix}2 M \\ {M}_{3}\end{matrix} \text{?}$ |
| Rank = 4 N₃ > 19 | 4 | 4 | 4 | 4 | ┌log₂ (2 [symbol] | $⌈ {log}_{2} ( \begin{matrix}2 M \\ {M}_{4}\end{matrix} \text{?}$ | $⌈ {log}_{2} ( \begin{matrix}2 M \\ {M}_{4}\end{matrix} \text{?}$ |
| | | | Information fields X₂ | | | | |
| | | | i_{1,6,3} | i_{1,6,4} | {i_{2,4,l}} [symbol] | {i_{2,5,l}} [symbol] | {i_{2,7,l}} [symbol] |
| | | Rank = 1 N₃ ≤ 19 | N/A | N/A | 3(K^{NZ} − 1) | 4(K^{NZ} − 1) | 2LM₁ |
| | | Rank = 2 N₃ ≤ 19 | N/A | N/A | 3(K^{NZ} − 2) | 4(K^{NZ} − 2) | 4LM₂ |
| | | Rank = 3 N₃ ≤ 19 | $⌈ {log}_{2} ( \begin{matrix}{N}_{3} \\ {M}_{3}\end{matrix} \text{?}$ | N/A | 3(K^{NZ} − 3) | 4(K^{NZ} − 3) | 6LM₃ |
| | | Rank = 4 N₃ ≤ 19 | $⌈ {log}_{2} ( \begin{matrix}{N}_{3} \\ {M}_{4}\end{matrix} \text{?}$ | $⌈ {log}_{2} ( \begin{matrix}{N}_{3} \\ {M}_{4}\end{matrix} \text{?}$ | 3(K^{NZ} − 4) | 4(K^{NZ} − 4) | 8LM₄ |
| | | Rank = 1 N₃ > 19 | N/A | N/A | 3(K^{NZ} − 1) | 4(K^{NZ} − 1) | 2LM₁ |
| | | Rank = 2 N₃ > 19 | N/A | N/A | 3(K^{NZ} − 2) | 4(K^{NZ} − 2) | 4LM₂ |
| | | Rank = 3 N₃ > 19 | $⌈ {log}_{2} ( \begin{matrix}2 M \\ {M}_{3}\end{matrix} \text{?}$ | N/A | 3(K^{NZ} − 3) | 4(K^{NZ} − 3) | 6LM₃ |
| | | Rank = 4 N₃ > 19 | $⌈ {log}_{2} ( \begin{matrix}2 M \\ {M}_{4}\end{matrix} \text{?}$ | $⌈ {log}_{2} ( \begin{matrix}2 M \\ {M}_{4}\end{matrix} \text{?}$ | 3(K^{NZ} − 4) | 4(K^{NZ} − 4) | 8LM₄ |

$NOTE : \\ the bitwidth for {\{ {i}_{1 , 7 , l} \}}_{l = 1 , … , v} , {\{ {i}_{2 , 4 , l} \}}_{l = 1 , … , v} and {\{ {i}_{1 = 2 , 5 , l} \}}_{l = 1 , … , v} shown in Table 6.3 \text{.2} \text{.1} \text{.2} - 1 A is the total bitwidth of \{ {i}_{1 , 7 , l} \} , \{ {i}_{2 , 4 , l} \} and \{ {i}_{1 = 2 , 5 , l} \} up to Rank = v , respectively , and the corresponding per layer bitwidths are 2 {LM}_{v} , 3 ( {K}_{l}^{NZ} - 1 ) , and 4 ( {K}_{l}^{NZ} - 1 ) , ( i . e . , 1 , 3 , and 4 bits for each respective indicator elements {k}_{l , i , f}^{( 3 )} , {k}_{l , i , f}^{( 2 )} , and {c}_{l , i , f} , respectively ) , where {K}_{l}^{NZ} as defined in TS 38.214 is the number of nonzero coefficients for layer l such that {K}^{NZ} = {\sum }_{l = 1}^{v} {K}_{l}^{NZ} .$ [symbol] indicates data missing or illegible when filed

For CSI reporting on part 1 PUSCH, CRI, rank indicator, wideband CQI for 1st TB, Subband CQI for 1^{st} TB has been added for all the CRIs. Total number of non zero coefficients is only for CRI and 1 and CRI 2 as shown below. Max CRI for Type I is M=4 and for Type II M=2.

TABLE 6.3.2.1.2-3
Mapping order of CSI fields of one CSI report, CSI part 1

| CSI report | |
|---|---|
| number | CSI fields |
| CSI report | CRI as in Tables 6.3.1.1.2-3/4/6, if reported |
| #n | rank indicator as in Tables 6.3.1.1.2-3/4/5 or 6.3.2.1.2-8/8A/8B/9/9A, if reported |
| CSI part 1 | Wideband CQI for the first TB as in Tables 6.3.1.1.2-3/4/5 or 6.3.2.1.2-8/8A/8B/9/9A, |
| | if reported |
| | Subband differential CQI for the first TB with increasing order of subband number as |
| | in Tables 6.3.1.1.2-3/4/5 or 6.3.2.1.2-8/8A/8B/9/9A, if reported |
| | Indicator of the number of non-zero wideband amplitude coefficients M₀ for layer 0 as |
| | in Table 6.3.1.1.2-5, if reported |
| | Indicator of the number of non-zero wideband amplitude coefficients M₁ for layer 1 as |
| | in Table 6.3.1.1.2-5 (if the rank according to the reported RI is equal to one, this field |
| | is set to all zeros), if 2-layer PMI reporting is allowed according to the rank restriction |
| | in TS 38.214 and if reported |
| | Indicator of the N₀ selected CSI-RS resources by a bitmap with N_{TRP} bits, this field is |
| | present only if N_{TRP} > 1 and restrictedCMR-Selection is configured to OFF |
| | Indicator of selected Lₙ value combination or αₙ value combination with bitwidth of |
| | [log₂(N_{L})], this field is present only if N_{L} > 1 |
| | Indicator of the total number of non-zero coefficients summed across all layers K^{NZ} as |
| | in Tables 6.3.2.1.2-8/8A/8B/9/9A, if reported |
| | 2^{nd} CRI as in Tables 6.3.1.1.2-3/4/6, if reported for M > 1 resources selected, if reported |
| | 2^{nd} CRI rank indicator as in Tables 6.3.1.1.2-3/4/5 or 6.3.2.1.2-8/8A/8B/9/9A, if |
| | reported |
| | 2^{nd} CRI Wideband CQI for the first TB as in Tables 6.3.1.1.2-3/4/5 or 6.3.2.1.2- |
| | 8/8A/8B/9/9A, if reported |
| | 2^{nd} CRI Subband differential CQI for the first TB with increasing order of subband |
| | number as in Tables 6.3.1.1.2-3/4/5 or 6.3.2.1.2-8/8A/8B/9/9A, if reported |
| | 2^{nd} CRI Indicator of the total number of non-zero coefficients summed across all layers |
| | K^{NZ} as in Tables 6.3.2.1.2-8/8A/8B/9/9A, if reported, for M > 1 and if Ks > 1 resources |
| | are configured |
| | 3^{rd} CRI as in Tables 6.3.1.1.2-3/4/6, if reported for M > 1 resources selected, if reported |
| | 3^{rd} CRI rank indicator as in Tables 6.3.1.1.2-3/4/5 or 6.3.2.1.2-8/8A/8B/9/9A, if |
| | reported |
| | 3^{rd} CRI Wideband CQI for the first TB as in Tables 6.3.1.1.2-3/4/5 or 6.3.2.1.2- |
| | 8/8A/8B/9/9A, if reported |
| | 3^{rd} CRI Subband differential CQI for the first TB with increasing order of subband |
| | number as in Tables 6.3.1.1.2-3/4/5 or 6.3.2.1.2-8/8A/8B/9/9A, if reported |
| | 4^{th} CRI as in Tables 6.3.1.1.2-3/4/6, if reported for M > 1 resources selected, if reported |
| | 4^{th} CRI rank indicator as in Tables 6.3.1.1.2-3/4/5 or 6.3.2.1.2-8/8A/8B/9/9A, if |
| | reported |
| | 4^{th} CRI Wideband CQI for the first TB as in Tables 6.3.1.1.2-3/4/5 or 6.3.2.1.2- |
| | 8/8A/8B/9/9A, if reported |
| | 4^{th} CRI Subband differential CQI for the first TB with increasing order of subband |
| | number as in Tables 6.3.1.1.2-3/4/5 or 6.3.2.1.2-8/8A/8B/9/9A, if reported |

NOTE:
Subbands for given CSI report n indicated by the higher layer parameter csi-ReportingBand are numbered continuously in the increasing order with the lowest subband of csi-ReportingBand as subband 0.

In an embodiment, of CSI part 1 on PUSCH, with single CSI report, is shown in table below, where within in each report i.e., CSI report #n, new sub partition is added CSI report #n, Mth CRI, Where M∈{0,1, . . . M−1} the number of reported CRI, is 4 for type I and 2 type II-r16 configured by gNB by higher layer parameter.

TABLE 6.3.2.1.2-3
Mapping order of CSI fields of one CSI report, CSI part 1

| CSI report | |
|---|---|
| number | CSI fields |
| CSI report | CRI as in Tables 6.3.1.1.2-3/4/6, if reported |
| #n | rank indicator as in Tables 6.3.1.1.2-3/4/5 or 6.3.2.1.2-8/8A/8B/9/9A, if reported |
| CSI part 1, | Wideband CQI for the first TB as in Tables 6.3.1.1.2-3/4/5 or 6.3.2.1.2-8/8A/8B/9/9A, |
| Mth CRI | if reported |
| | Subband differential CQI for the first TB with increasing order of subband number as |
| | in Tables 6.3.1.1.2-3/4/5 or 6.3.2.1.2-8/8A/8B/9/9A, if reported |
| | Indicator of the number of non-zero wideband amplitude coefficients M₀ for layer 0 as |
| | in Table 6.3.1.1.2-5, if reported |
| | Indicator of the number of non-zero wideband amplitude coefficients M₁ for layer 1 as |
| | in Table 6.3.1.1.2-5 (if the rank according to the reported RI is equal to one, this field |
| | is set to all zeros), if 2-layer PMI reporting is allowed according to the rank restriction |
| | in TS 38.214 and if reported |
| | Indicator of the No selected CSI-RS resources by a bitmap with NTRP bits, this field is |
| | present only if NTRP > 1 and restrictedCMR-Selection is configured to OFF |
| | Indicator of selected Ln value combination or an value combination with bitwidth of |
| | [log₂(N_{L})], this field is present only if N_{L} > 1 |
| | Indicator of the total number of non-zero coefficients summed across all layers K^{NZ} as |
| | in Tables 6.3.2.1.2-8/8A/8B/9/9A, if reported |

NOTE:
Subbands for given CSI report n indicated by the higher layer parameter csi-ReportingBand are numbered continuously in the increasing order with the lowest subband of csi-ReportingBand as subband 0.

In an embodiment, of CSI part 1 on PUSCH, CSI part is extended adding K CRIs, K RIs, 1 WB CQI associated with the 1^{st} CRI of the 1^{st} TB, 1 set of SB CQIs associated with the 1^{st} CRI of the 1^{st} TB and 1 K^{NZ} (M=2, type2-r16) after fields and in the same order as shown in table below.

TABLE 6.3.2.1.2-3
Mapping order of CSI fields of one CSI report, CSI part 1

| CSI report | |
|---|---|
| number | CSI fields |
| CSI report | 1^{st} CRI as in Tables 6.3.1.1.2-3/4/6, if reported |
| #n | 1^{st} rank indicator as in Tables 6.3.1.1.2-3/4/5 or 6.3.2.1.2-8/8A/8B/9/9A, if reported |
| CSI part 1 | 1^{st} Wideband CQI for the first TB as in Tables 6.3.1.1.2-3/4/5 or 6.3.2.1.2- |
| | 8/8A/8B/9/9A, if reported |
| | 1^{st} Subband differential CQI for the first TB with increasing order of subband |
| | number as in Tables 6.3.1.1.2-3/4/5 or 6.3.2.1.2-8/8A/8B/9/9A, if reported |
| | Indicator of the number of non-zero wideband amplitude coefficients M₀ for layer |
| | 0 as in Table 6.3.1.1.2-5, if reported |
| | Indicator of the number of non-zero wideband amplitude coefficients M₁ for layer |
| | 1 as in Table 6.3.1.1.2-5 (if the rank according to the reported RI is equal to one, |
| | this field is set to all zeros), if 2-layer PMI reporting is allowed according to the |
| | rank restriction in TS 38.214 and if reported |
| | Indicator of the N₀ selected CSI-RS resources by a bitmap with N_{TRP} bits, this field |
| | is present only if N_{TRP} > 1 and restrictedCMR-Selection is configured to OFF |
| | Indicator of selected Lₙ value combination or αₙ value combination with bitwidth |
| | of [log₂(N_{L})], this field is present only if N_{L} > 1 |
| | Indicator of the total number of non-zero coefficients summed across all layers K^{NZ} |
| | as in Tables 6.3.2.1.2-8/8A/8B/9/9A, if reported |
| | 2^{nd} CRI as in Tables 6.3.1.1.2-3/4/6, if reported for M > 1 resources selected, if |
| | reported |
| | 2^{nd} CRI rank indicator as in Tables 6.3.1.1.2-3/4/5 or 6.3.2.1.2-8/8A/8B/9/9A, if |
| | reported |
| | 2^{nd} CRI Indicator of the total number of non-zero coefficients summed across all |
| | layers K^{NZ} as in Tables 6.3.2.1.2-8/8A/8B/9/9A, if reported, for M > 1 and if Ks > 1 |
| | resources are configured |
| | 3^{rd} CRI as in Tables 6.3.1.1.2-3/4/6, if reported for M > 1 resources selected, if |
| | reported |
| | 3^{rd} CRI rank indicator as in Tables 6.3.1.1.2-3/4/5 or 6.3.2.1.2-8/8A/8B/9/9A, if |
| | reported |
| | 4^{th} CRI as in Tables 6.3.1.1.2-3/4/6, if reported for M > 1 resources selected, if |
| | reported |
| | 4^{th} CRI rank indicator as in Tables 6.3.1.1.2-3/4/5 or 6.3.2.1.2-8/8A/8B/9/9A, if |
| | reported |

NOTE:
Subbands for given CSI report n indicated by the higher layer parameter csi-ReportingBand are numbered continuously in the increasing order with the lowest subband of csi-ReportingBand as subband 0.

In an embodiment, of CSI part 1 reporting on PUSCH, CSI part is extended adding M CRIs, M RIs, Mᵣ WB CQI associated with the Mᵣ of the 1^{st} TB, Mᵣ set of SB CQIs associated with the Mᵣ CRI of the 1^{st} TB and 1 K^{NZ} (M=2, type2-r16) after fields and in the same order where Mᵣ is higher priority resources as shown in table below. The configuration high priority resources has been described above.

TABLE 6.3.2.1.2-3
Mapping order of CSI fields of one CSI report, CSI part 1

| CSI report | |
|---|---|
| number | CSI fields |
| CSI report | 1^{st} CRI as in Tables 6.3.1.1.2-3/4/6, if reported |
| #n | 1^{st} rank indicator as in Tables 6.3.1.1.2-3/4/5 or 6.3.2.1.2-8/8A/8B/9/9A, if reported |
| CSI part 1 | 1^{st} Wideband CQI for the first TB as in Tables 6.3.1.1.2-3/4/5 or 6.3.2.1.2- |
| | 8/8A/8B/9/9A, if reported |
| | 1^{st} Subband differential CQI for the first TB with increasing order of subband number |
| | as in Tables 6.3.1.1.2-3/4/5 or 6.3.2.1.2-8/8A/8B/9/9A, if reported |
| | Indicator of the number of non-zero wideband amplitude coefficients M₀ for layer 0 as |
| | in Table 6.3.1.1.2-5, if reported |
| | Indicator of the number of non-zero wideband amplitude coefficients M₁ for layer 1 as |
| | in Table 6.3.1.1.2-5 (if the rank according to the reported RI is equal to one, this field is |
| | set to all zeros), if 2-layer PMI reporting is allowed according to the rank restriction in |
| | TS 38.214 and if reported |
| | Indicator of the No selected CSI-RS resources by a bitmap with N_{TRP} bits, this field is |
| | present only if N_{TRP} > 1 and restrictedCMR-Selection is configured to OFF |
| | Indicator of selected Lₙ value combination or an value combination with bitwidth of |
| | ┌log₂ (N_{L})┐, this field is present only if N_{L} > 1 |
| | Indicator of the total number of non-zero coefficients summed across all layers K^{NZ} as |
| | in Tables 6.3.2.1.2-8/8A/8B/9/9A, if reported |
| | 2^{nd} CRI as in Tables 6.3.1.1.2-3/4/6, if reported for M > 1 resources selected, if reported |
| | 2^{nd} CRI rank indicator as in Tables 6.3.1.1.2-3/4/5 or 6.3.2.1.2-8/8A/8B/9/9A, if |
| | reported |
| | 2^{nd} Wideband CQI for the first TB as in Tables 6.3.1.1.2-3/4/5 or 6.3.2.1.2- |
| | 8/8A/8B/9/9A, if reported |
| | 2^{nd} Subband differential CQI for the first TB with increasing order of subband number |
| | as in Tables 6.3.1.1.2-3/4/5 or 6.3.2.1.2-8/8A/8B/9/9A, if reported |
| | 2^{nd} CRI Indicator of the total number of non-zero coefficients summed across all layers |
| | K^{NZ} as in Tables 6.3.2.1.2-8/8A/8B/9/9A, if reported, for M > 1 and if Ks > 1 resources |
| | are configured |
| | . . . |
| | . . . |
| | ${M}_{r}^{th} CRI as in Tables 6.3 \text{.1} \text{.1} \text{.2} - 3 \text{/4/} 6 , if reported for M > 1 resources selected , if reported$ |
| | ${M}_{r}^{th} CRI rank indicator as in Tables 6.3 \text{.1} \text{.1} \text{.2} - 3 \text{/4/} 5 or 6.3 \text{.2} \text{.1} \text{.2} - 8 \text{/8A/8B/9/} 9 A , if$ |
| | reported |
| | ${M}_{r}^{th} Wideband CQI for the first TB as in Tables 6.3 \text{.1} \text{.1} \text{.2} - 3 \text{/4/} 5 or 6.3 \text{.2} \text{.1} \text{.2} -$ |
| | 8/8A/8B/9/9A, if reported |
| | ${M}_{r}^{th} Subband CQI for the first TB as in Tables 6.3 \text{.1} \text{.1} \text{.2} - 3 \text{/4/} 5 or 6.3 \text{.2} \text{.1} \text{.2} -$ |
| | as in Tables 6.3.1.1.2-3/4/5 or 6.3.2.1.2-8/8A/8B/9/9A, if reported |
| | (M − Mr + 1) CRI as in Tables 6.3.1.1.2-3/4/6, if reported for M > 1 resources selected, |
| | if reported |
| | (M − Mr + 1) CRI rank indicator as in Tables 6.3.1.1.2-3/4/5 or 6.3.2.1.2-8/8A/8B/9/9A, |
| | if reported |
| | M^{th} CRI as in Tables 6.3.1.1.2-3/4/6, if reported for M > 1 resources selected, if reported |
| | M^{th} CRI rank indicator as in Tables 6.3.1.1.2-3/4/5 or 6.3.2.1.2-8/8A/8B/9/9A, if reported |

NOTE:
Subbands for given CSI report n indicated by the higher layer parameter csi-ReportingBand are numbered continuously in the increasing order with the lowest subband of csi-ReportingBand as subband 0.

In an embodiment, of CSI part 1 on PUSCH, only 1^{st} strongest/or any CRI is reported in CSI part 1 and rest K-1 CRIs are put in CSI part 2 WB as shown in table below.

TABLE 6.3.2.1.2-3
Mapping order of CSI fields of one CSI report, CSI part 1

| CSI report | |
|---|---|
| number | CSI fields |
| CSI report | 1^{st} CRI as in Tables 6.3.1.1.2-3/4/6, if reported |
| #n | 1^{st} CRI rank indicator as in Tables 6.3.1.1.2-3/4/5 or 6.3.2.1.2-8/8A/8B/9/9A, if |
| CSI part 1 | reported |
| | 1^{st} CRI Wideband CQI for the first TB as in Tables 6.3.1.1.2-3/4/5 or 6.3.2.1.2- |
| | 8/8A/8B/9/9A, if reported |
| | 1^{st} CRI Subband differential CQI for the first TB with increasing order of subband |
| | number as in Tables 6.3.1.1.2-3/4/5 or 6.3.2.1.2-8/8A/8B/9/9A, if reported |
| | 1^{st} CRI Indicator of the number of non-zero wideband amplitude coefficients M₀ |
| | for layer 0 as in Table 6.3.1.1.2-5, if reported |
| | 1^{st} CRI Indicator of the number of non-zero wideband amplitude coefficients M₁ |
| | for layer 1 as in Table 6.3.1.1.2-5 (if the rank according to the reported RI is equal |
| | to one, this field is set to all zeros), if 2-layer PMI reporting is allowed according |
| | to the rank restriction in TS 38.214 and if reported |
| | 1^{st} CRI Indicator of the N₀ selected CSI-RS resources by a bitmap with N_{TRP} bits, |
| | this field is present only if N_{TRP} > 1 and restrictedCMR-Selection is configured to |
| | OFF |
| | 1^{st} CRI Indicator of selected Lₙ value combination or αₙ value combination with |
| | bitwidth of [log₂(N_{L})], this field is present only if N_{L} > 1 |
| | 1^{st} CRI Indicator of the total number of non-zero coefficients summed across all |
| | layers K^{NZ} as in Tables 6.3.2.1.2-8/8A/8B/9/9A, if reported |

NOTE:
Subbands for given CSI report n indicated by the higher layer parameter csi-ReportingBand are numbered continuously in the increasing order with the lowest subband of csi-ReportingBand as subband 0.

In an embodiment, of CSI part 1 reporting on PUSCH, CSI part is extended adding Mᵣ CRIs, Mᵣ RIs, Mᵣ WB CQI associated with the Mᵣ of the 1^{st} TB, Mᵣ set of SB CQIs associated with the Mᵣ CRI of the 1^{st} TB and 1 K^{NZ} (M=2, type2-r16) after fields and in the same order where Mᵣ is higher priority resources as shown in table below. The configuration high priority resources has been described above.

| CSI report | |
|---|---|
| number | CSI fields |
| CSI report | 1^{st} CRI as in Tables 6.3.1.1.2-3/4/6, if reported |
| #n | 1^{st} rank indicator as in Tables 6.3.1.1.2-3/4/5 or 6.3.2.1.2-8/8A/8B/9/9A, if reported |
| CSI part 1 | 1^{st} Wideband CQI for the first TB as in Tables 6.3.1.1.2-3/4/5 or 6.3.2.1.2- |
| | 8/8A/8B/9/9A, if reported |
| | 1^{st} Subband differential CQI for the first TB with increasing order of subband number |
| | as in Tables 6.3.1.1.2-3/4/5 or 6.3.2.1.2-8/8A/8B/9/9A, if reported |
| | Indicator of the number of non-zero wideband amplitude coefficients M₀ for layer 0 |
| | as in Table 6.3.1.1.2-5, if reported |
| | Indicator of the number of non-zero wideband amplitude coefficients M₁ for layer 1 |
| | as in Table 6.3.1.1.2-5 (if the rank according to the reported RI is equal to one, this |
| | field is set to all zeros), if 2-layer PMI reporting is allowed according to the rank |
| | restriction in TS 38.214 and if reported |
| | Indicator of the No selected CSI-RS resources by a bitmap with N_{TRP} bits, this field |
| | is present only if N_{TRP} > 1 and restrictedCMR-Selection is configured to OFF |
| | Indicator of selected Lₙ value combination or αₙ value combination with bitwidth of |
| | [log₂(N_{L})], this field is present only if N_{L} > 1 |
| | Indicator of the total number of non-zero coefficients summed across all layers K^{NZ} |
| | as in Tables 6.3.2.1.2-8/8A/8B/9/9A, if reported |
| | 2^{nd} CRI as in Tables 6.3.1.1.2-3/4/6, if reported for M > 1 resources selected, if |
| | reported |
| | 2^{nd} CRI rank indicator as in Tables 6.3.1.1.2-3/4/5 or 6.3.2.1.2-8/8A/8B/9/9A, if |
| | reported |
| | 2^{nd} Wideband CQI for the first TB as in Tables 6.3.1.1.2-3/4/5 or 6.3.2.1.2- |
| | 8/8A/8B/9/9A, if reported |
| | 2^{nd} Subband differential CQI for the first TB with increasing order of subband number |
| | as in Tables 6.3.1.1.2-3/4/5 or 6.3.2.1.2-8/8A/8B/9/9A, if reported |
| | 2^{nd} CRI Indicator of the total number of non-zero coefficients summed across all |
| | layers K^{NZ} as in Tables 6.3.2.1.2-8/8A/8B/9/9A, if reported, for M > 1 and if Ks > 1 |
| | resources are configured |
| | . . . |
| | . . . |
| | M^{th} CRI as in Tables 6.3.1.1.2-3/4/6, if reported for M > 1 resources selected, if |
| | reported |
| | M^{th} CRI rank indicator as in Tables 6.3.1.1.2-3/4/5 or 6.3.2.1.2-8/8A/8B/9/9A, if |
| | reported |
| | M^{th} CRI Wideband CQI for the first TB as in Tables 6.3.1.1.2-3/4/5 or 6.3.2.1.2- |
| | 8/8A/8B/9/9A, if reported |
| | M^{th} CRI Subband differential CQI for the first TB with increasing order of subband |
| | number as in Tables 6.3.1.1.2-3/4/5 or 6.3.2.1.2-8/8A/8B/9/9A, if reported |

NOTE:
Subbands for given CSI report n indicated by the higher layer parameter csi-ReportingBand are numbered continuously in the increasing order with the lowest subband of csi-ReportingBand as subband 0.

For CSI Part 2 WB reporting on PUSCH, single CRI wideband CQI for 2^{nd} TB, layer indicator, PMI WB X₁ and X₂ are extended to multiple CRI as shown in table below. Extension to table is K WB CQIs for 2^{nd} TB, K LIs, K PMIX₁, and K PMI X₂ after fields and in the same order.

TABLE 6.3.2.1.2-4
Mapping order of CSI fields of one CSI report, CSI part 2 wideband

| CSI report | |
|---|---|
| number | CSI fields |
| CSI Report | 1^{st} CRI Wideband CQI for the second TB as in Tables 6.3.1.1.2-3/4/5, if present and |
| #n | reported |
| Part 2 WB | 1^{st} CRI Layer Indicator as in Tables 6.3.1.1.2-3/4/5, if reported |
| | 1^{st} CRI PMI wideband information fields X₁, from left to right as in Tables 6.3.1.1.2- |
| | 1/2 or 6.3.2.1.2-1/2, if reported |
| | 1^{st} CRI PMI wideband information fields X₂, from left to right as in Tables 6.3.1.1.2- |
| | 1/2 or 6.3.2.1.2-1/2, or codebook index for 2 antenna ports according to TS38.214, if |
| | pmi-FormatIndicator= widebandPMI and if reported |
| | Second CRI Wideband CQI for the second TB as in Tables 6.3.1.1.2-3/4/5, if present |
| | and reported |
| | Second CRI Layer Indicator as in Tables 6.3.1.1.2-3/4/5, if reported |
| | Second CRI PMI wideband information fields X₁, from left to right as in Tables |
| | 6.3.1.1.2-1/2 or 6.3.2.1.2-1/2, if reported |
| | Second CRI PMI wideband information fields X₂, from left to right as in Tables |
| | 6.3.1.1.2-1/2, 6.3.2.1.2-1/2, or codebook index for 2 antenna ports according to |
| | TS38.214, if pmi-FormatIndicator= widebandPMI and if reported |
| | Third CRI Wideband CQI for the second TB as in Tables 6.3.1.1.2-3/4/5, if present |
| | and reported |
| | Second CRI Layer Indicator as in Tables 6.3.1.1.2-3/4/5, if reported |
| | Third CRI PMI wideband information fields X₁, from left to right as in Tables |
| | 6.3.1.1.2-1/2 or 6.3.2.1.2-1/2, if reported |
| | Third CRI PMI wideband information fields X₂, from left to right as in Tables |
| | 6.3.1.1.2-1/2 or 6.3.2.1.2-1/2, or codebook index for 2 antenna ports according to |
| | TS38.214, if pmi-FormatIndicator= widebandPMI and if reported |
| | Fourth CRI Wideband CQI for the second TB as in Tables 6.3.1.1.2-3/4/5, if present |
| | and reported |
| | Fourth CRI Layer Indicator as in Tables 6.3.1.1.2-3/4/5, if reported |
| | Fourth CRI PMI wideband information fields X₁, from left to right as in Tables |
| | 6.3.1.1.2-1/2 or 6.3.2.1.2-1/2, if reported |
| | Fourth CRI PMI wideband information fields X₂, from left to right as in Tables |
| | 6.3.1.1.2-1/2, 6.3.2.1.2-1/2, or codebook index for 2 antenna ports according to |
| | TS38.214, if pmi-FormatIndicator= widebandPMI and if reported |

In an embodiment, for CSI part 2 WB reporting on PUSCH, some of the resources (M-Mᵣ) resources with CRI, RI, PMI, and CQI are present CSI part 2 WB. M and Mᵣ both is RRC configured value which indicates number of CRI to be reported and Mᵣ out of M are reported with high priority out of the rest of resources M to be reported.
In one embodiment, only Mᵣ resource order is configured, with codepoint. The field is this case, is log 2 (Mᵣ!) bits. M-Mᵣ resources are reported in CSI part 2 WB instead of CSI part 1 as considered in above embodiments.
In an embodiment, Whole M order is set by gNB by to the UE (102) by using a higher layer parameter. The length of bits for his field is given aslog₂ (Mᵣ!).

TABLE 6.3.2.1.2-4
Mapping order of CSI fields of one CSI report, CSI part 2 wideband

| CSI | |
|---|---|
| report | |
| number | CSI fields |
| CSI | (M − Mr + 1) CRI as in Tables 6.3.1.1.2-3/4/6, if reported |
| report #n | (M − Mr + 1) CRI rank indicator as in Tables 6.3.1.1.2-3/4/5 or 6.3.2.1.2- |
| CSI part | 8/8A/8B/9/9A, if reported |
| 2 | (M − Mr + 1) CRI Wideband CQI for the first TB as in Tables 6.3.1.1.2-3/4/5 or |
| wideband | 6.3.2.1.2-8/8A/8B/9/9A, if reported |
| | (M − Mr + 1) CRI Subband differential CQI for the first TB with increasing order of |
| | subband number as in Tables 6.3.1.1.2-3/4/5 or 6.3.2.1.2-8/8A/8B/9/9A, if reported |
| | . . . |
| | . . . |
| | M^{th} CRI as in Tables 6.3.1.1.2-3/4/6, if reported |
| | M^{th}CRI rank indicator as in Tables 6.3.1.1.2-3/4/5 or 6.3.2.1.2-8/8A/8B/9/9A, if reported |
| | M^{th} CRI Wideband CQI for the first TB as in Tables 6.3.1.1.2-3/4/5 or 6.3.2.1.2- |
| | 8/8A/8B/9/9A, if reported |
| | M^{th} CRI Subband differential CQI for the first TB with increasing order of subband |
| | number as in Tables 6.3.1.1.2-3/4/5 or 6.3.2.1.2-8/8A/8B/9/9A, if reported |
| | 1^{st} CRI Wideband CQI for the second TB as in Tables 6.3.1.1.2-3/4/5, if present and |
| | reported |
| | 1^{st} CRI Layer Indicator as in Tables 6.3.1.1.2-3/4/5, if reported |
| | 1^{st} CRI PMI wideband information fields X₁, from left to right as in Tables 6.3.1.1.2-1/2 |
| | or 6.3.2.1.2-1/2, if reported |
| | 1^{st} CRI PMI wideband information fields X₂, from left to right as in Tables 6.3.1.1.2-1/2 |
| | or 6.3.2.1.2-1/2, or codebook index for 2 antenna ports according to TS38.214, if pmi- |
| | FormatIndicator = widebandPMI and if reported |
| | Second CRI Wideband CQI for the second TB as in Tables 6.3.1.1.2-3/4/5, if present and |
| | reported |
| | Second CRI Layer Indicator as in Tables 6.3.1.1.2-3/4/5, if reported |
| | Second CRI PMI wideband information fields X₁, from left to right as in Tables 6.3.1.1.2- |
| | 1/2 or 6.3.2.1.2-1/2, if reported |
| | Second CRI PMI wideband information fields X₂, from left to right as in Tables 6.3.1.1.2- |
| | 1/2 [symbol] 6.3.2.1.2-1/2, or codebook index for 2 antenna ports according to TS38.214, if pmi- |
| | FormatIndicator = widebandPMI and if reported |
| | Third CRI Wideband CQI for the second TB as in Tables 6.3.1.1.2-3/4/5, if present and |
| | reported |
| | Second CRI Layer Indicator as in Tables 6.3.1.1.2-3/4/5, if reported |
| | Third CRI PMI wideband information fields X₁, from left to right as in Tables 6.3.1.1.2- |
| | 1/2 or 6.3.2.1.2-1/2, if reported |
| | Third CRI PMI wideband information fields X₂, from left to right as in Tables 6.3.1.1.2- |
| | 1/2 [symbol] 6.3.2.1.2-1/2, or codebook index for 2 antenna ports according to TS38.214, if pmi- |
| | FormatIndicator = widebandPMI and if reported |
| | Fourth CRI Wideband CQI for the second TB as in Tables 6.3.1.1.2-3/4/5, if present and |
| | reported |
| | Fourth CRI Layer Indicator as in Tables 6.3.1.1.2-3/4/5, if reported |
| | Fourth CRI PMI wideband information fields X₁, from left to right as in Tables 6.3.1.1.2- |
| | 1/2 or 6.3.2.1.2-1/2, if reported |
| | Fourth CRI PMI wideband information fields X₂, from left to right as in Tables 6.3.1.1.2- |
| | 1/2 or 6.3.2.1.2-1/2, or codebook index for 2 antenna ports according to TS38.214, if pmi- |
| | FormatIndicator = widebandPMI and if reported |

In an embodiment, M-1 WB CQI for 1^{st} TB and M−1 SB CQIs differential/normal are reported in CSI part 2 WB as shown below.

TABLE 6.3.2.1.2-4
Mapping order of CSI fields of one CSI report, CSI part 2 wideband

| CSI report | |
|---|---|
| number | CSI fields |
| CSI report | 1^{st} CRI Wideband CQI for the second TB as in Tables 6.3.1.1.2-3/4/5, if present and |
| #n | reported |
| CSI part 2 | 1^{st} CRI Layer Indicator as in Tables 6.3.1.1.2-3/4/5, if reported |
| wideband | 1^{st} CRI PMI wideband information fields X₁, from left to right as in Tables 6.3.1.1.2- |
| | 1/2 or 6.3.2.1.2-1/2, if reported |
| | 1^{st} CRI PMI wideband information fields X₂, from left to right as in Tables 6.3.1.1.2- |
| | 1/2 or 6.3.2.1.2-1/2, or codebook index for 2 antenna ports according to TS38.214, if |
| | pmi-FormatIndicator = widebandPMI and if reported |
| | 2^{nd} CRI Wideband CQI for the first TB as in Tables 6.3.1.1.2-3/4/5 or 6.3.2.1.2- |
| | 8/8A/8B/9/9A, if reported |
| | 2^{nd} CRI Subband differential CQI for the first TB with increasing order of subband |
| | number as in Tables 6.3.1.1.2-3/4/5 or 6.3.2.1.2-8/8A/8B/9/9A, if reported |
| | 2^{nd} CRI Wideband CQI for the second TB as in Tables 6.3.1.1.2-3/4/5, if present and |
| | reported |
| | 2^{nd} CRI Layer Indicator as in Tables 6.3.1.1.2-3/4/5, if reported |
| | 2^{nd} CRI PMI wideband information fields X₁, from left to right as in Tables 6.3.1.1.2- |
| | 1/2 or 6.3.2.1.2-1/2, if reported |
| | 2^{nd} CRI PMI wideband information fields X₂, from left to right as in Tables 6.3.1.1.2- |
| | 1/2 or 6.3.2.1.2-1/2, or codebook index for 2 antenna ports according to TS38.214, if |
| | pmi-FormatIndicator = widebandPMI and if reported |
| | . . . |
| | . . . |
| | M^{th} CRI Wideband CQI for the first TB as in Tables 6.3.1.1.2-3/4/5 or 6.3.2.1.2- |
| | 8/8A/8B/9/9A, if reported |
| | M^{th} CRI Subband differential CQI for the first TB with increasing order of subband |
| | number as in Tables 6.3.1.1.2-3/4/5 or 6.3.2.1.2-8/8A/8B/9/9A, if reported |
| | M^{th} CRI Wideband CQI for the second TB as in Tables 6.3.1.1.2-3/4/5, if present and |
| | reported |
| | M^{th} CRI Layer Indicator as in Tables 6.3.1.1.2-3/4/5, if reported |
| | M^{th} CRI PMI wideband information fields X₁, from left to right as in Tables 6.3.1.1.2- |
| | 1/2 or 6.3.2.1.2-1/2, if reported |
| | M^{th} CRI PMI wideband information fields X₂, from left to right as in Tables 6.3.1.1.2- |
| | 1/2 or 6.3.2.1.2-1/2, or codebook index for 2 antenna ports according to TS38.214, if |
| | pmi-FormatIndicator = widebandPMI and if reported |

In an embodiment, M−1 WB CQI for 1^{st} TB and M−1 SB CQIs differential/normal are reported in CSI part 2 WB as shown below.

TABLE 6.3.2.1.2-4
Mapping order of CSI fields of one CSI report, CSI part 2 wideband

| CSI report | |
|---|---|
| number | CSI fields |
| CSI report #n | 1^{st} CRI Wideband CQI for the second TB as in Tables 6.3.1.1.2-3/4/5, if present and |
| CSI part 2 | reported |
| wideband | 1^{st} CRI Layer Indicator as in Tables 6.3.1.1.2-3/4/5, if reported |
| | 1^{st} CRI PMI wideband information fields X₁, from left to right as in Tables 6.3.1.1.2- |
| | 1/2 or 6.3.2.1.2-1/2, if reported |
| | 1st CRI PMI wideband information fields X₂, from left to right as in Tables 6.3.1.1.2- |
| | 1/2 or 6.3.2.1.2-1/2, or codebook index for 2 antenna ports according to TS38.214, |
| | if pmi-FormatIndicator = widebandPMI and if reported |
| | . . . |
| | . . . |
| | (Mr) CRI Wideband CQI for the second TB as in Tables 6.3.1.1.2-3/4/5, if present |
| | and reported |
| | (Mr) CRI Layer Indicator as in Tables 6.3.1.1.2-3/4/5, if reported |
| | (Mr) CRI PMI wideband information fields X₁, from left to right as in Tables |
| | 6.3.1.1.2-1/2 or 6.3.2.1.2-1/2, if reported |
| | (Mr) CRI PMI wideband information fields X₂, from left to right as in Tables |
| | 6.3.1.1.2-1/2 or 6.3.2.1.2-1/2, or codebook index for 2 antenna ports according to |
| | TS38.214, if pmi-FormatIndicator = widebandPMI and if reported |
| | (Mr + 1) CRI Wideband CQI for the first TB as in Tables 6.3.1.1.2-3/4/5 or |
| | 6.3.2.1.2-8/8A/8B/9/9A, if reported |
| | (Mr + 1) CRI Subband differential CQI for the first TB with increasing order of |
| | subband number as in Tables 6.3.1.1.2-3/4/5 or 6.3.2.1.2-8/8A/8B/9/9A, if reported |
| | (Mr + 1) CRI Wideband CQI for the second TB as in Tables 6.3.1.1.2-3/4/5, if |
| | present and reported |
| | (Mr + 1) CRI Layer Indicator as in Tables 6.3.1.1.2-3/4/5, if reported |
| | (Mr + 1) CRI PMI wideband information fields X₁, from left to right as in Tables |
| | 6.3.1.1.2-1/2 or 6.3.2.1.2-1/2, if reported |
| | (Mr + 1) CRI PMI wideband information fields X₂, from left to right as in Tables |
| | 6.3.1.1.2-1/2 or 6.3.2.1.2-1/2, or codebook index for 2 antenna ports according to |
| | TS38.214, if pmi-FormatIndicator = widebandPMI and if reported |
| | . . . |
| | . . . |
| | M^{th} CRI Wideband CQI for the first TB as in Tables 6.3.1.1.2-3/4/5 or 6.3.2.1.2- |
| | 8/8A/8B/9/9A, if reported |
| | M^{th} CRI Subband differential CQI for the first TB with increasing order of subband |
| | number as in Tables 6.3.1.1.2-3/4/5 or 6.3.2.1.2-8/8A/8B/9/9A, if reported |
| | M^{th} CRI Wideband CQI for the second TB as in Tables 6.3.1.1.2-3/4/5, if present |
| | and reported |
| | M^{th} CRI Layer Indicator as in Tables 6.3.1.1.2-3/4/5, if reported |
| | Mth CRI PMI wideband information fields X₁, from left to right as in Tables |
| | 6.3.1.1.2-1/2 or 6.3.2.1.2-1/2, if reported |
| | Mth CRI PMI wideband information fields X₂, from left to right as in Tables |
| | 6.3.1.1.2-1/2 or 6.3.2.1.2-1/2, or codebook index for 2 antenna ports according to |
| | TS38.214, if pmi-FormatIndicator = widebandPMI and if reported |

In an embodiment, for SB reporting for CSI part 2 WB on PUSCH, is shown in table below, where within in each report i.e., CSI report #n, new sub partition is added CSI report #n, Lth CRI. Where L E {0, 1, M−1}.

report

| CSI report | |
|---|---|
| number | CSI fields |
| CSI report #n | Wideband CQI for the second TB as in Tables 6.3.1.1.2-3/4/5, if present and |
| CSI part 2 | reported |
| wideband, Lth | Layer Indicator as in Tables 6.3.1.1.2-3/4/5, if reported |
| CRI | PMI wideband information fields X₁, from left to right as in Tables 6.3.1.1.2-1/2 |
| | or 6.3.2.1.2-1/2, if reported |
| | PMI wideband information fields X₂, from left to right as in Tables 6.3.1.1.2-1/2 |
| | or 6.3.2.1.2-1/2, or codebook index for 2 antenna ports according to TS38.214, if |
| | pmi-FormatIndicator = widebandPMI and if reported |

For CSI part 2 SB, the fields which have been added for each CRI are subbband differential CQI for the second TB for all even subbbands and PMI information X_2 for even subband followed by subbband differential CQI for the second TB for all odd subbbands and PMI information X_2 for odd subband as shown in table below. The order is the same and this extension is after fields.

TABLE 6.3.2.1.2-5
Mapping order of CSI fields of one CSI report, CSI part 2 sub band

| | |
|---|---|
| CSI report #n | Subband differential CQI for the second TB of all even subbands with increasing |
| Part 2 subband | order of subband number, as in Tables 6.3.1.1.2-3/4/5, if cqi- |
| | FormatIndicator = subbandCQI and if reported |
| | PMI subband information fields X₂ of all even subbands with increasing order of |
| | subband number, from left to right as in Tables 6.3.1.1.2-1/2 or 6.3.2.1.2-1/2, or |
| | codebook index for 2 antenna ports according to TS38.214 of all even subbands |
| | with increasing order of subband number, if pmi-FormatIndicator = subbandPMI |
| | and if reported |
| | Subband differential CQI for the second TB of all odd subbands with increasing |
| | order of subband number, as in Tables 6.3.1.1.2-3/4/5, if cqi- |
| | FormatIndicator = subbandCQI and if reported |
| | PMI subband information fields X₂ of all odd subbands with increasing order of |
| | subband number, from left to right as in Tables 6.3.1.1.2-1/2 or 6.3.2.1.2-1/2, or |
| | codebook index for 2 antenna ports according to TS38.214 of all odd subbands |
| | with increasing order of subband number, if pmi-FormatIndicator = subbandPMI |
| | and if reported |
| | Subband differential CQI for the second TB for second CRI of all even subbands |
| | with increasing order of subband number, as in Tables 6.3.1.1.2-3/4/5, if cqi- |
| | FormatIndicator = subbandCQI and if reported |
| | second CRI PMI subband information fields X₂ of all even subbands with |
| | increasing order of subband number, from left to right as in Tables 6.3.1.1.2-1/2 |
| | or 6.3.2.1.2-1/2, or codebook index for 2 antenna ports according to TS38.214 of |
| | all even subbands with increasing order of subband number, if pmi- |
| | FormatIndicator = subbandPMI and if reported |
| | second CRI Subband differential CQI for the second TB of all odd subbands with |
| | increasing order of subband number, as in Tables 6.3.1.1.2-3/4/5, if cqi- |
| | FormatIndicator = subbandCQI and if reported |
| | second CRI PMI subband information fields X₂ of all odd subbands with |
| | increasing order of subband number, from left to right as in Tables 6.3.1.1.2-1/2 |
| | or 6.3.2.1.2-1/2, or codebook index for 2 antenna ports according to TS38.214 of |
| | all odd subbands with increasing order of subband number, if pmi- |
| | FormatIndicator = subbandPMI and if reported |
| | Subband differential CQI for the second TB for Third CRI of all even subbands |
| | with increasing order of subband number, as in Tables 6.3.1.1.2-3/4/5, if cqi- |
| | FormatIndicator = subbandCQI and if reported |
| | Third CRI PMI subband information fields X₂ of all even subbands with |
| | increasing order of subband number, from left to right as in Tables 6.3.1.1.2-1/2 |
| | or 6.3.2.1.2-1/2, or codebook index for 2 antenna ports according to TS38.214 of |
| | all even subbands with increasing order of subband number, if pmi- |
| | FormatIndicator = subbandPMI and if reported |
| | Third CRI Subband differential CQI for the second TB of all odd subbands with |
| | increasing order of subband number, as in Tables 6.3.1.1.2-3/4/5, if cqi- |
| | FormatIndicator = subbandCQI and if reported |
| | Third CRI PMI subband information fields X₂ of all odd subbands with |
| | increasing order of subband number, from left to right as in Tables 6.3.1.1.2-1/2 |
| | or 6.3.2.1.2-1/2, or codebook index for 2 antenna ports according to TS38.214 of |
| | all odd subbands with increasing order of subband number, if pmi- |
| | FormatIndicator = subbandPMI and if reported |
| | Subband differential CQI for the second TB for Fourth CRI of all even subbands |
| | with increasing order of subband number, as in Tables 6.3.1.1.2-3/4/5, if cqi- |
| | FormatIndicator = subbandCQI and if reported |
| | Fourth CRI PMI subband information fields X₂ of all even subbands with |
| | increasing order of subband number, from left to right as in Tables 6.3.1.1.2-1/2 |
| | or 6.3.2.1.2-1/2, or codebook index for 2 antenna ports according to TS38.214of |
| | all even subbands with increasing order of subband number, if pmi- |
| | FormatIndicator = subbandPMI and if reported |
| | Fourth CRI Subband differential CQI for the second TB of all odd subbands with |
| | increasing order of subband number, as in Tables 6.3.1.1.2-3/4/5, if cqi- |
| | FormatIndicator = subbandCQI and if reported |
| | Fourth CRI PMI subband information fields X₂ of all odd subbands with |
| | increasing order of subband number, from left to right as in Tables 6.3.1.1.2-1/2 |
| | or 6.3.2.1.2-1/2, or codebook index for 2 antenna ports according to TS38.214 of |
| | all odd subbands with increasing order of subband number, if pmi- |
| | FormatIndicator = subbandPMI and if reported |

NOTE:
Subbands for given CSI report n indicated by the higher layer parameter csi-ReportingBand are numbered continuously in the increasing order with the lowest subband of csi-ReportingBand as subband 0.

In an embodiment, for CSI part 2 SB, sub band differential CQI for 2^{nd} Tb for even bands and PMI information X_2 for even sub band for all CRIs are in increasing order and then, sub band differential CQI for 2^{nd} Tb for odd sub bands and PMI information X_2 for odd sub band clubbed together after even counterpart as shown in table below.

TABLE 6.3.2.1.2-5
Mapping order of CSI fields of one CSI report, CSI part 2 subband

| | |
|---|---|
| CSI report #n | Subband differential CQI for the second TB of all even subbands with increasing |
| Part 2 | order of subband number, as in Tables 6.3.1.1.2-3/4/5, if cqi- |
| subband | FormatIndicator = subbandCQI and if reported |
| | PMI subband information fields X₂ of all even subbands with increasing order of |
| | subband number, from left to right as in Tables 6.3.1.1.2-1/2 or 6.3.2.1.2-1/2, or |
| | codebook index for 2 antenna ports according to TS38.214 of all even subbands with |
| | increasing order of subband number, if pmi-FormatIndicator = subbandPMI and if |
| | reported |
| | Subband differential CQI for the second TB for SECOND CRI of all even subbands |
| | with increasing order of subband number, as in Tables 6.3.1.1.2-3/4/5, if cqi- |
| | FormatIndicator = subbandCQI and if reported |
| | SECOND CRI PMI subband information fields X₂ of all even subbands with |
| | increasing order of subband number, from left to right as in Tables 6.3.1.1.2-1/2 or |
| | 6.3.2.1.2-1/2, or codebook index for 2 antenna ports according to TS38.214 of all |
| | even subbands with increasing order of subband number, if pmi-FormatIndicator = |
| | subbandPMI and if reported |
| | Subband differential CQI for the second TB for Third CRI of all even subbands with |
| | increasing order of subband number, as in Tables 6.3.1.1.2-3/4/5, if cqi- |
| | FormatIndicator = subbandCQI and if reported |
| | Third CRI PMI subband information fields X₂ of all even subbands with increasing |
| | order of subband number, from left to right as in Tables 6.3.1.1.2-1/2 or 6.3.2.1.2- |
| | 1/2, or codebook index for 2 antenna ports according to TS38.214 of all even |
| | subbands with increasing order of subband number, if pmi-FormatIndicator = |
| | subbandPMI and if reported |
| | Subband differential CQI for the second TB for Fourth CRI of all even subbands |
| | with increasing order of subband number, as in Tables 6.3.1.1.2-3/4/5, if cqi- |
| | FormatIndicator = subbandCQI and if reported |
| | Fourth CRI PMI subband information fields X₂ of all even subbands with increasing |
| | order of subband number, from left to right as in Tables 6.3.1.1.2-1/2 or 6.3.2.1.2- |
| | 1/2, or codebook index for 2 antenna ports according to TS38.214 of all even |
| | subbands with increasing order of subband number, if pmi-FormatIndicator = |
| | subbandPMI and if reported |
| | Subband differential CQI for the second TB of all odd subbands with increasing order |
| | of subband number, as in Tables 6.3.1.1.2-3/4/5, if cqi- |
| | FormatIndicator = subbandCQI and if reported |
| | PMI subband information fields X₂ of all odd subbands with increasing order of |
| | subband number, from left to right as in Tables 6.3.1.1.2-1/2 or 6.3.2.1.2-1/2, or |
| | codebook index for 2 antenna ports according to TS38.214 of all odd subbands with |
| | increasing order of subband number, if pmi-FormatIndicator = subbandPMI and if |
| | reported |
| | Second CRI Subband differential CQI for the second TB SECOND CRI of all odd |
| | subbands with increasing order of subband number, as in Tables 6.3.1.1.2-3/4/5, if |
| | cqi-FormatIndicator = subbandCQI and if reported |
| | SECOND CRI PMI subband information fields X₂ of all odd subbands with |
| | increasing order of subband number, from left to right as in Tables 6.3.1.1.2-1/2 or |
| | 6.3.2.1.2-1/2, or codebook index for 2 antenna ports according to TS38.214 of all |
| | odd subbands with increasing order of subband number, if pmi-FormatIndicator = |
| | subbandPMI and if reported |
| | Second CRI Subband differential CQI for the second TB Third CRI of all odd |
| | subbands with increasing order of subband number, as in Tables 6.3.1.1.2-3/4/5, if |
| | cqi-FormatIndicator = subbandCQI and if reported |
| | Third CRI PMI subband information fields X₂ of all odd subbands with increasing |
| | order of subband number, from left to right as in Tables 6.3.1.1.2-1/2 or 6.3.2.1.2- |
| | 1/2, or codebook index for 2 antenna ports according to TS38.214 of all odd subbands |
| | with increasing order of subband number, if pmi-FormatIndicator = subbandPMI and |
| | if reported |
| | Second CRI Subband differential CQI for the second TB Fourth CRI of all odd |
| | subbands with increasing order of subband number, as in Tables 6.3.1.1.2-3/4/5, if |
| | cqi-FormatIndicator = subbandCQI and if reported |
| | Fourth CRI PMI subband information fields X₂ of all odd subbands with increasing |
| | order of subband number, from left to right as in Tables 6.3.1.1.2-1/2 or 6.3.2.1.2- |
| | 1/2, or codebook index for 2 antenna ports according to TS38.214 of all odd subbands |
| | with increasing order of subband number, if pmi-FormatIndicator = subbandPMI and |
| | if reported |

NOTE:
Subbands for given CSI report n indicated by the higher layer parameter csi-ReportingBand are numbered continuously in the increasing order with the lowest subband of csi-ReportingBand as subband 0.

In an embodiment, for SB reporting for CSI part 2 SB, is shown in table below, where within each report i.e., CSI report #n, new sub partition is added CSI report #n, Lth CRI. WhereL ∈{0,1, . . . . M−1}.

TABLE 6.3.2.1.2-5
Mapping order of CSI fields of one CSI report, CSI part 2 sub band

| | |
|---|---|
| CSI report #n | Subband differential CQI for the second TB of all even subbands with increasing |
| Part 2 subband, | order of subband number, as in Tables 6.3.1.1.2-3/4/5, if cqi- |
| Lth CRI | FormatIndicator = subbandCQI and if reported |
| | PMI subband information fields X₂ of all even subbands with increasing order of |
| | subband number, from left to right as in Tables 6.3.1.1.2-1/2 or 6.3.2.1.2-1/2, or |
| | codebook index for 2 antenna ports according to TS38.214 of all even subbands |
| | with increasing order of subband number, if pmi-FormatIndicator = subbandPMI |
| | and if reported |
| | Subband differential CQI for the second TB of all odd subbands with increasing |
| | order of subband number, as in Tables 6.3.1.1.2-3/4/5, if cqi- |
| | FormatIndicator = subbandCQI and if reported |
| | PMI subband information fields X₂ of all odd subbands with increasing order of |
| | subband number, from left to right as in Tables 6.3.1.1.2-1/2 or 6.3.2.1.2-1/2, or |
| | codebook index for 2 antenna ports according to TS38.214 of all odd subbands |
| | with increasing order of subband number, if pmi-FormatIndicator = subbandPMI |
| | and if reported |

NOTE:
Subbands for given CSI report n indicated by the higher layer parameter csi-ReportingBand are numbered continuously in the increasing order with the lowest subband of csi-ReportingBand as subband 0.

For mapping CSI reports to UCI bit sequence the following improvements to tables has been provided for multiple CRI based reporting.

TABLE 6.3.2.1.2-6
$Mapping order of CSI reports to UCI bit {sequencea}_{0}^{( 1 )} , {a}_{1}^{( 1 )} , {a}_{2}^{( 1 )} , {a}_{3}^{( 1 )} , … , {a}_{{A}^{( 1 )} - 1}^{( 1 )} ,$
with two-part CSI report(s)

| UCI bit | |
|---|---|
| sequence | CSI report number |
| $\text{} \begin{matrix}{a}_{0}^{( 1 )} \\ {a}_{1}^{( 1 )} \\ {a}_{2}^{( 1 )} \\ {a}_{3}^{( 1 )} \\ ⋮ \\ {a}_{{A}^{( 1 )} - 1}^{( 1 )}\end{matrix}$ | CSI part 1 of CSI report #1 as in Table 6.3.2.1.2-3/3A/3B or Table 6.3.1.1.2-8/8A/8B/8C or Table 6.3.2.1.2-3C Or CSI part 1 of CSI report #1 for 1^{st} CRI as in Table 6.3.2.1.2-3 or Table 6.3.1.1.2-8 CSI part 1 of CSI report #1 for 2^{nd} CRI as in Table 6.3.2.1.2-3 or Table 6.3.1.1.2-8 . . . CSI part 1 of CSI report #1 for Mth CRI as in Table 6.3.2.1.2-3 or Table 6.3.1.1.2-8 CSI part 1 of CSI report #2 as in Table 6.3.2.1.2-3/3A/3B or Table 6.3.1.1.2- 8/8A/8B/8C or Table 6.3.2.1.2-3C |
| | Or |
| | CSI part 2 of CSI report #1 for 1^{st} CRI as in Table 6.3.2.1.2-3 or Table 6.3.1.1.2-8 |
| | CSI part 2 of CSI report #1 for 2^{nd} CRI as in Table 6.3.2.1.2-3 or Table 6.3.1.1.2-8 |
| | CSI part 2 of CSI report #1 for Mth CRI as in Table 6.3.2.1.2-3 or Table 6.3.1.1.2-8 |
| | . . . |
| | CSI part 1 of CSI report #n as in Table 6.3.2.1.2-3/3A/3B or Table 6.3.1.1.2-8/8A/8B/8C or |
| | Table 6.3.2.1.2-3C |
| | Or |
| | CSI part #n of CSI report #1 for 1^{st} CRI as in Table 6.3.2.1.2-3 or Table 6.3.1.1.2-8 |
| | CSI part #n of CSI report #1 for 2^{nd} CRI as in Table 6.3.2.1.2-3 or Table 6.3.1.1.2-8 |

$\begin{matrix}NOTE : \\ For a CSI report \# i containing {N}_{i}^{sub} CSI sub - reports , where i ∈ \{ 1 , 2 , … , n \} , CSI part 1 of all CSI sub - reports are \\ mapped to the corresponding segment of the UCI bit sequence of CSI report \# i from upper part to lower part of the \\ segment , in increasing order of CSI sub - report number . CSI sub - report \#1 , CSI sub - report \#2 , CSI sub - report \\ {\# N}_{i}^{sub} correspond to the CSI sub - reports in increasing order of CSI - ReportSubConfigID . \\ For a CSI report \# i containing Kth CRI reports where M ∈ \{ 1 , 2 , … M \} , CSI part 1 of all CSI of \\ all CRIs are mapped to the corresponding segment of the UCI bit sequence of CSI report \# i , \\ from upper part to lower part of the segment , in the order of CSI resources configured within resource set . Or increasing order CSI resources number in resource set\end{matrix}$

For CSI report containing 2 part UCI, the following table is used.

TABLE 6.3.2.1.2-7
$Mapping order of CSI reports to UCI bit {sequencea}_{0}^{( 1 )} , {a}_{1}^{( 1 )} , {a}_{2}^{( 1 )} , {a}_{3}^{( 1 )} , … , {a}_{{A}^{( 1 )} - 1}^{( 1 )} ,$
with two-part CSI report(s)

| UCI bit | |
|---|---|
| sequence | CSI report number |
| $\text{} \begin{matrix}{a}_{0}^{( 2 )} \\ {a}_{1}^{( 2 )} \\ {a}_{2}^{( 2 )} \\ {a}_{3}^{( 2 )} \\ ⋮ \\ {a}_{{A}^{( 2 )} - 1}^{( 2 )}\end{matrix}$ | CSI report #1, CSI part 2 wideband, as in Table 6.3.2.1.2-4/4A/4B, or CSI part 2 with group 0, as in Table 6.3.2.1.2-5A/5B/5E/5F/5G, if CSI part 2 exists for CSI report #1 or CSI part 2, 2^{nd} CRI with group 0, as in Table 6.3.2.1.2-5A, / CSI part 2 wideband, as in Table 6.3.2.1.2-4, if reported CSI part 2, 3^{rd} CRI with group 0, as in Table 6.3.2.1.2-5A, / CSI part 2 wideband, as in Table 6.3.2.1.2-4, if reported CSI part 2, 4^{th} CRI with group 0, as in Table 6.3.2.1.2-5A, / CSI part 2 wideband, as |
| | in Table 6.3.2.1.2-4, if reported |
| | CSI report #2, CSI part 2 wideband, as in Table 6.3.2.1.2-4/4A/4B, |
| | or CSI part 2 with group 0, as in Table 6.3.2.1.2-5A/5B/5E/5F/5G, |
| | if CSI part 2 exists for CSI report #2 |
| | or |
| | CSI part 2, 2^{nd} CRI with group 0, as in Table 6.3.2.1.2-5A, / CSI part 2 wideband, as |
| | in Table 6.3.2.1.2-4, if reported |
| | CSI part 2, 3^{rd} CRI with group 0, as in Table 6.3.2.1.2-5A, / CSI part 2 wideband, as |
| | in Table 6.3.2.1.2-4, if reported |
| | CSI part 2, 4^{th} CRI with group 0, as in Table 6.3.2.1.2-5A, / CSI part 2 wideband, as |
| | in Table 6.3.2.1.2-4, if reported |
| | CSI report #n, CSI part 2 wideband, as in Table 6.3.2.1.2-4/4A/4B, |
| | or CSI part 2 with group 0, as in Table 6.3.2.1.2-5A/5B/5E/5F/5G, |
| | if CSI part 2 exists for CSI report #n |
| | or |
| | CSI part 2, 2^{nd} CRI with group 0, as in Table 6.3.2.1.2-5A, / CSI part 2 wideband, as |
| | in Table 6.3.2.1.2-4, if reported |
| | CSI part 2, 3^{rd} CRI with group 0, as in Table 6.3.2.1.2-5A, / CSI part 2 wideband, as |
| | in Table 6.3.2.1.2-4, if reported |
| | CSI part 2, 4^{th} CRI with group 0, as in Table 6.3.2.1.2-5A, / CSI part 2 wideband, as |
| | in Table 6.3.2.1.2-4, if reported |
| | CSI report #1, CSI part 2 subband, as in Table 6.3.2.1.2-5/5C/5D/5H, |
| | or CSI part 2 with group 1 and 2, as in Table 6.3.2.1.2-5A/5B/5E/5F/5G, |
| | if CSI part 2 exists for CSI report #1 |
| | or |
| | 2^{nd} CRI with group 1 and 2, as in Table 6.3.2.1.2-5A / CSI part 2 subband, as in Table |
| | 6.3.2.1.2-5, if reported |
| | and 3^{rd} CRI with group 1 and 2, as in Table 6.3.2.1.2-5A 5A / CSI part 2 subband, as |
| | in Table 6.3.2.1.2-5, if reported |
| | and 4^{th} CRI with group 1 and 2, as in Table 6.3.2.1.2-5A 5A / CSI part 2 subband, as |
| | in Table 6.3.2.1.2-5, if reported |
| | CSI report #2, CSI part 2 subband, as in Table 6.3.2.1.2-5/5C/5D/5H, |
| | or CSI part 2 with group 1 and 2, as in Table 6.3.2.1.2-5A/5B/5E/5F/5G, |
| | if CSI part 2 exists for CSI report #2 |
| | or |
| | 2^{nd} CRI with group 1 and 2, as in Table 6.3.2.1.2-5A / CSI part 2 subband, as in Table |
| | 6.3.2.1.2-5, if reported |
| | and 3^{rd} CRI with group 1 and 2, as in Table 6.3.2.1.2-5A 5A / CSI part 2 subband, as |
| | in Table 6.3.2.1.2-5, if reported |
| | and 4^{th} CRI with group 1 and 2, as in Table 6.3.2.1.2-5A 5A / CSI part 2 subband, as |
| | in Table 6.3.2.1.2-5, if reported |
| | CSI report #n, CSI part 2 subband, as in Table 6.3.2.1.2-5/5C/5D/5H, |
| | or CSI part 2 with group 1 and 2, as in Table 6.3.2.1.2-5A/5B/5E/5F/5G, |
| | if CSI part 2 exists for CSI report #n |
| | or |
| | 2^{nd} CRI with group 1 and 2, as in Table 6.3.2.1.2-5A / CSI part 2 subband, as in Table |
| | 6.3.2.1.2-5, if reported |
| | and 3^{rd} CRI with group 1 and 2, as in Table 6.3.2.1.2-5A 5A / CSI part 2 subband, as |
| | in Table 6.3.2.1.2-5, if reported |
| | and 4^{th} CRI with group 1 and 2, as in Table 6.3.2.1.2-5A 5A / CSI part 2 subband, as |
| | in Table 6.3.2.1.2-5, if reported |

In an embodiment, the table below shows a mapping order of CSI reports to UCI bit sequence.

TABLE 6.3.2.1.2-7
$Mapping order of CSI reports to UCI bit {sequencea}_{0}^{( 1 )} , {a}_{1}^{( 1 )} , {a}_{2}^{( 1 )} , {a}_{3}^{( 1 )} , … , {a}_{{A}^{( 1 )} - 1}^{( 1 )} ,$
with two-part CSI report(s)

| UCI bit | |
|---|---|
| sequence | CSI report number |
| $\text{} \begin{matrix}{a}_{0}^{( 2 )} \\ {a}_{1}^{( 2 )} \\ {a}_{2}^{( 2 )} \\ {a}_{3}^{( 2 )} \\ ⋮ \\ {a}_{{A}^{( 2 )} - 1}^{( 2 )}\end{matrix}$ | CSI report #1, 1^{st} CRI, CSI part 2 wideband, as in Table 6.3.2.1.2-4/4A/4B, or CSI part 2 with group 0, as in Table 6.3.2.1.2-5A/5B/5E/5F/5G, if CSI part 2 exists for CSI report #1 CSI report #1, 2^{nd} CRI, CSI part 2 wideband, as in Table 6.3.2.1.2-4/4A/4B, or CSI part 2 with group 0, as in Table 6.3.2.1.2-5A/5B/5E/5F/5G, if CSI part 2 exists for CSI report #1 CSI report #1, Mth CRI, CSI part 2 wideband, as in Table 6.3.2.1.2-4/4A/4B, or CSI part 2 with group 0, as in Table 6.3.2.1.2-5A/5B/5E/5F/5G, if CSI part 2 exists for CSI report #1 |
| | CSI report #2, 1^{st} CRI, CSI part 2 wideband, as in Table 6.3.2.1.2-4/4A/4B, |
| | or CSI part 2 with group 0, as in Table 6.3.2.1.2-5A/5B/5E/5F/5G, |
| | if CSI part 2 exists for CSI report #2 |
| | CSI report #2, Mth CRI, CSI part 2 wideband, as in Table 6.3.2.1.2-4/4A/4B, |
| | or CSI part 2 with group 0, as in Table 6.3.2.1.2-5A/5B/5E/5F/5G, |
| | if CSI part 2 exists for CSI report #2 |
| | CSI report #n, 1^{st} CRI, CSI part 2 wideband, as in Table 6.3.2.1.2-4/4A/4B, |
| | or CSI part 2 with group 0, as in Table 6.3.2.1.2-5A/5B/5E/5F/5G, |
| | if CSI part 2 exists for CSI report #n |
| | . . . |
| | CSI report #n, Mth CRI, CSI part 2 wideband, as in Table 6.3.2.1.2-4/4A/4B, |
| | or CSI part 2 with group 0, as in Table 6.3.2.1.2-5A/5B/5E/5F/5G, |
| | if CSI part 2 exists for CSI report #n |
| | CSI report #1,1^{st} CRI, CSI part 2 subband, as in Table 6.3.2.1.2-5/5C/5D/5H, |
| | or CSI part 2 with group 1 and 2, as in Table 6.3.2.1.2-5A/5B/5E/5F/5G, |
| | if CSI part 2 exists for CSI report #1 |
| | . . . |
| | CSI report #1, Mth CRI, CSI part 2 subband, as in Table 6.3.2.1.2-5/5C/5D/5H, |
| | or CSI part 2 with group 1 and 2, as in Table 6.3.2.1.2-5A/5B/5E/5F/5G, |
| | if CSI part 2 exists for CSI report #1 |
| | CSI report #2, 1^{st} CRI, CSI part 2 subband, as in Table 6.3.2.1.2-5/5C/5D/5H, |
| | or CSI part 2 with group 1 and 2, as in Table 6.3.2.1.2-5A/5B/5E/5F/5G, |
| | if CSI part 2 exists for CSI report #2 |
| | CSI report #2, Mth CRI, CSI part 2 subband, as in Table 6.3.2.1.2-5/5C/5D/5H, |
| | or CSI part 2 with group 1 and 2, as in Table 6.3.2.1.2-5A/5B/5E/5F/5G, |
| | if CSI part 2 exists for CSI report #2 |
| | CSI report #n, 1^{st} CRI, CSI part 2 subband, as in Table 6.3.2.1.2-5/5C/5D/5H, |
| | or CSI part 2 with group 1 and 2, as in Table 6.3.2.1.2-5A/5B/5E/5F/5G, |
| | if CSI part 2 exists for CSI report #n |
| | CSI report #n, Mth CRI, CSI part 2 subband, as in Table 6.3.2.1.2-5/5C/5D/5H, |
| | or CSI part 2 with group 1 and 2, as in Table 6.3.2.1.2-5A/5B/5E/5F/5G, |
| | if CSI part 2 exists for CSI report #n |

$\text{} \begin{matrix}NOTE : \\ For a CSI report \# i containing {N}_{i}^{sub} CSI sub - reports , where i ∈ \{ 1 , 2 , … , n \} , \\ - CSI part 2 wideband of all CSI sub - reports are mapped to the corresponding segment of the UCI \\ bit sequence of CSI report \# i , from upper part to lower part of the segment in increasing order of \\ in increasing order of CSI sub - report number ; \\ - CSI sub - report \#1 , CSI sub - report \#2 , CSI sub - report \# {N}_{i}^{sub} correspond to the CSI sub - reports \\ in increasing order of CSI - ReportSubConfigID .\end{matrix}$

In an embodiment, of UCI bit sequence to CSI report for CSI part 2 is given as below, Here CSI report 1 is combined, comprising CSI report part 2 WB, CSI report part 2 SB instead of combining CSI part 2 WB of all CSI reports.

TABLE 6.3.2.1.2-8
RI and CQI of codebookType = typeII-r16 or typeII-PortSelection-r16

| Field | Bitwidth |
|---|---|
| Rank indicator | min(2, ┌log₂n_{R1}┐) |
| Wide-band CQI | 4 |
| Subband differential CQI | 2 |
| Indicator of the total number of non-zero coefficients | [log₂ (K₀)] if max allowed rank is 1; |
| summed across all layers K^{NZ} | [log₂ (2K₀)] otherwise |

For reporting CSI reporting on Part 1 PUSCH, CRI, rank indicator, Wideband CQI for 1^{st} TB, Subband CQI for 1^{st} TB has been added for all the CRIs. Total number of non zero coefficients is only for CRI and 1 and CRI 2 as shown below. Max CRI for Type I is M=4 and for Type II M=2.

TABLE 6.3.2.1.2-3
Mapping order of CSI fields of one CSI report, CSI part 1

| CSI report number | CSI fields |
|---|---|
| CSI report #n | 1st CRI as in Tables 6.3.1.1.2-3/4/6, if reported |
| CSI part 1 | 2nd CRI as in Tables 6.3.1.1.2-3/4/6, if reported for M > 1 resources selected, if |
| | reported |
| | 3rd CRI as in Tables 6.3.1.1.2-3/4/6, if reported for M > 1 resources selected, if |
| | reported |
| | 4th CRI as in Tables 6.3.1.1.2-3/4/6, if reported for M > 1 resources selected, if |
| | reported |
| | 1st CRI rank indicator as in Tables 6.3.1.1.2-3/4/5 or 6.3.2.1.2-8/8A/8B/9/9A, |
| | if reported |
| | 2nd CRI rank indicator as in Tables 6.3.1.1.2-3/4/5 or 6.3.2.1.2-8/8A/8B/9/9A, |
| | if reported |
| | 3rd CRI rank indicator as in Tables 6.3.1.1.2-3/4/5 or 6.3.2.1.2-8/8A/8B/9/9A, |
| | if reported |
| | 4th CRI rank indicator as in Tables 6.3.1.1.2-3/4/5 or 6.3.2.1.2-8/8A/8B/9/9A, |
| | if reported |
| | 1st CRI Wideband CQI for the first TB as in Tables 6.3.1.1.2-3/4/5 or 6.3.2.1.2- |
| | 8/8A/8B/9/9A, if reported |
| | 2nd CRI Wideband CQI for the first TB as in Tables 6.3.1.1.2-3/4/5 or |
| | 6.3.2.1.2-8/8A/8B/9/9A, if reported |
| | 3rd CRI Wideband CQI for the first TB as in Tables 6.3.1.1.2-3/4/5 or |
| | 6.3.2.1.2-8/8A/8B/9/9A, if reported |
| | 4th CRI Wideband CQI for the first TB as in Tables 6.3.1.1.2-3/4/5 or 6.3.2.1.2- |
| | 8/8A/8B/9/9A, if reported |
| | 1st Subband differential CQI for the first TB with increasing order of subband |
| | number as in Tables 6.3.1.1.2-3/4/5 or 6.3.2.1.2-8/8A/8B/9/9A, if reported |
| | 2nd CRI Subband differential CQI for the first TB with increasing order of |
| | subband number as in Tables 6.3.1.1.2-3/4/5 or 6.3.2.1.2-8/8A/8B/9/9A, if |
| | reported |
| | 3rd CRI Subband differential CQI for the first TB with increasing order of |
| | subband number as in Tables 6.3.1.1.2-3/4/5 or 6.3.2.1.2-8/8A/8B/9/9A, if |
| | reported |
| | 4th CRI Subband differential CQI for the first TB with increasing order of |
| | subband number as in Tables 6.3.1.1.2-3/4/5 or 6.3.2.1.2-8/8A/8B/9/9A, if |
| | reported |
| | Indicator of the number of non-zero wideband amplitude coefficients Mo for |
| | layer 0 as in Table 6.3.1.1.2-5, if reported |
| | Indicator of the number of non-zero wideband amplitude coefficients M1 for |
| | layer 1 as in Table 6.3.1.1.2-5 (if the rank according to the reported RI is equal |
| | to one, this field is set to all zeros), if 2-layer PMI reporting is allowed |
| | according to the rank restriction in TS38.214 and if reported |
| | Indicator of the No selected CSI-RS resources by a bitmap with NTRP bits, this |
| | field is present only if NTRP > 1 and restrictedCMR-Selection is configured to |
| | OFF |
| | Indicator of selected Lₙ value combination or αₙ value combination with |
| | bitwidth of ┌log₂(N_{L})┐, this field is present only if N_{L} > 1 |
| | Indicator of the total number of non-zero coefficients summed across all layers |
| | K^{NZ} as in Tables 6.3.2.1.2-8/8A/8B/9/9A, if reported |
| | For 2nd CRI, the total number of non-zero coefficients summed across all |
| | layers K^{NZ} as in Tables 6.3.2.1.2-8/8A/8B/9/9A, if reported, for M > 1 and if |
| | Ks > 1 resources are configured |

NOTE:
Subbands for given CSI report n indicated by the higher layer parameter csi-ReportingBand are numbered continuously in the increasing order with the lowest subband of csi-ReportingBand as subband 0.

In an embodiment, for CSI part 1, followings are provided.

TABLE 6.3.2.1.2-3
Mapping order of CSI fields of one CSI report, CSI part 1

| CSI report number | CSI fields |
|---|---|
| CSI report #n | 1st CRI as in Tables 6.3.1.1.2-3/4/6, if reported |
| CSI part 1 | 2nd CRI as in Tables 6.3.1.1.2-3/4/6, if reported for M > 1 resources selected, if |
| | reported |
| | 3rd CRI as in Tables 6.3.1.1.2-3/4/6, if reported for M > 1 resources selected, if |
| | reported |
| | 4th CRI as in Tables 6.3.1.1.2-3/4/6, if reported for M > 1 resources selected, if |
| | reported |
| | 1st CRI rank indicator as in Tables 6.3.1.1.2-3/4/5 or 6.3.2.1.2-8/8A/8B/9/9A, |
| | if reported |
| | 2nd CRI rank indicator as in Tables 6.3.1.1.2-3/4/5 or 6.3.2.1.2-8/8A/8B/9/9A, |
| | if reported |
| | 3rd CRI rank indicator as in Tables 6.3.1.1.2-3/4/5 or 6.3.2.1.2-8/8A/8B/9/9A, |
| | if reported |
| | 4th CRI rank indicator as in Tables 6.3.1.1.2-3/4/5 or 6.3.2.1.2-8/8A/8B/9/9A, |
| | if reported |
| | 1st CRI Wideband CQI for the first TB as in Tables 6.3.1.1.2-3/4/5 or 6.3.2.1.2- |
| | 8/8A/8B/9/9A, if reported |
| | 1st Subband differential CQI for the first TB with increasing order of subband |
| | number as in Tables 6.3.1.1.2-3/4/5 or 6.3.2.1.2-8/8A/8B/9/9A, if reported |
| | 2nd CRI Wideband CQI for the first TB as in Tables 6.3.1.1.2-3/4/5 or |
| | 6.3.2.1.2-8/8A/8B/9/9A, if reported |
| | 2nd CRI Subband differential CQI for the first TB with increasing order of |
| | subband number as in Tables 6.3.1.1.2-3/4/5 or 6.3.2.1.2-8/8A/8B/9/9A, if |
| | reported |
| | 3rd CRI Wideband CQI for the first TB as in Tables 6.3.1.1.2-3/4/5 or 6.3.2.1.2- |
| | 8/8A/8B/9/9A, if reported |
| | 3rd CRI Subband differential CQI for the first TB with increasing order of |
| | subband number as in Tables 6.3.1.1.2-3/4/5 or 6.3.2.1.2-8/8A/8B/9/9A, if |
| | reported |
| | 4th CRI Wideband CQI for the first TB as in Tables 6.3.1.1.2-3/4/5 or 6.3.2.1.2- |
| | 8/8A/8B/9/9A, if reported |
| | 4th CRI Subband differential CQI for the first TB with increasing order of |
| | subband number as in Tables 6.3.1.1.2-3/4/5 or 6.3.2.1.2-8/8A/8B/9/9A, if |
| | reported |
| | Indicator of the number of non-zero wideband amplitude coefficients M₀ for |
| | layer 0 as in Table 6.3.1.1.2-5, if reported |
| | Indicator of the number of non-zero wideband amplitude coefficients M₁ for |
| | layer 1 as in Table 6.3.1.1.2-5 (if the rank according to the reported RI is equal |
| | to one, this field is set to all zeros), if 2-layer PMI reporting is allowed |
| | according to the rank restriction in TS38.214 and if reported |
| | Indicator of the N₀ selected CSI-RS resources by a bitmap with N_{TRP} bits, this |
| | field is present only if N_{TRP} > 1 and restrictedCMR-Selection is configured to |
| | OFF |
| | Indicator of selected Lₙ value combination or αₙ value combination with |
| | bitwidth of ┌log₂(N_{L})┐, this field is present only if N_{L} > 1 |
| | Indicator of the total number of non-zero coefficients summed across all layers |
| | K^{NZ} as in Tables 6.3.2.1.2-8/8A/8B/9/9A, if reported |
| | For 2nd CRI, the total number of non-zero coefficients summed across all layers |
| | K^{NZ} as in Tables 6.3.2.1.2-8/8A/8B/9/9A, if reported, for M > 1 and if Ks > 1 |
| | resources are configured |

NOTE:
Subbands for given CSI report n indicated by the higher layer parameter csi-ReportingBand are numbered continuously in the increasing order with the lowest subband of csi-ReportingBand as subband 0.

In an embodiment, for CSI part 1, followings are provided.

TABLE 6.3.2.1.2-3
Mapping order of CSI fields of one CSI report, CSI part 1

| CSI report number | CSI fields |
|---|---|
| CSI report #n | 1st CRI as in Tables 6.3.1.1.2-3/4/6, if reported |
| CSI part 1 | 2nd CRI as in Tables 6.3.1.1.2-3/4/6, if reported for M > 1 resources selected, |
| | if reported |
| | 3rd CRI as in Tables 6.3.1.1.2-3/4/6, if reported for M > 1 resources selected, |
| | if reported |
| | 4th CRI as in Tables 6.3.1.1.2-3/4/6, if reported for M > 1 resources selected, |
| | if reported |
| | 1st CRI rank indicator as in Tables 6.3.1.1.2-3/4/5 or 6.3.2.1.2- |
| | 8/8A/8B/9/9A, if reported |
| | 2nd CRI rank indicator as in Tables 6.3.1.1.2-3/4/5 or 6.3.2.1.2- |
| | 8/8A/8B/9/9A, if reported |
| | 3rd CRI rank indicator as in Tables 6.3.1.1.2-3/4/5 or 6.3.2.1.2- |
| | 8/8A/8B/9/9A, if reported |
| | 4th CRI rank indicator as in Tables 6.3.1.1.2-3/4/5 or 6.3.2.1.2- |
| | 8/8A/8B/9/9A, if reported |
| | 1st Wideband CQI for the first TB as in Tables 6.3.1.1.2-3/4/5 or 6.3.2.1.2- |
| | 8/8A/8B/9/9A, if reported |
| | 1st Subband differential CQI for the first TB with increasing order of |
| | subband number as in Tables 6.3.1.1.2-3/4/5 or 6.3.2.1.2-8/8A/8B/9/9A, if |
| | reported |
| | Indicator of the number of non-zero wideband amplitude coefficients M₀ for |
| | layer 0 as in Table 6.3.1.1.2-5, if reported |
| | Indicator of the number of non-zero wideband amplitude coefficients M₁ for |
| | layer 1 as in Table 6.3.1.1.2-5 (if the rank according to the reported RI is |
| | equal to one, this field is set to all zeros), if 2-layer PMI reporting is allowed |
| | according to the rank restriction in TS38.214 and if reported |
| | Indicator of the N₀ selected CSI-RS resources by a bitmap with N_{TRP} bits, |
| | this field is present only if N_{TRP} > 1 and restrictedCMR-Selection is |
| | configured to OFF |
| | Indicator of selected Lₙ value combination or αₙ value combination with |
| | bitwidth of ┌log₂(N_{L})┐, this field is present only if N_{L} > 1 |
| | For 1st CRI, the total number of non-zero coefficients summed across all |
| | layers K^{NZ} as in Tables 6.3.2.1.2-8/8A/8B/9/9A, if reported |
| | For 2nd CRI, the total number of non-zero coefficients summed across all |
| | layers K^{NZ} as in Tables 6.3.2.1.2-8/8A/8B/9/9A, if reported |

NOTE:
Subbands for given CSI report n indicated by the higher layer parameter csi-ReportingBand are numbered continuously in the increasing order with the lowest subband of csi-ReportingBand as subband 0.

In an embodiment, the tables below shows a mapping order of CSI fields of one CSI report, CSI part 1.

TABLE 6.3.2.1.2-3
Mapping order of CSI fields of one CSI report, CSI part 1

| CSI report number | CSI fields |
|---|---|
| CSI report #n | 1st CRI as in Tables 6.3.1.1.2-3/4/6, if reported |
| CSI part 1 | 2nd CRI as in Tables 6.3.1.1.2-3/4/6, if reported for M > 1 resources selected, if |
| | reported |
| | 3rd CRI as in Tables 6.3.1.1.2-3/4/6, if reported for M > 1 resources selected, if |
| | reported |
| | 4th CRI as in Tables 6.3.1.1.2-3/4/6, if reported for M > 1 resources selected, if |
| | reported |
| | 1st CRI rank indicator as in Tables 6.3.1.1.2-3/4/5 or 6.3.2.1.2-8/8A/8B/9/9A, |
| | if reported |
| | 2nd CRI rank indicator as in Tables 6.3.1.1.2-3/4/5 or 6.3.2.1.2-8/8A/8B/9/9A, |
| | if reported |
| | 3rd CRI rank indicator as in Tables 6.3.1.1.2-3/4/5 or 6.3.2.1.2-8/8A/8B/9/9A, |
| | if reported |
| | 4th CRI rank indicator as in Tables 6.3.1.1.2-3/4/5 or 6.3.2.1.2-8/8A/8B/9/9A, |
| | if reported |
| | 1st Wideband CQI for the first TB as in Tables 6.3.1.1.2-3/4/5 or 6.3.2.1.2- |
| | 8/8A/8B/9/9A, if reported |
| | 1st Subband differential CQI for the first TB with increasing order of subband |
| | number as in Tables 6.3.1.1.2-3/4/5 or 6.3.2.1.2-8/8A/8B/9/9A, if reported |
| | ${M}_{R}^{th} Wideband CQI for the first TB as in Tables 6.3 \text{.1} \text{.1} \text{.2} - 3 \text{/4/} 5 or 6.3 \text{.2} \text{.1} \text{.2} -$ |
| | 8/8A/8B/9/9A, if reported |
| | ${M}_{R}^{th} Subband CQI for the first TB as in Tables 6.3 \text{.1} \text{.1} \text{.2} - 3 \text{/4/} 5 or 6.3 \text{.2} \text{.1} \text{.2} -$ |
| | number as in Tables 6.3.1.1.2-3/4/5 or 6.3.2.1.2-8/8A/8B/9/9A, if reported |
| | Indicator of the number of non-zero wideband amplitude coefficients M₀ for |
| | layer 0 as in Table 6.3.1.1.2-5, if reported |
| | Indicator of the number of non-zero wideband amplitude coefficients M₁ for |
| | layer 1 as in Table 6.3.1.1.2-5 (if the rank according to the reported RI is equal |
| | to one, this field is set to all zeros), if 2-layer PMI reporting is allowed according |
| | to the rank restriction in TS38.214 and if reported |
| | Indicator of the No selected CSI-RS resources by a bitmap with N_{TRP} bits, this |
| | field is present only if N_{TRP} > 1 and restrictedCMR-Selection is configured to |
| | OFF |
| | Indicator of selected Lₙ value combination or an value combination with |
| | bitwidth of ┌log₂(N_{L})┐, this field is present only if N_{L} > 1 |
| | 1^{st} CRI, Indicator of the total number of non-zero coefficients summed across |
| | all layers K^{NZ} as in Tables 6.3.2.1.2-8/8A/8B/9/9A, if reported |
| | 2^{nd} t CRI, Indicator of the total number of non-zero coefficients summed across |
| | all layers K^{NZ} as in Tables 6.3.2.1.2-8/8A/8B/9/9A, if reported |

NOTE:
Subbands for given CSI report n indicated by the higher layer parameter csi-ReportingBand are numbered continuously in the increasing order with the lowest subband of csi-ReportingBand as subband 0.

In an embodiment, of CSI part 1 reporting on PUSCH, CSI part is extended adding M CRIs, M RIs, Mᵣ WB CQI associated with the Mᵣ of the 1^{st} TB, Mᵣ set of SB CQIs associated with the Mᵣ CRI of the 1^{st} TB and 1 K^{NZ} (M=2, type2-r16) after fields and in the same order where Mᵣ is higher priority resources as shown in table below.

In such cases, in one embodiment, the UE (102) does not report higher priority resource CRIs (M_{R}) and in an embodiment, irrespective of configuration of M_{R} resources UE always report with same UCI payload. This helps in a unified design. Those M_{R} resources can be sent configured to be periodic, semi-persistent, or aperiodic with CSI-Aperiodictriggerlist. Also, a report can be configured to periodic, semi-persistent, or aperiodic depending on type CSI configured. For example, for aperiodic CSI, only aperiodic reporting can be configured.

M_{R} resources can be indicated by gNB to the UE (102) by RRC layer signalling with Bitmap of Size K_{S} or with Combinatorial coding can be used with Log2 (M_{R}!) bits to configure the order or within the M_{R} the priority is by CSI resource number index. The order of priority can be lowest to highest of resource number. That is the lowest CSI resource number that has a higher priority or from high to low of resource index number that is the highest CSI resource index number that has the highest priority among M_{R} resources.

The reporting of CRIs can be in with [log₂(K_{S}−M_{R})] bits when M_{R} resources are configured or Just [log₂K_{S}] bits irrespective of M_{R} resources are configured or not.

If M_{R} resources are configured, only M-M_{R} CRIs may be reported with [log₂(K_{S}-M_{R})] or [log₂K_{S}] bits. The mapping of M_{R} (RI, PMI, and CQI) is important for decoding since CRI is absent for M_{R} resources.

TABLE 6.3.2.1.2-3
Mapping order of CSI fields of one CSI report, CSI part 1

| | CSI fields |
|---|---|
| CSI report #n | 1st CRI as in Tables 6.3.1.1.2-3/4/6, if reported |
| CSI part 1 | 2nd CRI as in Tables 6.3.1.1.2-3/4/6, if reported for M > 1 resources selected, |
| | if reported |
| | . . . |
| | (M − Mr) CRI as in Tables 6.3.1.1.2-3/4/6, if reported for M > 1 resources |
| | selected, if reported |
| | 1st rank indicator as in Tables 6.3.1.1.2-3/4/5 or 6.3.2.1.2-8/8A/8B/9/9A, if |
| | reported |
| | 2nd CRI rank indicator as in Tables 6.3.1.1.2-3/4/5 or 6.3.2.1.2- |
| | 8/8A/8B/9/9A, if reported |
| | M^{th} CRI rank indicator as in Tables 6.3.1.1.2-3/4/5 or 6.3.2.1.2- |
| | 8/8A/8B/9/9A, if reported |
| | 1st Wideband CQI for the first TB as in Tables 6.3.1.1.2-3/4/5 or 6.3.2.1.2- |
| | 8/8A/8B/9/9A, if reported |
| | 2nd Wideband CQI for the first TB as in Tables 6.3.1.1.2-3/4/5 or 6.3.2.1.2- |
| | 8/8A/8B/9/9A, if reported |
| | . . . |
| | ${M}_{r}^{th} Wideband CQI for the first TB as in Tables 6.3 \text{.1} \text{.1} \text{.2} - 3/4/5 or 6.3 \text{.2} \text{.1} \text{.2} -$ |
| | 8/8A/8B/9/9A, if reported |
| | 1st Subband differential CQI for the first TB with increasing order of subband |
| | number as in Tables 6.3.1.1.2-3/4/5 or 6.3.2.1.2-8/8A/8B/9/9A, if reported |
| | 2nd Subband differential CQI for the first TB with increasing order of |
| | subband number as in Tables 6.3.1.1.2-3/4/5 or 6.3.2.1.2-8/8A/8B/9/9A, if |
| | reported |
| | . . . |
| | ${M}_{r}^{th} Subband differential CQI for the first TB with increasing order of$ |
| | subband number as in Tables 6.3.1.1.2-3/4/5 or 6.3.2.1.2-8/8A/8B/9/9A, if |
| | reported |
| | Indicator of the number of non-zero wideband amplitude coefficients M₀ for |
| | layer 0 as in Table 6.3.1.1.2-5, if reported |
| | Indicator of the number of non-zero wideband amplitude coefficients M₁ for |
| | layer 1 as in Table 6.3.1.1.2-5 (if the rank according to the reported RI is |
| | equal to one, this field is set to all zeros), if 2-layer PMI reporting is allowed |
| | according to the rank restriction in TS38.214 and if reported |
| | Indicator of the N₀ selected CSI-RS resources by a bitmap with N_{TRP} bits, |
| | this field is present only if N_{TRP} > 1 and restrictedCMR-Selection is |
| | configured to OFF |
| | Indicator of selected Lₙ value combination or an value combination with |
| | bitwidth of ┌log₂(N_{L})┐, this field is present only if N_{L} > 1 |
| | Indicator of the total number of non-zero coefficients summed across all |
| | layers K^{NZ} as in Tables 6.3.2.1.2-8/8A/8B/9/9A, if reported |
| | 2nd CRI Indicator of the total number of non-zero coefficients summed |
| | across all layers K^{NZ} as in Tables 6.3.2.1.2-8/8A/8B/9/9A, if reported, for |
| | M > 1 and if Ks > 1 resources are configured |

NOTE:
Subbands for given CSI report n indicated by the higher layer parameter csi-ReportingBand are numbered continuously in the increasing order with the lowest subband of csi-ReportingBand as subband 0.

In an embodiment, the table below shows WB reporting.

| | CSI fields |
|---|---|
| CSI report #n | 1st CRI as in Tables 6.3.1.1.2-3/4/6, if reported |
| CSI part 1 | 2nd CRI as in Tables 6.3.1.1.2-3/4/6, if reported for M > 1 resources selected, if |
| | reported |
| | . . . |
| | M^{th} CRI as in Tables 6.3.1.1.2-3/4/6, if reported for M > 1 resources selected, if |
| | reported |
| | 1st rank indicator as in Tables 6.3.1.1.2-3/4/5 or 6.3.2.1.2-8/8A/8B/9/9A, if |
| | reported |
| | 2nd CRI rank indicator as in Tables 6.3.1.1.2-3/4/5 or 6.3.2.1.2-8/8A/8B/9/9A, |
| | . . . |
| | if reported |
| | M^{th} CRI rank indicator as in Tables 6.3.1.1.2-3/4/5 or 6.3.2.1.2-8/8A/8B/9/9A, |
| | if reported |
| | 1st Wideband CQI for the first TB as in Tables 6.3.1.1.2-3/4/5 or 6.3.2.1.2- |
| | 8/8A/8B/9/9A, if reported |
| | 1st Subband differential CQI for the first TB with increasing order of subband |
| | number as in Tables 6.3.1.1.2-3/4/5 or 6.3.2.1.2-8/8A/8B/9/9A, if reported |
| | 2nd Wideband CQI for the first TB as in Tables 6.3.1.1.2-3/4/5 or 6.3.2.1.2- |
| | 8/8A/8B/9/9A, if reported |
| | 2nd Subband differential CQI for the first TB with increasing order of subband |
| | number as in Tables 6.3.1.1.2-3/4/5 or 6.3.2.1.2-8/8A/8B/9/9A, if reported |
| | . . . |
| | $Wideband CQI for the first TB as in Tables 6.3 \text{.1} \text{.1} \text{.2} - 3/4/5 or 6.3 \text{.2} \text{.1} \text{.2} -$ |
| | 8/8A/8B/9/9A, if reported |
| | ${M}_{r}^{th} Subband differential CQI for the first TB with increasing order of$ |
| | number as in Tables 6.3.1.1.2-3/4/5 or 6.3.2.1.2-8/8A/8B/9/9A, if reported |
| | Indicator of the number of non-zero wideband amplitude coefficients M₀ for |
| | layer 0 as in Table 6.3.1.1.2-5, if reported |
| | Indicator of the number of non-zero wideband amplitude coefficients M₁ for |
| | layer 1 as in Table 6.3.1.1.2-5 (if the rank according to the reported RI is equal |
| | to one, this field is set to all zeros), if 2-layer PMI reporting is allowed according |
| | to the rank restriction in TS38.214 and if reported |
| | Indicator of the N₀ selected CSI-RS resources by a bitmap with N_{TRP} bits, this |
| | field is present only if N_{TRP} > 1 and restrictedCMR-Selection is configured to |
| | OFF |
| | Indicator of selected Lₙ value combination or αₙ value combination with |
| | bitwidth of ┌log₂(N_{L})┐, this field is present only if N_{L} > 1 |
| | Indicator of the total number of non-zero coefficients summed across all layers |
| | K^{NZ} as in Tables 6.3.2.1.2-8/8A/8B/9/9A, if reported |
| | 2nd CRI Indicator of the total number of non-zero coefficients summed across |
| | all layers K^{NZ} as in Tables 6.3.2.1.2-8/8A/8B/9/9A, if reported, for M > 1 and if |
| | Ks > 1 resources are configured |

NOTE:
Subbands for given CSI report n indicated by the higher layer parameter csi-ReportingBandare numbered continuously in the increasing order with the lowest subband of csi-ReportingBandas subband 0.

1ST M_{R} CRIs are not reported if M_{R} is configured by gNB to the UE (102), otherwise all CRIs are reported, hence 1ST CRI is above table corresponds to 1st

$${M}_{R}^{th}$$

CRI and is not reported but RI, CQI, LI and PMI are reported.

M−M_{R} CRIs are always reported with [log₂(K_{S}-M_{R})] bits/[log₂K_{S}] depending on if M_{R} is configured or not. This applies to all reporting UCI tables.

For CSI Part 2 WB reporting on PUSCH, single CRI wideband CQI for 2nd TB, layer indicator, PMI WB X₁ and X₂ are extended to multiple CRI as shown in table below. Extension to table is K WB CQIs for 2^{nd} TB, K LIs, K PMIX₁, and K PMI X₂ after fields and in the same order.

TABLE 6.3.2.1.2-4
Mapping order of CSI fields of one CSI report, CSI part 2 wideband

| CSI report number | CSI fields |
|---|---|
| CSI Report #n Part 2 | 1st CRI Wideband CQI for the second TB as in Tables 6.3.1.1.2-3/4/5, if |
| WB | present and reported |
| | Second CRI Wideband CQI for the second TB as in Tables 6.3.1.1.2-3/4/5, |
| | if present and reported |
| | Third CRI Wideband CQI for the second TB as in Tables 6.3.1.1.2-3/4/5, if |
| | present and reported |
| | Fourth CRI Wideband CQI for the second TB as in Tables 6.3.1.1.2-3/4/5, |
| | if present and reported |
| | 1st CRI Layer Indicator as in Tables 6.3.1.1.2-3/4/5, if reported |
| | Second CRI Layer Indicator as in Tables 6.3.1.1.2-3/4/5, if reported |
| | Third CRI Layer Indicator as in Tables 6.3.1.1.2-3/4/5, if reported |
| | Fourth CRI Layer Indicator as in Tables 6.3.1.1.2-3/4/5, if reported |
| | 1st CRI PMI wideband information fields X₁, from left to right as in Tables |
| | 6.3.1.1.2-1/2 or 6.3.2.1.2-1/2, if reported |
| | Second CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if |
| | reported |
| | Third CRI PMI wideband information fields X₁, from left to right as in |
| | Tables 6.3.1.1.2-1/2 or 6.3.2.1.2-1/2, if reported |
| | Fourth CRI PMI wideband information fields X₁, from left to right as in |
| | Tables 6.3.1.1.2-1/2 or 6.3.2.1.2-1/2, if reported |
| | 1st CRI PMI wideband information fields X2, from left to right as in Tables |
| | 6.3.1.1.2-1/2 or 6.3.2.1.2-1/2, or codebook index for 2 antenna ports |
| | according to TS38.214, if pmi-FormatIndicator = widebandPMI and if |
| | reported |
| | Second CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if |
| | reported |
| | Third CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if |
| | reported |
| | Fourth CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if |
| | reported |

In an embodiment, M−1 WB CQI for 1^{st} TB and M−1 SB CQIs differential/normal are reported in CSI part 2 WB as shown below.

TABLE 6.3.2.1.2-4
Mapping order of CSI fields of one CSI report, CSI part 2 wideband

| CSI report | |
|---|---|
| number | CSI fields |
| CSI report #n | 1st CRI Wideband CQI for the second TB as in Tables 6.3.1.1.2-3/4/5, if present and |
| CSI part 2 | reported |
| wideband | 2nd CRI Wideband CQI for the first TB as in Tables 6.3.1.1.2-3/4/5 or 6.3.2.1.2- |
| | 8/8A/8B/9/9A, if reported |
| | 2nd CRI Wideband CQI for the second TB as in Tables 6.3.1.1.2-3/4/5, if present |
| | and reported |
| | . . . |
| | M^{th} CRI Wideband CQI for the first TB as in Tables 6.3.1.1.2-3/4/5 or 6.3.2.1.2- |
| | 8/8A/8B/9/9A, if reported |
| | M^{th} CRI Wideband CQI for the second TB as in Tables 6.3.1.1.2-3/4/5, if present |
| | and reported |
| | 1st CRI Layer Indicator as in Tables 6.3.1.1.2-3/4/5, if reported |
| | 2nd CRI Layer Indicator as in Tables 6.3.1.1.2-3/4/5, if reported |
| | . . . |
| | M^{th} CRI Layer Indicator as in Tables 6.3.1.1.2-3/4/5, if reported |
| | 2nd CRI Subband differential CQI for the first TB with increasing order of subband |
| | number as in Tables 6.3.1.1.2-3/4/5 or 6.3.2.1.2-8/8A/8B/9/9A, if reported |
| | . . . |
| | M^{th} CRI Subband differential CQI for the first TB with increasing order of subband |
| | number as in Tables 6.3.1.1.2-3/4/5 or 6.3.2.1.2-8/8A/8B/9/9A, if reported |
| | 1st CRI PMI wideband information fields X₁, from left to right as in Tables 6.3.1.1.2- |
| | 1/2 or 6.3.2.1.2-1/2, if reported |
| | 2nd CRI PMI wideband information fields X₁, from left to right as in Tables |
| | 6.3.1.1.2-1/2 or 6.3.2.1.2-1/2, if reported |
| | . . . |
| | M^{th} CRI PMI wideband information fields X₁, from left to right as in Tables |
| | 6.3.1.1.2-1/2 or 6.3.2.1.2-1/2, if reported |
| | 1st CRI PMI wideband information fields X₂, from left to right as in Tables 6.3.1.1.2- |
| | 1/2 or 6.3.2.1.2-1/2, or codebook index for 2 antenna ports according to TS38.214, |
| | if pmi-FormatIndicator = widebandPMI and if reported |
| | 2nd CRI PMI wideband information fields X₂, from left to right as in Tables |
| | 6.3.1.1.2-1/2 or 6.3.2.1.2-1/2, or codebook index for 2 antenna ports according to |
| | TS38.214, if pmi-FormatIndicator = widebandPMI and if reported |
| | . . . |
| | M^{th} CRI PMI wideband information fields X₂, from left to right as in Tables |
| | 6.3.1.1.2-1/2 or 6.3.2.1.2-1/2, or codebook index for 2 antenna ports according to |
| | TS38.214, if pmi-FormatIndicator = widebandPMI and if reported |

The value of M∈{1,2,., K_{S}} and X∈{0,1.,., M_{R},., M} where M_{R} is configured, by a network, is smaller than M.

TABLE 6.3.2.1.2-3
Mapping order of CSI fields of one CSI report, CSI part 1

| CSI report number | CSI fields |
|---|---|
| CSI report #n | 1st CRI as in Tables 6.3.1.1.2-3/4/6, if reported |
| CSI part 1 | 2nd CRI as in Tables 6.3.1.1.2-3/4/6, if reported |
| | . . . |
| | M^{th} CRI as in Tables 6.3.1.1.2-3/4/6, if reported |
| | 1st CRI rank indicator as in Tables 6.3.1.1.2-3/4/5 or 6.3.2.1.2-8/8A/8B/9/9A, |
| | if reported |
| | 2nd CRI rank indicator as in Tables 6.3.1.1.2-3/4/5 or 6.3.2.1.2-8/8A/8B/9/9A, |
| | if reported |
| | . . . |
| | M^{th} CRI rank indicator as in Tables 6.3.1.1.2-3/4/5 or 6.3.2.1.2- |
| | 8/8A/8B/9/9A, if reported |
| | 1st CRI Wideband CQI for the first TB as in Tables 6.3.1.1.2-3/4/5 or 6.3.2.1.2- |
| | 8/8A/8B/9/9A, if reported |
| | 2nd CRI Wideband CQI for the first TB as in Tables 6.3.1.1.2-3/4/5 or |
| | 6.3.2.1.2-8/8A/8B/9/9A, if reported |
| | . . . |
| | X^{th} CRI Wideband CQI for the first TB as in Tables 6.3.1.1.2-3/4/5 or |
| | 6.3.2.1.2-8/8A/8B/9/9A, if reported |
| | 1st Subband differential CQI for the first TB with increasing order of subband |
| | number as in Tables 6.3.1.1.2-3/4/5 or 6.3.2.1.2-8/8A/8B/9/9A, if reported |
| | 2nd CRI Subband differential CQI for the first TB with increasing order of |
| | subband number as in Tables 6.3.1.1.2-3/4/5 or 6.3.2.1.2-8/8A/8B/9/9A, if |
| | reported |
| | . . . |
| | X^{th} CRI Subband differential CQI for the first TB with increasing order of |
| | subband number as in Tables 6.3.1.1.2-3/4/5 or 6.3.2.1.2-8/8A/8B/9/9A, if |
| | reported |
| | Indicator of the number of non-zero wideband amplitude coefficients Mo for |
| | layer 0 as in Table 6.3.1.1.2-5, if reported |
| | Indicator of the number of non-zero wideband amplitude coefficients M1 for |
| | layer 1 as in Table 6.3.1.1.2-5 (if the rank according to the reported RI is equal |
| | to one, this field is set to all zeros), if 2-layer PMI reporting is allowed |
| | according to the rank restriction in TS38.214 and if reported |
| | Indicator of the N₀ selected CSI-RS resources by a bitmap with N_{TRP} bits, this |
| | field is present only if N_{TRP} > 1 and restrictedCMR-Selection is configured to |
| | OFF |
| | Indicator of selected Lₙ value combination or αₙ value combination with |
| | bitwidth of ┌log₂(N_{L})┐, this field is present only if N_{L} > 1 |
| | Indicator of the total number of non-zero coefficients summed across all layers |
| | K^{NZ} as in Tables 6.3.2.1.2-8/8A/8B/9/9A, if reported |
| | For 2nd CRI, the total number of non-zero coefficients summed across all |
| | layers K^{NZ} as in Tables 6.3.2.1.2-8/8A/8B/9/9A, if reported, for M > 1 and if |
| | Ks > 1 resources are configured |

NOTE:
Subbands for given CSI report n indicated by the higher layer parameter csi-ReportingBand are numbered continuously in the increasing order with the lowest subband of csi-ReportingBand as subband 0 Subbands for given CSI report n indicated by the higher layer parameter csi-ReportingBand are numbered continuously in the increasing order with the lowest subband of csi-ReportingBand as subband 0.

In an embodiment, the table below shows a mapping order of CSI fields of one CSI report, CSI part 1.

TABLE 6.3.2.1.2-3
Mapping order of CSI fields of one CSI report, CSI part 1

| CSI report number | CSI fields |
|---|---|
| CSI report #n | 1st CRI as in Tables 6.3.1.1.2-3/4/6, if reported |
| CSI part 1 | 2nd CRI as in Tables 6.3.1.1.2-3/4/6, if reported |
| | . . . |
| | X^{th} CRI as in Tables 6.3.1.1.2-3/4/6, if reported |
| | 1st CRI rank indicator as in Tables 6.3.1.1.2-3/4/5 or 6.3.2.1.2-8/8A/8B/9/9A, |
| | if reported |
| | 2nd CRI rank indicator as in Tables 6.3.1.1.2-3/4/5 or 6.3.2.1.2-8/8A/8B/9/9A, |
| | if reported |
| | X^{th} CRI rank indicator as in Tables 6.3.1.1.2-3/4/5 or 6.3.2.1.2-8/8A/8B/9/9A, |
| | if reported |
| | 1st CRI Wideband CQI for the first TB as in Tables 6.3.1.1.2-3/4/5 or 6.3.2.1.2- |
| | 8/8A/8B/9/9A, if reported |
| | 2nd CRI Wideband CQI for the first TB as in Tables 6.3.1.1.2-3/4/5 or |
| | 6.3.2.1.2-8/8A/8B/9/9A, if reported |
| | . . . |
| | X^{th} CRI Wideband CQI for the first TB as in Tables 6.3.1.1.2-3/4/5 or |
| | 6.3.2.1.2-8/8A/8B/9/9A, if reported |
| | 1st Subband differential CQI for the first TB with increasing order of subband |
| | number as in Tables 6.3.1.1.2-3/4/5 or 6.3.2.1.2-8/8A/8B/9/9A, if reported |
| | 2nd CRI Subband differential CQI for the first TB with increasing order of |
| | subband number as in Tables 6.3.1.1.2-3/4/5 or 6.3.2.1.2-8/8A/8B/9/9A, if |
| | reported |
| | . . . |
| | X^{th} CRI Subband differential CQI for the first TB with increasing order of |
| | subband number as in Tables 6.3.1.1.2-3/4/5 or 6.3.2.1.2-8/8A/8B/9/9A, if |
| | reported |
| | Indicator of the number of non-zero wideband amplitude coefficients M₀ for |
| | layer 0 as in Table 6.3.1.1.2-5, if reported |
| | Indicator of the number of non-zero wideband amplitude coefficients M₁ for |
| | layer 1 as in Table 6.3.1.1.2-5 (if the rank according to the reported RI is equal |
| | to one, this field is set to all zeros), if 2-layer PMI reporting is allowed |
| | according to the rank restriction in TS38.214 and if reported |
| | Indicator of the N₀ selected CSI-RS resources by a bitmap with N_{TRP} bits, this |
| | field is present only if N_{TRP} > 1 and restrictedCMR-Selection is configured to |
| | OFF |
| | Indicator of selected Lₙ value combination or αₙ value combination with |
| | bitwidth of ┌log₂(N_{L})┐, this field is present only if N_{L} > 1 |
| | Indicator of the total number of non-zero coefficients summed across all layers |
| | K^{NZ} as in Tables 6.3.2.1.2-8/8A/8B/9/9A, if reported |
| | For 2nd CRI, the total number of non-zero coefficients summed across all |
| | layers K^{NZ} as in Tables 6.3.2.1.2-8/8A/8B/9/9A, if reported, for M > 1 and if |
| | Ks > 1 resources are configured |

NOTE:
Subbands for given CSI report n indicated by the higher layer parameter csi-ReportingBand are numbered continuously in the increasing order with the lowest subband of csi-ReportingBand as subband 0 Subbands for given CSI report n indicated by the higher layer parameter csi-ReportingBand are numbered continuously in the increasing order with the lowest subband of csi-ReportingBand as subband 0.

In an embodiment, the table below is referred to.

| CSI report number | CSI fields |
|---|---|
| CSI report #n | 1st CRI as in Tables 6.3.1.1.2-3/4/6, if reported |
| CSI part 1 | 1st rank indicator as in Tables 6.3.1.1.2-3/4/5 or 6.3.2.1.2-8/8A/8B/9/9A, if |
| | reported |
| | 1st Wideband CQI for the first TB as in Tables 6.3.1.1.2-3/4/5 or 6.3.2.1.2- |
| | 8/8A/8B/9/9A, if reported |
| | 1st Subband differential CQI for the first TB with increasing order of subband |
| | number as in Tables 6.3.1.1.2-3/4/5 or 6.3.2.1.2-8/8A/8B/9/9A, if reported |
| | Indicator of the number of non-zero wideband amplitude coefficients M₀ for |
| | layer 0 as in Table 6.3.1.1.2-5, if reported |
| | Indicator of the number of non-zero wideband amplitude coefficients M₁ for |
| | layer 1 as in Table 6.3.1.1.2-5 (if the rank according to the reported RI is equal |
| | to one, this field is set to all zeros), if 2-layer PMI reporting is allowed |
| | according to the rank restriction in TS38.214 and if reported |
| | Indicator of the N₀ selected CSI-RS resources by a bitmap with N_{TRP} bits, this |
| | field is present only if N_{TRP} > 1 and restrictedCMR-Selection is configured to |
| | OFF |
| | Indicator of selected Lₙ value combination or αₙ value combination with |
| | bitwidth of [log₂(N_{L})], this field is present only if N_{L} > 1 |
| | Indicator of the total number of non-zero coefficients summed across all layers |
| | K^{NZ} as in Tables 6.3.2.1.2-8/8A/8B/9/9A, if reported |
| | 2nd CRI as in Tables 6.3.1.1.2-3/4/6, if reported for M> 1 resources selected, if |
| | reported |
| | 2nd CRI rank indicator as in Tables 6.3.1.1.2-3/4/5 or 6.3.2.1.2-8/8A/8B/9/9A, |
| | if reported |
| | 2nd Wideband CQI for the first TB as in Tables 6.3.1.1.2-3/4/5 or 6.3.2.1.2- |
| | 8/8A/8B/9/9A, if reported |
| | 2nd Subband differential CQI for the first TB with increasing order of subband |
| | number as in Tables 6.3.1.1.2-3/4/5 or 6.3.2.1.2-8/8A/8B/9/9A, if reported |
| | 2nd CRI Indicator of the total number of non-zero coefficients summed across |
| | all layers K^{NZ} as in Tables 6.3.2.1.2-8/8A/8B/9/9A, if reported, for M > 1 and |
| | if Ks > 1 resources are configured |
| | . . . |
| | X^{th} CRI as in Tables 6.3.1.1.2-3/4/6, if reported for M>1 resources selected, |
| | if reported |
| | X^{th} CRI rank indicator as in Tables 6.3.1.1.2-3/4/5 or 6.3.2.1.2-8/8A/8B/9/9A, |
| | if reported |
| | xth Wideband CQI for the first TB as in Tables 6.3.1.1.2-3/4/5 or 6.3.2.1.2- |
| | 8/8A/8B/9/9A, if reported |
| | X^{th} Subband differential CQI for the first TB with increasing order of subband |
| | number as in Tables 6.3.1.1.2-3/4/5 or 6.3.2.1.2-8/8A/8B/9/9A, if reported |

NOTE:
Subbands for given CSI report n indicated by the higher layer parameter csi-ReportingBand are numbered continuously in the increasing order with the lowest subband of csi-ReportingBand as subband 0.

In an embodiment, the table below is referred to.

report

| CSI report | |
|---|---|
| number | CSI fields |
| CSI report #n | 1st CRI as in Tables 6.3.1.1.2-3/4/6, if reported |
| CSI part 1 | 2nd CRI as in Tables 6.3.1.1.2-3/4/6, if reported |
| | . . . |
| | M^{th} CRI as in Tables 6.3.1.1.2-3/4/6, if reported |
| | 1st CRI rank indicator as in Tables 6.3.1.1.2-3/4/5 or 6.3.2.1.2-8/8A/8B/9/9A, if |
| | reported |
| | 2nd CRI rank indicator as in Tables 6.3.1.1.2-3/4/5 or 6.3.2.1.2-8/8A/8B/9/9A, if |
| | reported |
| | . . . |
| | M^{th} CRI rank indicator as in Tables 6.3.1.1.2-3/4/5 or 6.3.2.1.2-8/8A/8B/9/9A, |
| | if reported |
| | 1st CRI Wideband CQI for the first TB as in Tables 6.3.1.1.2-3/4/5 or 6.3.2.1.2- |
| | 8/8A/8B/9/9A, if reported |
| | 1st Subband differential CQI for the first TB with increasing order of subband |
| | number as in Tables 6.3.1.1.2-3/4/5 or 6.3.2.1.2-8/8A/8B/9/9A, if reported |
| | 2nd CRI Wideband CQI for the first TB as in Tables 6.3.1.1.2-3/4/5 or 6.3.2.1.2- |
| | 8/8A/8B/9/9A, if reported |
| | 2nd CRI Subband differential CQI for the first TB with increasing order of |
| | subband number as in Tables 6.3.1.1.2-3/4/5 or 6.3.2.1.2-8/8A/8B/9/9A, if |
| | reported |
| | . . . |
| | X^{th} CRI Wideband CQI for the first TB as in Tables 6.3.1.1.2-3/4/5 or 6.3.2.1.2- |
| | 8/8A/8B/9/9A, if reported |
| | X^{th} CRI Subband differential CQI for the first TB with increasing order of |
| | subband number as in Tables 6.3.1.1.2-3/4/5 or 6.3.2.1.2-8/8A/8B/9/9A, if |
| | reported |
| | Indicator of the number of non-zero wideband amplitude coefficients M₀ for layer |
| | 0 as in Table 6.3.1.1.2-5, if reported |
| | Indicator of the number of non-zero wideband amplitude coefficients M₁ for layer |
| | 1 as in Table 6.3.1.1.2-5 (if the rank according to the reported RI is equal to one, |
| | this field is set to all zeros), if 2-layer PMI reporting is allowed according to the |
| | rank restriction in TS38.214 and if reported |
| | Indicator of the N₀ selected CSI-RS resources by a bitmap with N_{TRP} bits, this |
| | field is present only if N_{TRP} > 1 and restrictedCMR-Selection is configured to |
| | OFF |
| | Indicator of selected Lₙ value combination or αₙ value combination with bitwidth |
| | of ┌log₂ (N_{L})┐, this field is present only if N_{L} > 1 |
| | Indicator of the total number of non-zero coefficients summed across all layers |
| | K^{NZ} as in Tables 6.3.2.1.2-8/8A/8B/9/9A, if reported |
| | For 2nd CRI, the total number of non-zero coefficients summed across all layers |
| | K^{NZ} as in Tables 6.3.2.1.2-8/8A/8B/9/9A, if reported, for M > 1 and if Ks > 1 |
| | resources are configured |

NOTE:
Subbands for given CSI report n indicated by the higher layer parameter csi-ReportingBand are numbered continuously in the increasing order with the lowest subband of csi-ReportingBand as subband 0 Subbands for given CSI report n indicated by the higher layer parameter csi-ReportingBand are numbered continuously in the increasing order with the lowest subband of csi-ReportingBand as subband 0.

In such cases, in one embodiment, the UE (102) does not report higher priority resource CRIs (M_{R}) and in an embodiment, irrespective of configuration of M_{R} resources a UE always report with the same UCI payload. This helps in a unified design. Those M_{R} resources can be sent configured to be periodic, semi-persistent, or aperiodic with CSI-Aperiodictriggerlist. Also, a report can be configured to periodic, semi-persistent, or aperiodic depending on type CSI Configured. For example, for aperiodic CSI, only aperiodic reporting can be configured.

In an embodiment, the table below is referred to.

| | CSI fields |
|---|---|
| CSI report #n | 1st CRI as in Tables 6.3.1.1.2-3/4/6, if reported |
| CSI part 1 | 1st rank indicator as in Tables 6.3.1.1.2-3/4/5 or 6.3.2.1.2-8/8A/8B/9/9A, |
| | if reported |
| | 1st Wideband CQI for the first TB as in Tables 6.3.1.1.2-3/4/5 or 6.3.2.1.2- |
| | 8/8A/8B/9/9A, if reported |
| | 1st Subband differential CQI for the first TB with increasing order of |
| | subband number as in Tables 6.3.1.1.2-3/4/5 or 6.3.2.1.2-8/8A/8B/9/9A, |
| | if reported |
| | Indicator of the number of non-zero wideband amplitude coefficients M₀ |
| | for layer 0 as in Table 6.3.1.1.2-5, if reported |
| | Indicator of the number of non-zero wideband amplitude coefficients M₁ |
| | for layer 1 as in Table 6.3.1.1.2-5 (if the rank according to the reported RI |
| | is equal to one, this field is set to all zeros), if 2-layer PMI reporting is |
| | allowed according to the rank restriction in TS38.214 and if reported |
| | Indicator of the N₀ selected CSI-RS resources by a bitmap with N_{TRP} bits, |
| | this field is present only if N_{TRP} > 1 and restrictedCMR-Selection is |
| | configured to OFF |
| | Indicator of selected Lₙ value combination or αₙ value combination with |
| | bitwidth of ┌log₂(N_{L})┐, this field is present only if N_{L} > 1 |
| | Indicator of the total number of non-zero coefficients summed across all |
| | layers K^{NZ} as in Tables 6.3.2.1.2-8/8A/8B/9/9A, if reported |
| | 2nd CRI as in Tables 6.3.1.1.2-3/4/6, if reported for M > 1 resources |
| | selected, if reported |
| | 2nd CRI rank indicator as in Tables 6.3.1.1.2-3/4/5 or 6.3.2.1.2- |
| | 8/8A/8B/9/9A, if reported |
| | 2nd Wideband CQI for the first TB as in Tables 6.3.1.1.2-3/4/5 or |
| | 6.3.2.1.2-8/8A/8B/9/9A, if reported |
| | 2nd Subband differential CQI for the first TB with increasing order of |
| | subband number as in Tables 6.3.1.1.2-3/4/5 or 6.3.2.1.2-8/8A/8B/9/9A, |
| | if reported |
| | 2nd CRI Indicator of the total number of non-zero coefficients summed |
| | across all layers K^{NZ} as in Tables 6.3.2.1.2-8/8A/8B/9/9A, if reported, for |
| | M > 1 and if Ks > 1 resources are configured |
| | . . . |
| | . . . |
| | X^{th} CRI as in Tables 6.3.1.1.2-3/4/6, if reported for M > 1 resources |
| | selected, if reported |
| | X^{th} CRI rank indicator as in Tables 6.3.1.1.2-3/4/5 or 6.3.2.1.2- |
| | 8/8A/8B/9/9A, if reported |
| | X^{th} CRI Wideband CQI for the first TB as in Tables 6.3.1.1.2-3/4/5 or |
| | 6.3.2.1.2-8/8A/8B/9/9A, if reported |
| | X^{th} CRI Subband differential CQI for the first TB with increasing order |
| | of subband number as in Tables 6.3.1.1.2-3/4/5 or 6.3.2.1.2- |
| | 8/8A/8B/9/9A, if reported |
| | . . . |
| | M^{th} CRI as in Tables 6.3.1.1.2-3/4/6, if reported for M > 1 resources |
| | selected, if reported |
| | M^{th} CRI rank indicator as in Tables 6.3.1.1.2-3/4/5 or 6.3.2.1.2- |
| | 8/8A/8B/9/9A, if reported |

NOTE:
Subbands for given CSI report n indicated by the higher layer parameter csi-ReportingBand are numbered continuously in the increasing order with the lowest subband of csi-ReportingBand as subband 0.

For CSI Part 2 WB reporting on PUSCH, single CRI wideband CQI for 2nd TB, layer indicator, PMI WB X₁ and X₂ are extended to multiple CRI as shown in table below. Extension to table is K WB CQIs for 2^{nd} TB, K LIs, K PMIX₁, and K PMI X₂ after fields and in the same order.

TABLE 6.3.2.1.2-4
Mapping order of CSI fields of one CSI report, CSI part 2 wideband

| CSI report number | CSI fields |
|---|---|
| CSI Report #n Part 2 | 1st CRI Wideband CQI for the second TB as in Tables 6.3.1.1.2-3/4/5, if |
| WB | present and reported |
| | Second CRI Wideband CQI for the second TB as in Tables 6.3.1.1.2-3/4/5, |
| | if present and reported |
| | Third CRI Wideband CQI for the second TB as in Tables 6.3.1.1.2-3/4/5, if |
| | present and reported |
| | Fourth CRI Wideband CQI for the second TB as in Tables 6.3.1.1.2-3/4/5, |
| | if present and reported |
| | 1st CRI Layer Indicator as in Tables 6.3.1.1.2-3/4/5, if reported |
| | Second CRI Layer Indicator as in Tables 6.3.1.1.2-3/4/5, if reported |
| | Third CRI Layer Indicator as in Tables 6.3.1.1.2-3/4/5, if reported |
| | Fourth CRI Layer Indicator as in Tables 6.3.1.1.2-3/4/5, if reported |
| | 1st CRI PMI wideband information fields X₁, from left to right as in Tables |
| | 6.3.1.1.2-1/2 or 6.3.2.1.2-1/2, if reported |
| | Second CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if |
| | reported |
| | Third CRI PMI wideband information fields X₁, from left to right as in |
| | Tables 6.3.1.1.2-1/2 or 6.3.2.1.2-1/2, if reported |
| | Fourth CRI PMI wideband information fields X₁, from left to right as in |
| | Tables 6.3.1.1.2-1/2 or 6.3.2.1.2-1/2, if reported |
| | 1st CRI PMI wideband information fields X₂, from left to right as in Tables |
| | 6.3.1.1.2-1/2 or 6.3.2.1.2-1/2, or codebook index for 2 antenna ports |
| | according to TS38.214, if pmi-FormatIndicator = widebandPMI and if |
| | reported |
| | Second CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if |
| | reported |
| | Third CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicato r = widebandPMI and if |
| | reported |
| | Fourth CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if |
| | reported |

TABLE 6.3.2.1.2-4
Mapping order of CSI fields of one CSI report, CSI part 2 wideband

| CSI report number | CSI fields |
|---|---|
| CSI Part 2 | (M − X + 1) CRI Wideband CQI for the first TB as in Tables 6.3.1.1.2- |
| WB | 3/4/5 or 6.3.2.1.2-8/8A/8B/9/9A, if reported |
| | M − X + 2) CRI Wideband CQI for the first TB as in Tables 6.3.1.1.2-3/4/5 |
| | or 6.3.2.1.2-8/8A/8B/9/9A, if reported |
| | . . . |
| | M^{th} CRI Wideband CQI for the first TB as in Tables 6.3.1.1.2-3/4/5 or |
| | 6.3.2.1.2-8/8A/8B/9/9A, if reported |
| | (M − X + 1) CRI Subband differential CQI for the first TB with increasing |
| | order of subband number as in Tables 6.3.1.1.2-3/4/5 or 6.3.2.1.2- |
| | 8/8A/8B/9/9A, if reported |
| | (M − X + 2) CRI Subband differential CQI for the first TB with increasing |
| | order of subband number as in Tables 6.3.1.1.2-3/4/5 or 6.3.2.1.2- |
| | 8/8A/8B/9/9A, if reported |
| | . . . |
| | M^{th} CRI Subband differential CQI for the first TB with increasing order of |
| | subband number as in Tables 6.3.1.1.2-3/4/5 or 6.3.2.1.2-8/8A/8B/9/9A, if |
| | reported |
| | 1st CRI Wideband CQI for the second TB as in Tables 6.3.1.1.2-3/4/5, if |
| | present and reported |
| | Second CRI Wideband CQI for the second TB as in Tables 6.3.1.1.2-3/4/5, |
| | if present and reported |
| | Third CRI Wideband CQI for the second TB as in Tables 6.3.1.1.2-3/4/5, if |
| | present and reported |
| | Fourth CRI Wideband CQI for the second TB as in Tables 6.3.1.1.2-3/4/5, |
| | if present and reported |
| | 1st CRI Layer Indicator as in Tables 6.3.1.1.2-3/4/5, if reported |
| | Second CRI Layer Indicator as in Tables 6.3.1.1.2-3/4/5, if reported |
| | third CRI Layer Indicator as in Tables 6.3.1.1.2-3/4/5, if reported |
| | Fourth CRI Layer Indicator as in Tables 6.3.1.1.2-3/4/5, if reported |
| | 1st CRI PMI wideband information fields X₁, from left to right as in Tables |
| | 6.3.1.1.2-1/2 or 6.3.2.1.2-1/2, if reported |
| | Second CRI PMI wideband information fields X₁, from left to right as in |
| | Tables 6.3.1.1.2-1/2 or 6.3.2.1.2-1/2, if reported |
| | Third CRI PMI wideband information fields X₁, from left to right as in |
| | Tables 6.3.1.1.2-1/2 or 6.3.2.1.2-1/2, if reported |
| | Fourth CRI PMI wideband information fields X₁, from left to right as in |
| | Tables 6.3.1.1.2-1/2 or 6.3.2.1.2-1/2, if reported |
| | 1st CRI PMI wideband information fields X₂, from left to right as in Tables |
| | 6.3.1.1.2-1/2 or 6.3.2.1.2-1/2, or codebook index for 2 antenna ports |
| | according to TS38.214, if pmi-FormatIndicator = widebandPMI and if |
| | reported |
| | Second CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if |
| | reported |
| | Third CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if |
| | reported |
| | Fourth CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if |
| | reported |

In an embodiment, the table below is referred to.

| CSI report number | CSI fields |
|---|---|
| CSI Part 2 | (M − X + 1) CRI Wideband CQI for the first TB as in Tables 6.3.1.1.2- |
| | 3/4/5 or 6.3.2.1.2-8/8A/8B/9/9A, if reported |
| WB | (M − X + 1) CRI Subband differential CQI for the first TB with increasing |
| | order of subband number as in Tables 6.3.1.1.2-3/4/5 or 6.3.2.1.2- |
| | 8/8A/8B/9/9A, if reported |
| | M − X + 2) CRI Wideband CQI for the first TB as in Tables 6.3.1.1.2-3/4/5 |
| | or 6.3.2.1.2-8/8A/8B/9/9A, if reported |
| | (M − X + 2) CRI Subband differential CQI for the first TB with increasing |
| | order of subband number as in Tables 6.3.1.1.2-3/4/5 or 6.3.2.1.2- |
| | 8/8A/8B/9/9A, if reported |
| | M^{th} CRI Wideband CQI for the first TB as in Tables 6.3.1.1.2-3/4/5 or |
| | 6.3.2.1.2-8/8A/8B/9/9A, if reported |
| | M^{th} CRI Subband differential CQI for the first TB with increasing order of |
| | subband number as in Tables 6.3.1.1.2-3/4/5 or 6.3.2.1.2-8/8A/8B/9/9A, if |
| | reported |
| | 1st CRI Wideband CQI for the second TB as in Tables 6.3.1.1.2-3/4/5, if |
| | present and reported |
| | Second CRI Wideband CQI for the second TB as in Tables 6.3.1.1.2-3/4/5, |
| | if present and reported |
| | Third CRI Wideband CQI for the second TB as in Tables 6.3.1.1.2-3/4/5, if |
| | present and reported |
| | Fourth CRI Wideband CQI for the second TB as in Tables 6.3.1.1.2-3/4/5, |
| | if present and reported |
| | 1st CRI Layer Indicator as in Tables 6.3.1.1.2-3/4/5, if reported |
| | Second CRI Layer Indicator as in Tables 6.3.1.1.2-3/4/5, if reported |
| | third CRI Layer Indicator as in Tables 6.3.1.1.2-3/4/5, if reported |
| | Fourth CRI Layer Indicator as in Tables 6.3.1.1.2-3/4/5, if reported |
| | 1st CRI PMI wideband information fields X₁, from left to right as in Tables |
| | 6.3.1.1.2-1/2 or 6.3.2.1.2-1/2, if reported |
| | Second CRI PMI wideband information fields X₁, from left to right as in |
| | Tables 6.3.1.1.2-1/2 or 6.3.2.1.2-1/2, if reported |
| | Third CRI PMI wideband information fields X₁, from left to right as in |
| | Tables 6.3.1.1.2-1/2 or 6.3.2.1.2-1/2, if reported |
| | Fourth CRI PMI wideband information fields X₁, from left to right as in |
| | Tables 6.3.1.1.2-1/2 or 6.3.2.1.2-1/2, if reported |
| | 1st CRI PMI wideband information fields X₂, from left to right as in Tables |
| | 6.3.1.1.2-1/2 or 6.3.2.1.2-1/2, or codebook index for 2 antenna ports |
| | according to TS38.214, if pmi-FormatIndicator = widebandPMI and if |
| | reported |
| | Second CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if |
| | reported |
| | Third CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if |
| | reported |
| | Fourth CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if |
| | reported |

In an embodiment, the table below shows a mapping order of CSI fields of one CSI report, CSI part 2 wideband.

TABLE 6.3.2.1.2-4
Mapping order of CSI fields of one CSI report, CSI part 2 wideband

| CSI report number | CSI fields |
|---|---|
| CSI part 2 WB | (M − X + 1) CRI Wideband CQI for the first TB as in Tables 6.3.1.1.2-3/4/5 |
| | or 6.3.2.1.2-8/8A/8B/9/9A, if reported |
| | (M − X + 1) CRI Subband differential CQI for the first TB with increasing |
| | order of subband number as in Tables 6.3.1.1.2-3/4/5 or 6.3.2.1.2- |
| | 8/8A/8B/9/9A, if reported |
| | (M − X + 2) CRI Wideband CQI for the first TB as in Tables 6.3.1.1.2-3/4/5 |
| | or 6.3.2.1.2-8/8A/8B/9/9A, if reported |
| | (M − X + 2) CRI Subband differential CQI for the first TB with increasing |
| | order of subband number as in Tables 6.3.1.1.2-3/4/5 or 6.3.2.1.2- |
| | 8/8A/8B/9/9A, if reported |
| | . . . |
| | M^{th} CRI Wideband CQI for the first TB as in Tables 6.3.1.1.2-3/4/5 or |
| | 6.3.2.1.2-8/8A/8B/9/9A, if reported |
| | M^{th} CRI Subband differential CQI for the first TB with increasing order of |
| | subband number as in Tables 6.3.1.1.2-3/4/5 or 6.3.2.1.2-8/8A/8B/9/9A, if |
| | reported |
| | 1st CRI Wideband CQI for the second TB as in Tables 6.3.1.1.2-3/4/5, if |
| | present and reported |
| | Second CRI Wideband CQI for the second TB as in Tables 6.3.1.1.2-3/4/5, if |
| | present and reported |
| | Third CRI Wideband CQI for the second TB as in Tables 6.3.1.1.2-3/4/5, if |
| | present and reported |
| | Fourth CRI Wideband CQI for the second TB as in Tables 6.3.1.1.2-3/4/5, if |
| | present and reported |
| | 1st CRI Layer Indicator as in Tables 6.3.1.1.2-3/4/5, if reported |
| | Second CRI Layer Indicator as in Tables 6.3.1.1.2-3/4/5, if reported |
| | third CRI Layer Indicator as in Tables 6.3.1.1.2-3/4/5, if reported |
| | Fourth CRI Layer Indicator as in Tables 6.3.1.1.2-3/4/5, if reported |
| | 1st CRI PMI wideband information fields X₁, from left to right as in Tables |
| | 6.3.1.1.2-1/2 or 6.3.2.1.2-1/2, if reported |
| | 1st CRI PMI wideband information fields X₂, from left to right as in Tables |
| | 6.3.1.1.2-1/2 or 6.3.2.1.2-1/2, or codebook index for 2 antenna ports according |
| | to TS38.214, if pmi-FormatIndicator = widebandPMI and if reported |
| | Second CRI PMI wideband information fields X₁, from left to right as in Tables |
| | 6.3.1.1.2-1/2 or 6.3.2.1.2-1/2, if reported |
| | Second CRI PMI wideband information fields X₂, from left to right as in Tables |
| | 6.3.1.1.2-1/2 or 6.3.2.1.2-1/2, or codebook index for 2 antenna ports according |
| | to TS38.214, if pmi-FormatIndicator = widebandPMI and if reported |
| | Third CRI PMI wideband information fields X₁, from left to right as in Tables |
| | 6.3.1.1.2-1/2 or 6.3.2.1.2-1/2, if reported |
| | Third CRI PMI wideband information fields X₂, from left to right as in Tables |
| | 6.3.1.1.2-1/2 or 6.3.2.1.2-1/2, or codebook index for 2 antenna ports according |
| | to TS38.214, if pmi-FormatIndicator = widebandPMI and if reported |
| | Fourth CRI PMI wideband information fields X₁, from left to right as in Tables |
| | 6.3.1.1.2-1/2 or 6.3.2.1.2-1/2, if reported |
| | Fourth CRI PMI wideband information fields X₂, from left to right as in Tables |
| | 6.3.1.1.2-1/2 or 6.3.2.1.2-1/2, or codebook index for 2 antenna ports according |
| | to TS38.214, if pmi-FormatIndicator = widebandPMI and if reported |

In an embodiment, M−1 WB CQI for 1^{st} TB and M−1 SB CQIs differential/normal are reported in CSI part 2 WB as shown below.

TABLE 6.3.2.1.2-4
Mapping order of CSI fields of one CSI report, CSI part 2 wideband

| CSI report number | CSI fields |
|---|---|
| CSI report #n | 1st CRI Wideband CQI for the second TB as in Tables 6.3.1.1.2-3/4/5, if |
| | present and reported |
| CSI part 2 | 1st CRI Layer Indicator as in Tables 6.3.1.1.2-3/4/5, if reported |
| wideband | 1st CRI PMI wideband information fields X1, from left to right as in Tables |
| | 6.3.1.1.2-1/2 or 6.3.2.1.2-1/2, if reported |
| | 1st CRI PMI wideband information fields X₂, from left to right as in Tables |
| | 6.3.1.1.2-1/2 or 6.3.2.1.2-1/2, or codebook index for 2 antenna ports according |
| | to TS38.214, if pmi-FormatIndicator = widebandPMI and if reported |
| | . . . |
| | . . . |
| | (X) CRI Wideband CQI for the second TB as in Tables 6.3.1.1.2-3/4/5, if |
| | present and reported |
| | X) CRI Layer Indicator as in Tables 6.3.1.1.2-3/4/5, if reported |
| | X) CRI PMI wideband information fields X₁, from left to right as in Tables |
| | 6.3.1.1.2-1/2 or 6.3.2.1.2-1/2, if reported |
| | (X) CRI PMI wideband information fields X₂, from left to right as in Tables |
| | 6.3.1.1.2-1/2 or 6.3.2.1.2-1/2, or codebook index for 2 antenna ports according |
| | to TS38.214, if pmi-FormatIndicator = widebandPMI and if reported |
| | (M − X + 1) CRI Wideband CQI for the first TB as in Tables 6.3.1.1.2-3/4/5 |
| | or 6.3.2.1.2-8/8A/8B/9/9A, if reported |
| | (M − X + 1) CRI Subband differential CQI for the first TB with increasing |
| | order of subband number as in Tables 6.3.1.1.2-3/4/5 or 6.3.2.1.2- |
| | 8/8A/8B/9/9A, if reported |
| | (M − X + 1) CRI Wideband CQI for the second TB as in Tables 6.3.1.1.2- |
| | 3/4/5, if present and reported |
| | (M − X + 1) CRI Layer Indicator as in Tables 6.3.1.1.2-3/4/5, if reported |
| | (M − X + 1) CRI PMI wideband information fields X₁, from left to right as in |
| | Tables 6.3.1.1.2-1/2 or 6.3.2.1.2-1/2, if reported |
| | (M − X + 1) CRI PMI wideband information fields X₂, from left to right as in |
| | Tables 6.3.1.1.2-1/2 or 6.3.2.1.2-1/2, or codebook index for 2 antenna ports |
| | according to TS38.214, if pmi-FormatIndicator = widebandPMI and if reported |
| | . . . |
| | M^{th} CRI Wideband CQI for the first TB as in Tables 6.3.1.1.2-3/4/5 or |
| | 6.3.2.1.2-8/8A/8B/9/9A, if reported |
| | M^{th} CRI Subband differential CQI for the first TB with increasing order of |
| | subband number as in Tables 6.3.1.1.2-3/4/5 or 6.3.2.1.2-8/8A/8B/9/9A, if |
| | reported |
| | M^{th} CRI Wideband CQI for the second TB as in Tables 6.3.1.1.2-3/4/5, if |
| | present and reported |
| | M^{th} CRI Layer Indicator as in Tables 6.3.1.1.2-3/4/5, if reported |
| | M^{th} CRI PMI wideband information fields X₁, from left to right as in Tables |
| | 6.3.1.1.2-1/2 or 6.3.2.1.2-1/2, if reported |
| | M^{th} CRI PMI wideband information fields X₂, from left to right as in Tables |
| | 6.3.1.1.2-1/2 or 6.3.2.1.2-1/2, or codebook index for 2 antenna ports according |
| | to TS38.214, if pmi-FormatIndicator = widebandPMI and if reported |

For CSI part 2 SB, in addition of Sub band differential CQI of second TB, sub band differential CQI of 1^{st} TB is also added for (M-X+1) CRIs as shown in table below.

TABLE 6.3.2.1.2-5
Mapping order of CSI fields of one CSI report, CSI part 2 subband

| | |
|---|---|
| CSI report #n | (M − X + 1) CRI Subband differential CQI for the first TB with increasing order |
| Part 2 | of subband number as in Tables 6.3.1.1.2-3/4/5 or 6.3.2.1.2-8/8A/8B/9/9A, if |
| subband | reported |
| | M^{th} CRI Subband differential CQI for the first TB with increasing order of |
| | subband number as in Tables 6.3.1.1.2-3/4/5 or 6.3.2.1.2-8/8A/8B/9/9A, if |
| | reported |
| | 1st CRI Subband differential CQI for the second TB of all even subbands with |
| | increasing order of subband number, as in Tables 6.3.1.1.2-3/4/5, if cqi- |
| | FormatIndicator = subbandCQI and if reported |
| | 1st CRI PMI subband information fields X₂ of all even subbands with increasing |
| | order of subband number, from left to right as in Tables 6.3.1.1.2-1/2 or 6.3.2.1.2- |
| | 1/2, or codebook index for 2 antenna ports according to TS38.214 of all even |
| | subbands with increasing order of subband number, if pmi-FormatIndicator = |
| | subbandPMI and if reported |
| | 1st CRI Subband differential CQI for the second TB of all odd subbands with |
| | increasing order of subband number, as in Tables 6.3.1.1.2-3/4/5, if cqi- |
| | FormatIndicator = subbandCQI and if reported |
| | 1st CRI PMI subband information fields X₂ of all odd subbands with increasing |
| | order of subband number, from left to right as in Tables 6.3.1.1.2-1/2 or 6.3.2.1.2- |
| | 1/2, or codebook index for 2 antenna ports according to TS38.214 of all odd |
| | subbands with increasing order of subband number, if pmi-FormatIndicator = |
| | subbandPMI and if reported |
| | 2nd CRI Subband differential CQI for the second TB of all even subbands with |
| | increasing order of subband number, as in Tables 6.3.1.1.2-3/4/5, if cqi- |
| | FormatIndicator = subbandCQI and if reported |
| | 2nd CRI PMI subband information fields X₂ of all even subbands with increasing |
| | order of subband number, from left to right as in Tables 6.3.1.1.2-1/2 or 6.3.2.1.2- |
| | 1/2, or codebook index for 2 antenna ports according to TS38.214 of all even |
| | subbands with increasing order of subband number, if pmi-FormatIndicator = |
| | subbandPMI and if reported |
| | 2nd CRI Subband differential CQI for the second TB of all odd subbands with |
| | increasing order of subband number, as in Tables 6.3.1.1.2-3/4/5, if cqi- |
| | FormatIndicator = subbandCQI and if reported |
| | 2nd CRI PMI subband information fields X₂ of all odd subbands with increasing |
| | order of subband number, from left to right as in Tables 6.3.1.1.2-1/2 or 6.3.2.1.2- |
| | 1/2, or codebook index for 2 antenna ports according to TS38.214 of all odd |
| | subbands with increasing order of subband number, if pmi-FormatIndicator = |
| | subbandPMI and if reported |
| | 3rd CRI Subband differential CQI for the second TB of all even subbands with |
| | increasing order of subband number, as in Tables 6.3.1.1.2-3/4/5, if cqi- |
| | FormatIndicator = subbandCQI and if reported |
| | 3rd CRI PMI subband information fields X₂ of all even subbands with increasing |
| | order of subband number, from left to right as in Tables 6.3.1.1.2-1/2 or 6.3.2.1.2- |
| | 1/2, or codebook index for 2 antenna ports according to TS38.214 of all even |
| | subbands with increasing order of subband number, if pmi-FormatIndicator = |
| | subbandPMI and if reported |
| | 3rd CRI Subband differential CQI for the second TB of all odd subbands with |
| | increasing order of subband number, as in Tables 6.3.1.1.2-3/4/5, if cqi- |
| | FormatIndicator = subbandCQI and if reported |
| | 3rd CRI PMI subband information fields X₂ of all odd subbands with increasing |
| | order of subband number, from left to right as in Tables 6.3.1.1.2-1/2 or 6.3.2.1.2- |
| | 1/2, or codebook index for 2 antenna ports according to TS38.214 of all odd |
| | subbands with increasing order of subband number, if pmi-FormatIndicator = |
| | subbandPMI and if reported |
| | 4th CRI Subband differential CQI for the second TB of all even subbands with |
| | increasing order of subband number, as in Tables 6.3.1.1.2-3/4/5, if cqi- |
| | FormatIndicator = subbandCQI and if reported |
| | 4th CRI PMI subband information fields X₂ of all even subbands with increasing |
| | order of subband number, from left to right as in Tables 6.3.1.1.2-1/2 or 6.3.2.1.2- |
| | 1/2, or codebook index for 2 antenna ports according to TS38.214 of all even |
| | subbands with increasing order of subband number, if pmi-FormatIndicator = |
| | subbandPMI and if reported |
| | 4th CRI Subband differential CQI for the second TB of all odd subbands with |
| | increasing order of subband number, as in Tables 6.3.1.1.2-3/4/5, if cqi- |
| | FormatIndicator = subbandCQI and if reported |
| | 4th CRI PMI subband information fields X₂ of all odd subbands with increasing |
| | order of subband number, from left to right as in Tables 6.3.1.1.2-1/2 or 6.3.2.1.2- |
| | 1/2, or codebook index for 2 antenna ports according to TS38.214 of all odd |
| | subbands with increasing order of subband number, if pmi-FormatIndicator = |
| | subbandPMI and if reported |

NOTE:
Subbands for given CSI report n indicated by the higher layer parameter csi-ReportingBand are numbered continuously in the increasing order with the lowest subband of csi-ReportingBand as subband 0.

In an embodiment, the table below is referred to.

| | |
|---|---|
| CSI part 2 SB | 1st CRI Subband differential CQI for the second TB of all even subbands with |
| report#n | increasing order of subband number, as in Tables 6.3.1.1.2-3/4/5, if cqi- |
| | FormatIndicator = subbandCQI and if reported |
| | 1st CRI PMI subband information fields X₂ of all even subbands with increasing |
| | order of subband number, from left to right as in Tables 6.3.1.1.2-1/2 or 6.3.2.1.2- |
| | 1/2, or codebook index for 2 antenna ports according to TS38.214 of all even |
| | subbands with increasing order of subband number, if pmi-FormatIndicator = |
| | subbandPMI and if reported |
| | 1st CRI Subband differential CQI for the second TB of all odd subbands with |
| | increasing order of subband number, as in Tables 6.3.1.1.2-3/4/5, if cqi- |
| | FormatIndicator = subbandCQI and if reported |
| | 1st CRI PMI subband information fields X₂ of all odd subbands with increasing |
| | order of subband number, from left to right as in Tables 6.3.1.1.2-1/2 or 6.3.2.1.2- |
| | 1/2, or codebook index for 2 antenna ports according to TS38.214 of all odd |
| | subbands with increasing order of subband number, if pmi-FormatIndicator = |
| | subbandPMI and if reported |
| | . . . |
| | (M − X) CRI Subband differential CQI for the second TB of all even subbands |
| | with increasing order of subband number, as in Tables 6.3.1.1.2-3/4/5, if cqi- |
| | FormatIndicator = subbandCQI and if reported |
| | (M − X ) CRI PMI subband information fields X₂ of all even subbands with |
| | increasing order of subband number, from left to right as in Tables 6.3.1.1.2-1/2 or |
| | 6.3.2.1.2-1/2, or codebook index for 2 antenna ports according to TS38.214 of all |
| | even subbands with increasing order of subband number, if pmi-FormatIndicator = |
| | subbandPMI and if reported |
| | (M − X ) CRI Subband differential CQI for the second TB of all odd subbands with |
| | increasing order of subband number, as in Tables 6.3.1.1.2-3/4/5, if cqi- |
| | FormatIndicator = subbandCQI and if reported |
| | (M − X ) CRI PMI subband information fields X₂ of all odd subbands with |
| | increasing order of subband number, from left to right as in Tables 6.3.1.1.2-1/2 or |
| | 6.3.2.1.2-1/2, or codebook index for 2 antenna ports according to TS38.214 of all |
| | odd subbands with increasing order of subband number, if pmi-FormatIndicator = |
| | subbandPMI and if reported |
| | (M − X + 1) CRI Subband differential CQI for the first TB with increasing order |
| | of subband number as in Tables 6.3.1.1.2-3/4/5 or 6.3.2.1.2-8/8A/8B/9/9A, if |
| | reported |
| | (M − X + 1) CRI Subband differential CQI for the second TB of all even |
| | subbands with increasing order of subband number, as in Tables 6.3.1.1.2-3/4/5, if |
| | cqi-FormatIndicator = subbandCQI and if reported |
| | (M − X + 1) CRI PMI subband information fields X₂ of all even subbands with |
| | increasing order of subband number, from left to right as in Tables 6.3.1.1.2-1/2 or |
| | 6.3.2.1.2-1/2, or codebook index for 2 antenna ports according to TS38.214 of all |
| | even subbands with increasing order of subband number, if pmi-FormatIndicator = |
| | subbandPMI and if reported |
| | (M − X + 1) CRI Subband differential CQI for the second TB of all odd subbands |
| | with increasing order of subband number, as in Tables 6.3.1.1.2-3/4/5, if cqi- |
| | FormatIndicator = subbandCQI and if reported |
| | (M − X + 1) CRI PMI subband information fields X₂ of all odd subbands with |
| | increasing order of subband number, from left to right as in Tables 6.3.1.1.2-1/2 or |
| | 6.3.2.1.2-1/2, or codebook index for 2 antenna ports according to TS38.214 of all |
| | odd subbands with increasing order of subband number, if pmi-FormatIndicator = |
| | subbandPMI and if reported |
| | . . . |
| | M^{th} CRI Subband differential CQI for the first TB with increasing order of |
| | subband number as in Tables 6.3.1.1.2-3/4/5 or 6.3.2.1.2-8/8A/8B/9/9A, if |
| | reported |
| | M^{th} CRI Subband differential CQI for the second TB of all even subbands with |
| | increasing order of subband number, as in Tables 6.3.1.1.2-3/4/5, if cqi- |
| | FormatIndicator = subbandCQI and if reported |
| | M^{th} CRI PMI subband information fields X₂ of all even subbands with increasing |
| | order of subband number, from left to right as in Tables 6.3.1.1.2-1/2 or 6.3.2.1.2- |
| | 1/2, or codebook index for 2 antenna ports according to TS38.214 of all even |
| | subbands with increasing order of subband number, if pmi-FormatIndicator = |
| | subbandPMI and if reported |
| | M^{th} CRI Subband differential CQI for the second TB of all odd subbands with |
| | increasing order of subband number, as in Tables 6.3.1.1.2-3/4/5, if cqi- |
| | FormatIndicator = subbandCQI and if reported |
| | M^{th} CRI PMI subband information fields X₂ of all odd subbands with increasing |
| | order of subband number, from left to right as in Tables 6.3.1.1.2-1/2 or 6.3.2.1.2- |
| | 1/2, or codebook index for 2 antenna ports according to TS38.214 of all odd |
| | subbands with increasing order of subband number, if pmi-FormatIndicator = |
| | subbandPMI and if reported |

NOTE:
Subbands for given CSI report n indicated by the higher layer parameter csi-ReportingBand are numbered continuously in the increasing order with the lowest subband of csi-ReportingBand as subband 0.

In an embodiment, the table below is referred to.

TABLE 6.3.2.1.2-5
Mapping order of CSI fields of one CSI report, CSI part 2 subband

| | |
|---|---|
| CSI part 2 SB | 1st CRI Subband differential CQI for the second TB of all even subbands with |
| report#n | increasing order of subband number, as in Tables 6.3.1.1.2-3/4/5, if cqi- |
| | FormatIndicator = subbandCQI and if reported |
| | 1st CRI PMI subband information fields X₂ of all even subbands with increasing |
| | order of subband number, from left to right as in Tables 6.3.1.1.2-1/2 or 6.3.2.1.2- |
| | 1/2, or codebook index for 2 antenna ports according to TS38.214 of all even |
| | subbands with increasing order of subband number, if pmi-FormatIndicator = |
| | subbandPMI and if reported |
| | 1st CRI Subband differential CQI for the second TB of all odd subbands with |
| | increasing order of subband number, as in Tables 6.3.1.1.2-3/4/5, if cqi- |
| | FormatIndicator = subbandCQI and if reported |
| | 1st CRI PMI subband information fields X₂ of all odd subbands with increasing |
| | order of subband number, from left to right as in Tables 6.3.1.1.2-1/2 or 6.3.2.1.2- |
| | 1/2, or codebook index for 2 antenna ports according to TS38.214 of all odd |
| | subbands with increasing order of subband number, if pmi-FormatIndicator = |
| | subbandPMI and if reported |
| | . . . |
| | (M − X ) CRI Subband differential CQI for the second TB of all even subbands |
| | with increasing order of subband number, as in Tables 6.3.1.1.2-3/4/5, if cqi- |
| | FormatIndicator = subbandCQI and if reported |
| | (M − X ) CRI PMI subband information fields X₂ of all even subbands with |
| | increasing order of subband number, from left to right as in Tables 6.3.1.1.2-1/2 or |
| | 6.3.2.1.2-1/2, or codebook index for 2 antenna ports according to TS38.214 of all |
| | even subbands with increasing order of subband number, if pmi-FormatIndicator = |
| | subbandPMI and if reported |
| | (M − X ) CRI Subband differential CQI for the second TB of all odd subbands with |
| | increasing order of subband number, as in Tables 6.3.1.1.2-3/4/5, if cqi- |
| | FormatIndicator = subbandCQI and if reported |
| | (M − X ) CRI PMI subband information fields X₂ of all odd subbands with |
| | increasing order of subband number, from left to right as in Tables 6.3.1.1.2-1/2 or |
| | 6.3.2.1.2-1/2, or codebook index for 2 antenna ports according to TS38.214 of all |
| | odd subbands with increasing order of subband number, if pmi-FormatIndicator = |
| | subbandPMI and if reported |
| | (M − X + 1) CRI Subband differential CQI for the first TB of all even subbands |
| | with increasing order of subband number as in Tables 6.3.1.1.2-3/4/5 or 6.3.2.1.2- |
| | 8/8A/8B/9/9A, if reported |
| | (M − X +1) CRI Subband differential CQI for the second TB of all even |
| | subbands with increasing order of subband number, as in Tables 6.3.1.1.2-3/4/5, if |
| | cqi-FormatIndicator = subbandCQI and if reported |
| | (M − X + 1) CRI PMI subband information fields X₂ of all even subbands with |
| | increasing order of subband number, from left to right as in Tables 6.3.1.1.2-1/2 or |
| | 6.3.2.1.2-1/2, or codebook index for 2 antenna ports according to TS38.214 of all |
| | even subbands with increasing order of subband number, if pmi-FormatIndicator = |
| | subbandPMI and if reported |
| | (M − X + 1) CRI Subband differential CQI for the first TB of all odd subbands |
| | with increasing order of subband number as in Tables 6.3.1.1.2-3/4/5 or 6.3.2.1.2- |
| | 8/8A/8B/9/9A, if reported |
| | (M − X + 1) CRI Subband differential CQI for the second TB of all odd subbands |
| | with increasing order of subband number, as in Tables 6.3.1.1.2-3/4/5, if cqi- |
| | FormatIndicator = subbandCQI and if reported |
| | (M − X + 1) CRI PMI subband information fields X₂ of all odd subbands with |
| | increasing order of subband number, from left to right as in Tables 6.3.1.1.2-1/2 or |
| | 6.3.2.1.2-1/2, or codebook index for 2 antenna ports according to TS38.214 of all |
| | odd subbands with increasing order of subband number, if pmi-FormatIndicator = |
| | subbandPMI and if reported |
| | Mth CRI Subband differential CQI for the first TB of all even subbands with |
| | increasing order of subband number as in Tables 6.3.1.1.2-3/4/5 or 6.3.2.1.2- |
| | 8/8A/8B/9/9A, if reported |
| | M^{th} CRI Subband differential CQI for the second TB of all even subbands with |
| | increasing order of subband number, as in Tables 6.3.1.1.2-3/4/5, if cqi- |
| | FormatIndicator = subbandCQI and if reported |
| | M^{th} CRI PMI subband information fields X₂ of all even subbands with increasing |
| | order of subband number, from left to right as in Tables 6.3.1.1.2-1/2 or 6.3.2.1.2- |
| | 1/2, or codebook index for 2 antenna ports according to TS38.214 of all even |
| | subbands with increasing order of subband number, if pmi-FormatIndicator = |
| | subbandPMI and if reported |
| | M^{th} CRI Subband differential CQI for the first TB of all odd subbands with |
| | increasing order of subband number as in Tables 6.3.1.1.2-3/4/5 or 6.3.2.1.2- |
| | 8/8A/8B/9/9A, if reported |
| | Mth CRI Subband differential CQI for the second TB of all odd subbands with |
| | increasing order of subband number, as in Tables 6.3.1.1.2-3/4/5, if cqi- |
| | FormatIndicator = subbandCQI and if reported |
| | M^{th} CRI PMI subband information fields X₂ of all odd subbands with increasing |
| | order of subband number, from left to right as in Tables 6.3.1.1.2-1/2 or 6.3.2.1.2- |
| | 1/2, or codebook index for 2 antenna ports according to TS38.214 of all odd |
| | subbands with increasing order of subband number, if pmi-FormatIndicator = |
| | subbandPMI and if reported |

NOTE:
Subbands for given CSI report n indicated by the higher layer parameter csi-ReportingBand are numbered continuously in the increasing order with the lowest subband of csi-ReportingBand as subband 0.

For type II-r16 CSI feedback, different format from above is used for CSI reporting on PUSCH. The format is given as shown below.

TABLE 6.3.2.1.2-5A
Mapping order of CSI fields of one CSI report, CSI part

| CSI report | |
|---|---|
| number | CSI fields |
| CSI report #n | PMI fields X₁, from left to right as in Tables 6.3.2.1.2-1A/2A, if reported |
| CSI part 2, | |
| group 0 | |
| CSI report #n CSI part 2, group 1 | The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K^{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2 | The following PMI fields X₂, from left to right, as in Tables 6.3.2.1.2- $1 A / 2 A : min ( {K}^{NZ} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \} and$ |
| | └K^{NZ}/2┘ lowest priority bits of {i_{1,7,l}: l = 1, . . . , v}, in decreasing order of priority |
| | based on the corresponding function Pri(l, i, f) defined in TS 38.214, if reported |

This format can be extended for multiple CRI based reporting for typeII-r16 as shown below.

Table 6.3.2.1.2-5A
Mapping order of CSI fields of one CSI report, CSI part 2 of codebookType = typeII-r16 or typeII-PortSelection-r16

| CSI report | |
|---|---|
| number | CSI fields |
| CSI report #n | 1st CRI PMI fields X₁, from left to right as in Tables 6.3.2.1.2-1A/2A, if reported |
| CSI part 2, | |
| group 0, 1st CRI | |
| CSI report #n CSI part 2, group 1, 1st CRI | 1st CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 1st CRI | 1st CRI The following PMI fields X₂, from left to right, as in Tables 6.3.2.1.2- $1 A / 2 A : min ( {K}^{NZ} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |
| CSI report #n | 2nd CRI PMI fields X₁, from left to right as in Tables 6.3.2.1.2-1A/2A, if reported |
| CSI part 2, | |
| group 0,2nd CRI | |
| CSI report #n CSI part 2, group 1, 2nd CRI | 2nd CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K^{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 2nd CRI | 2nd CRI The following PMI fields X₂, from left to right, as in Tables 6.3.2.1.2- $1 A / 2 A : min ( {K}^{NZ} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |

| CSI report | |
|---|---|
| number | CSI fields |
| CSI report #n | 1st CRI PMI fields X₁, from left to right as in Tables 6.3.2.1.2-1A/2A, if |
| CSI part 2, | reported |
| group 0, 1st CRI | |
| CSI report #n | 2nd CRI PMI fields X₁, from left to right as in Tables 6.3.2.1.2-1A/2A, if |
| CSI part 2, | reported |
| group 0,2nd CRI | |
| CSI report #n CSI part 2, group 1, 1st CRI | 1st CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K^{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 1st CRI | 1st CRI The following PMI fields X₂, from left to right, as in Tables 6.3.2.1.2- $1 A / 2 A : min ( {K}^{NZ} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of |
| | priority based on the corresponding function Pri(l, i, f) defined in TS 38.214 |
| | [6], if reported |
| CSI report #n CSI part 2, group 1, 2nd CRI | 2nd CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K^{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 2nd CRI | 2nd CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |

In an embodiment, the table below shows a mapping order of CSI fields of one CSI report, CSI part 2 of codebookType=typeII-r16 or typeII-PortSelection-r16.

TABLE 6.3.2.1.2-5A
Mapping order of CSI fields of one CSI report, CSI part 2 of codebookType = typeII-r16 or typeII-PortSelection-r16

| CSI report | |
|---|---|
| number | CSI fields |
| CSI report #n | 1st CRI PMI fields X₁, from left to right as in Tables 6.3.2.1.2-1A/2A, if reported |
| CSI part 2, | |
| group 0, 1st CRI | |
| CSI report #n CSI part 2, group 1, 1st CRI | 1st CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 1st CRI | 1st CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |
| CSI report #n | 2nd CRI PMI fields X₁, from left to right as in Tables 6.3.2.1.2-1A/2A, if reported |
| CSI part 2, | |
| group 0, 2nd CRI | |
| CSI report #n CSI part 2, group 1, 2nd CRI | 2nd CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K^{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 2nd CRI | 2nd CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |

In an embodiment, the table below is referred to.

TABLE 6.3.2.1.2-5A
Mapping order of CSI fields of one CSI report, CSI part 2 ofc odebookType = typeII-r16 or typeII-PortSelection-r16

| CSI report | |
|---|---|
| number | CSI fields |
| CSI report #n | 1st CRI PMI fields X₁, from left to right as in Tables 6.3.2.1.2-1A/2A, if reported |
| CSI part 2, | |
| group 0, 1st CRI | |
| CSI report #n CSI part 2, group 1, 1st CRI | 1st CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 1st CRI | 1st CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of |
| | priority based on the corresponding function Pri(l, i, f) defined in TS 38.214, |
| | if reported |
| CSI report #n | 2nd CRI Subband differential CQI for the first TB for all even subbands with |
| CSI part 2, | increasing order of subband number as in Tables 6.3.1.1.2-3/4/5 or 6.3.2.1.2- |
| 2nd CRI | 8/8A/8B/9/9A, if reported |
| CSI report #n | 2nd CRI PMI fields X₁, from left to right as in Tables 6.3.2.1.2-1A/2A, if reported |
| CSI part 2, | |
| group 0, 2nd CRI | |
| CSI report #n CSI part 2, group 1, 2nd CRI | 2nd CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K^{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n | 2nd CRI Subband differential CQI for the first TB for all odd subbands with |
| CSI part 2, 2nd | increasing order of subband number as in Tables 6.3.1.1.2-3/4/5 or 6.3.2.1.2- |
| CRI | 8/8A/8B/9/9A, if reported |
| CSI report #n CSI part 2, group 2, 2nd CRI | 2nd CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |

In an embodiment, the table below is referred to.

TABLE 6.3.2.1.2-5A
Mapping order of CSI fields of one CSI report, CSI part 2 of codebookType = typeII-r16 or typeII-PortSelection-r16

| CSI report | |
|---|---|
| number | CSI fields |
| CSI report #n | 1st CRI PMI fields X₁, from left to right as in Tables 6.3.2.1.2-1A/2A, if reported |
| CSI part 2, | |
| group 0, 1st CRI | |
| CSI report #n CSI part 2, group 1, 1st CRI | 1st CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 1st CRI | 1st CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of |
| | priority based on the corresponding function Pri(l, i, f) defined in TS 38.214, |
| | if reported |
| CSI report #n | 2nd CRI Subband differential CQI for the first TB for all even subbands with |
| CSI part 2, | increasing order of subband number as in Tables 6.3.1.1.2-3/4/5 or 6.3.2.1.2- |
| 2nd CRI | 8/8A/8B/9/9A, if reported |
| CSI report #n | 2nd CRI PMI fields X₁, from left to right as in Tables 6.3.2.1.2-1A/2A, if reported |
| CSI part 2, | |
| group 0, 2nd CRI | |
| CSI report #n CSI part 2, group 1, 2nd CRI | 2nd CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K^{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n | 2nd CRI Subband differential CQI for the first TB for all odd subbands with |
| CSI part 2, 2nd | increasing order of subband number as in Tables 6.3.1.1.2-3/4/5 or 6.3.2.1.2- |
| CRI | 8/8A/8B/9/9A, if reported |
| CSI report #n CSI part 2, group 2, 2nd CRI | 2nd CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |

In an embodiment, the table below is referred to.

TABLE 6.3.2.1.2-5A
Mapping order of CSI fields of one CSI report, CSI part 2 of codebookType = typeII-r16 or typeII-PortSelection-r16

| CSI report | |
|---|---|
| number | CSI fields |
| CSI report #n | 1st CRI Wideband CQI for the first TB as in Tables 6.3.1.1.2-3/4/5 or 6.3.2.1.2- |
| CSI part 2, 1st | 8/8A/8B/9/9A, if reported |
| CRI | |
| CSI report #n | 1st CRI Subband differential CQI for the first TB with increasing order of |
| CSI part 2, 1st | subband number as in Tables 6.3.1.1.2-3/4/5 or 6.3.2.1.2-8/8A/8B/9/9A, if |
| CRI | reported |
| CSI report #n | 1st CRI PMI fields X₁, from left to right as in Tables 6.3.2.1.2-1A/2A, if |
| CSI part 2, | reported |
| group 0, 1st CRI | |
| CSI report #n CSI part 2, group 1, 1st CRI | 1st CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 1st CRI | 1st CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of |
| | priority based on the corresponding function Pri(l, i, f) defined in TS 38.214, |
| | if reported |
| CSI report #n | 2nd CRI Wideband CQI for the first TB as in Tables 6.3.1.1.2-3/4/5 or 6.3.2.1.2- |
| CSI part 2, | 8/8A/8B/9/9A, if reported |
| 2nd CRI | |
| CSI report #n | 2nd CRI Subband differential CQI for the first TB with increasing order of |
| CSI part 2, 2nd | subband number as in Tables 6.3.1.1.2-3/4/5 or 6.3.2.1.2-8/8A/8B/9/9A, if |
| CRI | reported |
| CSI report #n | 2nd CRI PMI fields X₁, from left to right as in Tables 6.3.2.1.2-1A/2A, if |
| CSI part 2, | reported |
| group 0, 2nd CRI | |
| CSI report #n CSI part 2, group 1, 2nd CRI | 2nd CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 2nd CRI | 2nd CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |

In an embodiment, the table below is referred to.

TABLE 6.3.2.1.2-5A
Mapping order of CSI fields of one CSI report, CSI part 2 of codebookType = typeII-r16 or typeII-PortSelection-r16

| CSI report | |
|---|---|
| number | CSI fields |
| CSI report #n | 1st CRI PMI fields X₁, from left to right as in Tables 6.3.2.1.2-1A/2A, if |
| CSI part 2, | reported |
| group 0, 1st CRI | |
| CSI report #n CSI part 2, group 1, 1st CRI | 1st CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 1st CRI | 1st CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of |
| | priority based on the corresponding function Pri(l, i, f) defined in TS 38.214, |
| | if reported |
| CSI report #n | 2nd CRI Wideband CQI for the first TB as in Tables 6.3.1.1.2-3/4/5 or 6.3.2.1.2- |
| CSI part 2, 2nd | 8/8A/8B/9/9A, if reported |
| CRI | |
| CSI report #n | 2nd CRI Subband differential CQI for the first TB with increasing order of |
| CSI part 2, 2nd | subband number as in Tables 6.3.1.1.2-3/4/5 or 6.3.2.1.2-8/8A/8B/9/9A, if |
| CRI | reported |
| CSI report #n | 2nd CRI PMI fields X₁, from left to right as in Tables 6.3.2.1.2-1A/2A, if |
| CSI part 2, | reported |
| group 0,2nd CRI | |
| CSI report #n CSI part 2, group 1, 2nd CRI | 2nd CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 2nd CRI | 2nd CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |

In an embodiment, the table below is referred to.

| CSI report | |
|---|---|
| number | CSI fields |
| CSI report #n | 1st CRI Subband differential CQI for the first TB with increasing order of |
| CSI part 2, 1st | subband number as in Tables 6.3.1.1.2-3/4/5 or 6.3.2.1.2-8/8A/8B/9/9A, if |
| CRI | reported |
| CSI report #n | 2nd CRI Subband differential CQI for the first TB with increasing order of |
| CSI part 2, 2nd | subband number as in Tables 6.3.1.1.2-3/4/5 or 6.3.2.1.2-8/8A/8B/9/9A, if |
| CRI | reported |
| CSI report #n | 1st CRI PMI fields X₁, from left to right as in Tables 6.3.2.1.2-1A/2A, if |
| CSI part 2, | reported |
| group 0,1 st CRI | |
| CSI report #n CSI part 2, group 1, 1st CRI | 1st CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 1st CRI | 1st CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| CSI report #n | 2nd CRI PMI fields X₁, from left to right as in Tables 6.3.2.1.2-1A/2A, if |
| CSI part 2, | reported |
| group 0, 2nd CRI | |
| CSI report #n CSI part 2, group 1, 2nd CRI | 2nd CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 2nd CRI | 2nd CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |

In an embodiment, the table below is referred to.

TABLE 6.3.2.1.2-5A
Mapping order of CSI fields of one CSI report, CSI part 2 of codebook Type = typeII-r16 or typeII-PortSelection-r16

| CSI report | |
|---|---|
| number | CSI fields |
| CSI report #n | 1st CRI Wideband CQI for the first TB as in Tables 6.3.1.1.2-3/4/5 or 6.3.2.1.2- |
| CSI part 2, 1st | 8/8A/8B/9/9A, if reported |
| CRI | |
| CSI report #n | 1st CRI Subband differential CQI for the first TB with increasing order of |
| CSI part 2, 1st | subband number as in Tables 6.3.1.1.2-3/4/5 or 6.3.2.1.2-8/8A/8B/9/9A, if |
| CRI | reported |
| CSI report #n | 2nd CRI Wideband CQI for the first TB as in Tables 6.3.1.1.2-3/4/5 or 6.3.2.1.2- |
| CSI part 2, 2nd | 8/8A/8B/9/9A, if reported |
| CRI | |
| CSI report #n | 2nd CRI Subband differential CQI for the first TB with increasing order of |
| CSI part 2, 2nd | subband number as in Tables 6.3.1.1.2-3/4/5 or 6.3.2.1.2-8/8A/8B/9/9A, if |
| CRI | reported |
| CSI report #n | 1st CRI PMI fields X₁, from left to right as in Tables 6.3.2.1.2-1A/2A, if |
| CSI part 2, | reported |
| group 0,1 st CRI | |
| CSI report #n CSI part 2, group 1, 1st CRI | 1st CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 1st CRI | 1st CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |
| CSI report #n | 2nd CRI PMI fields X₁, from left to right as in Tables 6.3.2.1.2-1A/2A, if |
| CSI part 2, | reported |
| group 0,2nd CRI | |
| CSI report #n CSI part 2, group 1, 2nd CRI | 2nd CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 2nd CRI | 2nd CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |

In an embodiment, the table below is referred to.

| CSI report | |
|---|---|
| number | CSI fields |
| CSI report #n | 1 st CRI Wideband CQI for the first TB as in Tables 6.3.1.1.2-3/4/5 or 6.3.2.1.2- |
| CSI part 2, 1st | 8/8A/8B/9/9A, if reported |
| CRI | |
| CSI report #n | 1st CRI Subband differential CQI for the first TB with increasing order of |
| CSI part 2, 1st | subband number as in Tables 6.3.1.1.2-3/4/5 or 6.3.2.1.2-8/8A/8B/9/9A, if |
| CRI | reported |
| CSI report #n | 2nd CRI Wideband CQI for the first TB as in Tables 6.3.1.1.2-3/4/5 or 6.3.2.1.2- |
| CSI part 2, 2nd | 8/8A/8B/9/9A, if reported |
| CRI | |
| CSI report #n | 2nd CRI Subband differential CQI for the first TB with increasing order of |
| CSI part 2, 2nd | subband number as in Tables 6.3.1.1.2-3/4/5 or 6.3.2.1.2-8/8A/8B/9/9A, if |
| CRI | reported |
| CSI report #n | 1st CRI PMI fields X₁, from left to right as in Tables 6.3.2.1.2-1A/2A, if |
| CSI part 2, | reported |
| group 0,1 st CRI | |
| CSI report #n CSI part 2, group 1, 1st CRI | 1st CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 1st CRI | 1st CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |
| CSI report #n | 2nd CRI PMI fields X₁, from left to right as in Tables 6.3.2.1.2-1A/2A, if |
| CSI part 2, | reported |
| group 0,2nd CRI | |
| CSI report #n CSI part 2, group 1, 2nd CRI | 2nd CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n group 2, 2nd CRI | 2nd CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |

In an embodiment, the table below is referred to.

TABLE 6.3.2.1.2-5A
Mapping order of CSI fields of one CSI report, CSI part 2 of codebookType = typeII-r16 or typeII-PortSelection-r16

| CSI report | |
|---|---|
| number | CSI fields |
| CSI report #n | 2nd CRI Wideband CQI for the first TB as in Tables 6.3.1.1.2-3/4/5 or 6.3.2.1.2- |
| CSI part 2, 1st | 8/8A/8B/9/9A, if reported |
| CRI | |
| CSI report #n | 2nd CRI Subband differential CQI for the first TB with increasing order of |
| CSI part 2, 2nd | subband number as in Tables 6.3.1.1.2-3/4/5 or 6.3.2.1.2-8/8A/8B/9/9A, if |
| CRI | reported |
| CSI report #n | 1st CRI PMI fields X₁, from left to right as in Tables 6.3.2.1.2-1A/2A, if |
| CSI part 2, | reported |
| group 0,1 st CRI | |
| CSI report #n CSI part 2, group 1, 1st CRI | 1st CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n CSI part 2, group 2, 1st CRI | 1st CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |
| CSI report #n | 2nd CRI PMI fields X₁, from left to right as in Tables 6.3.2.1.2-1A/2A, if |
| CSI part 2, | reported |
| group 0,2nd CRI | |
| CSI report #n CSI part 2, group 1, 2nd CRI | 2nd CRI The following PMI fields X₂, from left to right, as in Tables 6.3.2.1.2- $1 A / 2 A : \{ {i}_{2 , 3 , l} : l = 1 , … , v \} , {i}_{1 , 5} , \{ {i}_{1 , 6 , l} : l = 1 , … , v \} and max ( 0 , ⌈ \frac{{K}^{NZ}}{2} ⌉ - v ) \times 3$ |
| | highest priority bits of |
| | $\{ {i}_{2 , 4 , l} : l = 1 , … , v \} , max ( 0 , ⌈ \frac{{K}^{NZ}}{2} ⌉ - v ) \times 4 highest priority bits of \{ {i}_{2 , 5 , l} : l =$ |
| | 1, . . . , v} and v * 2LMᵥ − └K_{NZ}/2┘ highest priority bits of {i_{1,7,l}: l = 1, . . . , v}, in |
| | decreasing order of priority based on the corresponding function Pri(l, i, f) |
| | defined in TS 38.214, if reported |
| CSI report #n group 2, 2nd CRI | 2nd CRI The following PMI fields X₂, from left to right, as in Tables 6.3.2.1.2- $1 A / 2 A : min ( {K}^{N Z} - v , ⌊ \frac{{K}^{NZ}}{2} ⌋ ) \times 3 lowest priority bits of \{ {i}_{2 , 4 , l} : l =$ |
| | $1 , … , v \} , min ( {K}^{NZ} - v , ⌊ \frac{{K}^{NZ}}{2} ⌋ ) \times 4 lowest priority bits of \{ {i}_{2 , 5 , l} : l = 1 , … , v \}$ |
| | and └K^{NZ}/2┘ lowest priority bits of {i_{1,7,l}: l = 1, . . . , v}, in decreasing order of priority |
| | based on the corresponding function Pri(l, i, f) defined in TS 38.214, if reported |

FIG. 2 illustrates a flow diagram of a method for managing UCI for hybrid beamforming on a PUSCH in a wireless communication system according to an embodiment as disclosed herein. The method includes steps (202-206). Each step is explained in further detail below.

At step (202), the UE (102) receives a CSI report configuration from a network apparatus. The network apparatus includes various hardware and software components that facilitate communication between user equipment and network infrastructure. Examples of the network apparatus (501) can include, but is not limited to base stations (such as macro cells, small cells, femtocells, picocells) for wireless communication, antennas and RF units (e.g., MIMO, beamforming) to enhance signal coverage and data throughput, core network equipment (e.g., MMEs, S-GWs, P-GWs in 4G; AMFs, UPFs in 5G) for data routing, mobility, and session control, network function virtualization (NFV) and software-defined networking (SDN) for dynamic resource allocation and scalability, edge computing nodes (e.g., MEC servers) for low-latency processing, backhaul and transport equipment (e.g., fiber-optic links, microwave relays, Ethernet switches) to connect base stations to the core network, network management systems (NMS) and operation support systems (OSS) for network configuration, fault management, and optimization, radio network controllers (RNCs) in 3G, distributed units (DUs), and centralized units (CUs) in 5G, network slicing components for virtualized resource allocation, security elements (e.g., Firewalls, IDS, AAA Servers) for secure communication.

At step (204), the UE (102) splits the UCI associated with the UE (102) upon receiving the CSI report configuration from the network apparatus. The UCI is split into a part one UCI portion and a part two UCI portion. The part one UCI portion includes a fixed design and a number of bits dependent on a predetermined configuration. The part two UCI portion includes a variable payload dependent on a rank of CSI reporting.

At step (206), the UE (102) configures upon splitting the UCI, a UCI packing information for multiple CRI reporting along the part one UCI portion and part two UCI portion. The part one UCI portion has a high priority over the part two TCI portion.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) for transmitting uplink control information (UCI) for hybrid beamforming on a physical uplink shared channel (PUSCH) in a wireless communication system, the method comprising:
receiving, from a base station, a channel state information (CSI) report configuration, wherein the CSI report configuration includes configuration information associated with multiple CRI based hybrid beamforming;
identifying the UCI including a first UCI part and a second UCI part; and
transmitting, to the base station, the UCI,
wherein the first UCI part includes a CSI resource indicator (CRI), a rank indicator (RI), and channel quality information (CQI),
wherein the second UCI part includes a variable payload based on an order of CSI reporting, and
wherein the first UCI part includes a higher priority than a priority of the second UCI part.

2. The method of claim 1, wherein transmitting the UCI comprises:
determining a first order for reporting the UCI in the first UCI part, the first order being obtained for a CRI-based CSI refinement for up to 128 CSI-reference signal (CSI-RS) ports;
generating the CSI report based on the first order; and
transmitting the CSI report to the base station on the PUSCH,
wherein the first order for reporting the UCI in the first UCI part includes a first UCI part associated with a first reported CRI associated with a configured channel measurement resource (CMR), a second reported CRI associated with configured CMR, and a Mth reported CRI associated with configured CMR, and
wherein each CRI is associated with the configured CMR.

3. The method of claim 2, wherein the first order for reporting the UCI in the first UCI part includes a first UCI part associated with an X reported CRI associated with the configured CMR,
wherein a second order for reporting the UCI in a second UCI part includes the first UCI part associated with an M-X reported CRI, followed by the second UCI part associated with an M reported CRI,
wherein an X is less than an M,
wherein generating the CSI report based on the first order comprises generating a first CSI part based on the first order, and
wherein the first CSI part includes at least one of a CRI, an RI, a wideband differential CQI for a first transport block (TB), a sub-band differential CQI for the first TB, or an indicator of a number of wideband amplitude coefficients for 1^{st} reported CRI up to an Mth reported CRI, further comprising transmitting, to the base station, the first UCI part including the first CSI part based on the first order.

4. The method of claim 1, wherein transmitting the UCI comprises:
determining a second order for reporting the UCI in the second UCI part, the second order being obtained for a CRI-based CSI refinement for up to 128 CSI-RS ports;
generating the CSI report based on the second order; and
transmitting the CSI report to the base station on the PUSCH.

5. The method of claim 4, wherein the second UCI part includes a wideband UCI part and a subbands UCI part,
wherein the second order for reporting the UCI in the second UCI part includes the G0/wideband for a 1^{st} reported CRI, G0/wideband for a 2^{nd} reported CRI, up to G0/wideband for a Mth reported CRI, and
wherein each CRI is associated with configured CMR.

6. The method of claim 5, wherein generating the CSI report based on the second order comprises generating a wideband CSI part based on the second order, and
wherein the wideband UCI part includes at least one of a sub-band differential CQI for a first transmit block (TB), a first CRI wideband CQI for a second TB for the UCI, a first CRI layer indicator for the UCI, or first CRI PMI wideband information fields for 1^{st} reported CRI up to a Mth reported CRI,
further comprising transmitting, to the base station, the second UCI part including the second wideband CSI part.

7. The method of claim 5, wherein the second order for reporting the UCI in the second UCI part includes even subbands (G1) associated with 1^{st} reported CRI and odd subbands associated with 1^{st} reported RI, even subbands (G1) associated with 2^{nd} reported CRI and odd subbands associated with 2^{nd} reported CRI, up to, even subbands (G1) associated with Mth reported CRI and odd subbands associated with Mth reported CRI,
wherein each CRI is associated with configured CMR,
wherein generating the CSI report based on a second order comprises generating a subband CSI part based on the second order, and
wherein the subband CSI part includes at least one of a sub-band CQI for a second TB of an even subbands, a precoding matrix indicator (PMI) sub-band information fields of the even subbands, a sub-band differential CQI for a second TB of an odd subbands, PMI sub-band information fields of the odd subbands for the 1^{st} reported CRI up to Mth reported CRI,
further comprising transmitting, to the base station, the second UCI part including a second subband UCI part.

8. The method of claim 5, wherein the second order comprises G1 PMI components for 1^{st} reported CRI and G2 PMI components for 1^{st} reported CRI, G1 PMI components for 2nd reported CRI and G2 PMI components for 2^{nd} reported CRI, up to G1 PMI components for Mth reported CRI and G2 PMI components for Mth reported CRI, and
wherein each CRI is associated with the configured CMR.

9. A UE for transmitting uplink control information (UCI) for hybrid beamforming on a physical uplink shared channel (PUSCH) in a wireless communication system, the UE comprising:
a transceiver; and
a processor coupled with the transceiver and configured to:
receive, from a base station, a channel state information (CSI) report configuration, wherein the CSI report configuration includes configuration information associated with multiple CRI based hybrid beamforming,
identify the UCI including a first UCI part and a second UCI part, and
transmit, to the base station, the UCI,
wherein the first UCI part includes a CSI resource indicator (CRI), a rank indicator (RI), and a channel quality information (CQI),
wherein the second UCI part includes a variable payload based on an order of CSI reporting, and
wherein the first UCI part includes a higher priority than a priority of the second UCI part.

10. The UE of claim 9, wherein the processor is further configured to:
determine a first order for reporting the UCI in the first UCI part, the first order being obtained for a CRI-based CSI refinement for up to 128 CSI-reference signal (CSI-RS) ports,
generate the CSI report based on the first order, and
transmit the CSI report to the base station on the PUSCH,
wherein the first order for reporting the UCI in the first UCI part includes a first UCI part associated with a first reported CRI associated with a configured channel measurement resource (CMR), a second reported CRI associated with configured CMR, and a Mth reported CRI associated with configured CMR, and
wherein each CRI is associated with the configured CMR.

11. The UE of claim 9, wherein a first order for reporting the UCI in the first UCI part includes a first UCI part associated with an X reported CRI associated with a configured CMR,
wherein a second order for reporting the UCI in a second UCI part includes the first UCI part associated with an M-X reported CRI, followed by the second UCI part associated with an M reported CRI,
wherein an X is less than an M,
wherein the processor is further configured to generate a first CSI part based on the first order,
wherein the first CSI part includes at least one of a CRI, an RI, a wideband differential CQI for a first transport block (TB), a sub-band differential CQI for the first TB, or an indicator of a number of wideband amplitude coefficients for 1^{st} reported CRI up to an Mth reported CRI, and
wherein the processor is further configured to transmit, to the base station, the first UCI part including the first CSI part based on the first order.

12. The UE of claim 9, wherein the processor is further configured to:
determine a second order for reporting the UCI in the second UCI part, the second order being obtained for a CRI-based CSI refinement for up to 128 CSI-RS ports,
generate the CSI report based on the second order, and
transmit the CSI report to the base station on the PUSCH.

13. The UE of claim 12, wherein the second UCI part includes a wideband UCI part and subbands UCI part,
wherein the second order for reporting the UCI in the second UCI part includes the G0/wideband for a 1^{st} reported CRI, G0/wideband for a 2^{nd} reported CRI, up to G0/wideband for a Mth reported CRI, and
wherein each CRI is associated with configured CMR.

14. The UE of claim 13, wherein the processor is further configured to generate a wideband CSI part based on the second order,
wherein the wideband UCI part includes at least one of a sub-band differential CQI for a first transmit block (TB), a first CRI wideband CQI for a second TB for the UCI, a first CRI layer indicator for the UCI, or first CRI PMI wideband information fields for 1^{st} reported CRI up to a Mth reported CRI, and
wherein the processor is further configured to transmit, to the base station, the second UCI part including the second wideband CSI part.

15. The UE of claim 13, wherein the second order for reporting the UCI in the second UCI part includes even subbands (G1) associated with 1^{st} reported CRI and odd subbands associated with 1^{st} reported RI, even subbands (G1) associated with 2^{nd} reported CRI and odd subbands associated with 2^{nd} reported CRI, up to, even subbands (G1) associated with Mth reported CRI and odd subbands associated with Mth reported CRI,
wherein each CRI is associated with configured CMR,
wherein generating the CSI report based on a second order comprises generating a subband CSI part based on the second order,
wherein the subband CSI part includes at least one of a sub-band CQI for a second TB of an even subbands, a precoding matrix indicator (PMI) sub-band information fields of the even subbands, a sub-band differential CQI for a second TB of an odd subbands, PMI sub-band information fields of the odd subbands for the 1^{st} reported CRI up to Mth reported CRI,
wherein the processor is further configured to transmit, to the base station, the second UCI part including a second subband UCI part,
wherein the second order comprises G1 PMI components for 1^{st} reported CRI and G2 PMI components for 1^{st} reported CRI, G1 PMI components for 2^{nd} reported CRI and G2 PMI components for 2^{nd} reported CRI, up to G1 PMI components for Mth reported CRI and G2 PMI components for Mth reported CRI, and
wherein each CRI is associated with the configured CMR.
